(19) United States
(12) Patent Application Publication
(10) Pub. No.: US 2014/0221206 A1
(43) Pub. Date: Aug. 7, 2014

(54) HERBICIDAL COMPOSITION COMPRISING POLYMERIC MICROPARTICLES CONTAINING A HERBICIDE

(71) Applicants: Carol Formstone, Bracknell (GB); Martine Ingrid De Heer, Bracknell (GB); Philip Taylor, Bracknell (GB); Sian Janet Taylor, Bracknell (GB)

(72) Inventors: Carol Formstone, Bracknell (GB); Martine Ingrid De Heer, Bracknell (GB); Philip Taylor, Bracknell (GB); Sian Janet Taylor, Bracknell (GB)

(73) Assignee: SYNGENTA LIMITED, Guildford, Surrey (GB)

(21) Appl. No.: 14/343,058

(22) PCT Filed: Sep. 3, 2012
(86) PCT No.: PCT/EP2012/067072

§ 371 Date: Mar. 12, 2014

(30) Foreign Application Priority Data
Sep. 8, 2011 (GB) 1115564.5

(51) Int. Cl. A01N 25/10; A01N 43/90; A01N 37/40

(52) U.S. Cl. CPC A01N 25/10; A01N 37/40; A01N 43/90
USPC 504/103; 504/324; 504/139

(57) ABSTRACT

The invention provides a herbicidal composition comprising a mixture of: (a) polymeric microparticles containing a first herbicide, wherein the first herbicide is a synthetic auxin herbicide (e.g. dicamba, MCPA or 2,4-D) or an acetolactate synthase (ALS) inhibitor herbicide (e.g. triasulfuron, tribenuron-methyl, iodosulfuron-methyl, mesosulfuron-methyl, sulfosulfuron, flupyrsulfuron-methyl, or pyroxsulam); wherein the first herbicide, when in a salt-free form and when not contained within polymeric microparticles, antagonises the herbicidal activity of pinoxaden; and (b) pinoxaden; wherein the polymeric microparticles are controlled-release matrices, within which is the first herbicide, and which function in such a way as to control and/or slow down the release of the first herbicide from the polymeric microparticles into a liquid (e.g. aqueous) medium when the polymeric microparticles are placed (e.g. dispersed) in and in contact with the liquid medium. The containing of the first herbicide within the controlled-release polymeric microparticles is thought to mitigate the antagonism of the grass-weed-herbicidal activity of pinoxaden which might otherwise be caused by the first herbicide depending on the circumstances. The invention also provides a method of reducing the antagonistic effect on the control of monocotyledonous weeds in non-oat cereals which is shown by a herbicidal mixture of either a synthetic auxin herbicide with pinoxadenor an ALS inhibitor herbicide with pinoxaden, which comprises applying a herbicidal composition according to the invention. The invention also provides a herbicidal composition comprising (a) polymeric microparticles (e.g. controlled-release matrices), containing a first herbicide as defined above, and either (x) a nonionic surfactant or (y) a surface-modified clay, as defined herein.

The present invention relates to a new herbicidal composition, e.g. for controlling weeds in crops of useful plants, especially in crops of non-oat cereals such as wheat and/or barley, which composition comprises (a) polymeric microparticles containing a first herbicide, wherein the first herbicide is a synthetic auxin herbicide or an ALS inhibitor herbicide (e.g. as defined herein), and (b) pinoxaden (which is an ACCase inhibitor herbicide). The present invention also relates to a herbicidal composition comprising (a) polymeric microparticles containing a first herbicide, wherein the first herbicide is a synthetic auxin herbicide or an ALS inhibitor herbicide (e.g. as defined herein), and either (x) a nonionic surfactant (e.g. as defined herein) or (y) a surface-modified clay (e.g. as defined herein).

### BACKGROUND OF THE INVENTION

It is known, for example, from R. J. A. Deschamps, A. I. Hsiao and W. A. Quick, “Antagonistic effect of MCPA on fenoxaprop activity”, Weed Sci., 38 (1990), pp. 62-66, that the commercially available synthetic auxin herbicide MCPA tends to antagonise the herbicidal efficacy of the herbicide fenoxaprop, which inhibits ACCase (acetyl coenzyme A carboxylase), in view of the control of grass in cereals.

This antagonistic effect is sometimes also observed when different synthetic auxin herbicides, such as dicamba or 2,4-D, are used in combination with a different ACCase inhibitor herbicide, pinoxaden. Specifically, the herbicidal efficacy of the pinoxaden versus certain grassy weeds is sometimes reduced, depending on the conditions and/or depending on the application rates of the pinoxaden and of the dicamba or 2,4-D and/or depending on the grassy weeds to be controlled. This sometimes affects the use of tank-mixtures of pinoxaden mixed with a synthetic auxin herbicide such as dicamba or 2,4-D, in that the grass-herbicidal (graminicidal) activity of pinoxaden can sometimes be negatively affected, although the herbicidal activity against dicotyledonous weeds (provided by the synthetic auxin herbicide) is usually excellent.

Antagonism of the herbicidal activity of pinoxaden is also sometimes seen when pinoxaden is mixed with certain herbicidal inhibitors of acetolactate synthase (ALS) such as triasulfuron or tribenuron-methyl (e.g. see results shown hereinafter in Biological Examples 4 and 5). Pinoxaden is a herbicide suitable for use on non-oat cereals such as wheat, barley, rye and/or triticale, especially wheat and/or barley (i.e. is selective for non-oat cereals), and is typically applied post-emergence for control of grassy weeds such as Alopecurus, Apera, Avena, Lolium, Phalaris or Setaria species, e.g. at application rates of from 30 to 60 g active ingredient/ha (ha=hectare) (these features, e.g. uses or application rates can be used in the present invention). Pinoxaden is typically and preferably used in admixture with cloquintocet-mexyl as a safener. Pinoxaden is disclosed as compound 1.008 in WO 99/47525 A1 (Novartis AG); herbicidal compositions comprising pinoxaden and various co-herbicides are disclosed in WO 01/17351 A1 (Syngenta Participations AG); an emulsifiable concentrate herbicidal composition comprising pinoxaden, an emulsifier(s), a water-insoluble solvent(s) (e.g. aromatic hydrocarbons), an alcohol as a solvent (preferably benzyl alcohol, tetrahydrofurfuryl alcohol (“THFA”), or 2-methyl-2,4-pentanediol), and optionally a further herbicide, are disclosed WO 2007/073933 A2 (Syngenta Participations AG); and a liquid herbicidal composition containing pinoxaden and a built-in phosphate adjuvant such as tris-(2-ethylhexyl) phosphate is disclosed in WO 2008/049618 A2 (Syngenta Participations AG); all of which are incorporated herein by reference, and all of which are referred to in respect of, and/or can be utilized in embodiments of, the present invention. Pinoxaden and its herbicidal uses are disclosed in: M. Muehlebach et al., Bioorganic & Medicinal Chemistry, 2009, vol. 17, pp. 4241-4256; M. Muehlebach et al., in “Pesticide Chemistry. Crop Protection, Public Health, Environmental Safety”, ed. H. Ohkawa et al., 2007, Wiley, Weinheim, pp. 101-110; U. Hofer et al. Journal of Plant Diseases and Protection, 2006, Special Issue XX, pp. 989-995; and “The Pesticide Manual”, ed. C. D. S. Tomlin, 15th edition, 2009, British Crop Production Council, UK, see entry 687 “pinoxaden” on pp. 911-912; all of which are incorporated herein by reference. Pinoxaden has the following structure:

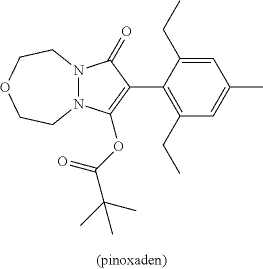 [SMILES: CCc1cc(C)cc(CC)c1-c1c(OC(=O)C(C)(C)C)n2n(c1=O)CCOCC2]

The synthetic auxin herbicides dicamba[3,6-dichloro-2-methoxybenzoic acid], 2,4-D [(2,4-dichlorophenoxy)acetic acid], and MCPA [(4-chloro-2-methylphenoxy)acetic acid], and their herbicidal uses, are disclosed inter alia in “The Pesticide Manual”, ed. C. D. S. To, 15th edition, 2009, British Crop Production Council, UK, see entry 226 “2,4-D” (pp. 294-300), entry 245 “dicamba” (pp. 323-325), and entry 535 “MCPA” (pp. 709-712); all of which are incorporated herein by reference. Dicamba or a salt thereof (e.g. sodium, potassium, or dimethylammonium salt, all of which are commercially available in formulations) is typically used for control of annual and/or perennial broad-leaved weeds, or brush species; e.g. in the following crops: cereals (e.g. wheat, barley, rye or oats, in particular spring or winter wheat, spring barley or spring rye), maize, sorghum, sugar cane, asparagus, perennial seed grasses, or turf; or in pastures, rangeland or non-crop land; e.g. at application rates in crops of from 80 to 400 g or from 100 to 400 g active ingredient/ha, measured as the free acid; or higher rates in pastures; the application rates vary with the specific use; for example, the approved application rate in Canada for the BANVEL™ II herbicide (BASF Canada Inc.) containing as active ingredient dicamba as the diglycolamine salt, in wheat, barley, rye or oat crops, is from ca. 110 to ca. 140 g dicamba/ha, measured as the free acid (any of these features e.g. uses or application rates can be used, separately or together, in the present invention). 2,4-D or a salt thereof (e.g. sodium or dimethylammonium salt) is typically used for post-emergence control of annual and/or perennial broad-leaved weeds, e.g. in various crops including cereals, maize, established turf, orchards, sugar cane, rice, etc; e.g. at application rates of from 280 to 2300 g active ingredient/ha, measured as the free acid (these features, e.g. uses or application rates can be used in the present invention). MCPA or a salt thereof (e.g. sodium, potassium, or dimethylammonium salt, all of which are commercially available in formulations) is typically used for post-emergence control of annual and/or perennial broad-leaved weeds; e.g. in the following crops: cereals, herbage seed crops, flax, rice, vines, peas, potatoes, asparagus, grassland, turf, under fruit trees; or on roadside verges or embankments; e.g. at application rates of from 280 to 2250 g active ingredient/ha, measured as the free acid (these features, e.g. uses or application rates can be used in the present invention). The structures of dicamba, 2,4-D, and MCPA are shown below; and are characterised by the presence of a carboxylic acid moiety:

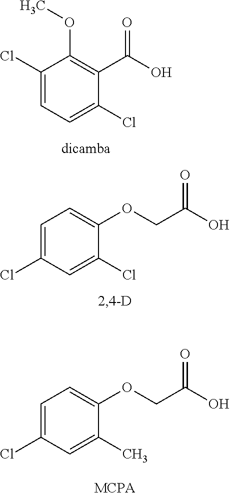

Triasulfuron, tribenuron-methyl, iodosulfuron-methyl (as the sodium salt), mesosulfuron-methyl, and pyroxsulam are disclosed in “The Pesticide Manual”, ed. C. D. S. Tomlin, 15th edition, 2009, British Crop Production Council, UK, see entry 494 “iodosulfuron-methyl-sodium” (pp. 658-660), entry 550 “mesosulfuron-methyl” (pp. 733-734), entry 753 “pyroxsulam” (pp. 1001-1002), entry 868 “triasulfuron” (pp. 1150-1151), and entry 873 “tribenuron-methyl” (pp. 1156-1158); all of which are incorporated herein by reference.

Triasulfuron is an ALS inhibitor, of the sulfonyl urea structural class, which is typically used pre- or post-emergence for control of broad-leaved weeds, e.g. in cereal crops such as wheat, barley or triticale, e.g. at application rates of from 5 to 10 g active ingredient/ha, measured as the free compound (these features, e.g. uses or application rates can be used in the present invention). Tribenuron-methyl is an ALS inhibitor, of the sulfonyl urea structural class, which is typically used post-emergence for control of broad-leaved weeds, e.g. in cereal crops such as wheat, barley, oats, rye or triticale, e.g. at application rates of from 7.5 to 30 g active ingredient/ha, measured as the free compound (these features, e.g. uses or application rates can be used in the present invention). Iodosulfuron-methyl (usually in the form of the sodium salt) is an ALS inhibitor, of the sulfonyl urea structural class, which is typically used post-emergence for control of grass weeds and/or broad-leaved weeds, e.g. in cereal crops such as winter, spring or durum wheat, triticale, rye or spring barley, e.g. at an application rate of 10 g active ingredient/ha, measured as the free compound (these features, e.g. uses or application rates can be used in the present invention). Typically, iodosulfuron-methyl is used in admixture with mefenpyr-diethyl as a safener. Mesosulfuron-methyl is an ALS inhibitor, of the sulfonyl urea structural class, which is typically used early to mid post-emergence for control of grass weeds and/or (some) broad-leaved weeds, e.g. in cereal crops such as winter, spring or durum wheat, triticale or rye, e.g. at an application rate of 15 g active ingredient/ha, measured as the free compound (these features, e.g. uses or application rates can be used in the present invention). Pyroxsulam is an ALS inhibitor, of the triazolopyrimidine structural class, which is typically used post-emergence for control of annual grasses and/or broad-leaved weeds; e.g. in cereal crops such as spring or winter wheat, winter rye or winter triticale; e.g. at application rates of from 9 to 18.75 g active ingredient/ha, measured as the free compound (these features, e.g. uses or application rates can be used in the present invention). Pyroxsulam is typically used in admixture with cloquintocet-mexyl as a safener.

The structures of triasulfuron, tribenuron-methyl, iodosulfuron-methyl, mesosulfuron-methyl, and pyroxsulam are shown below:

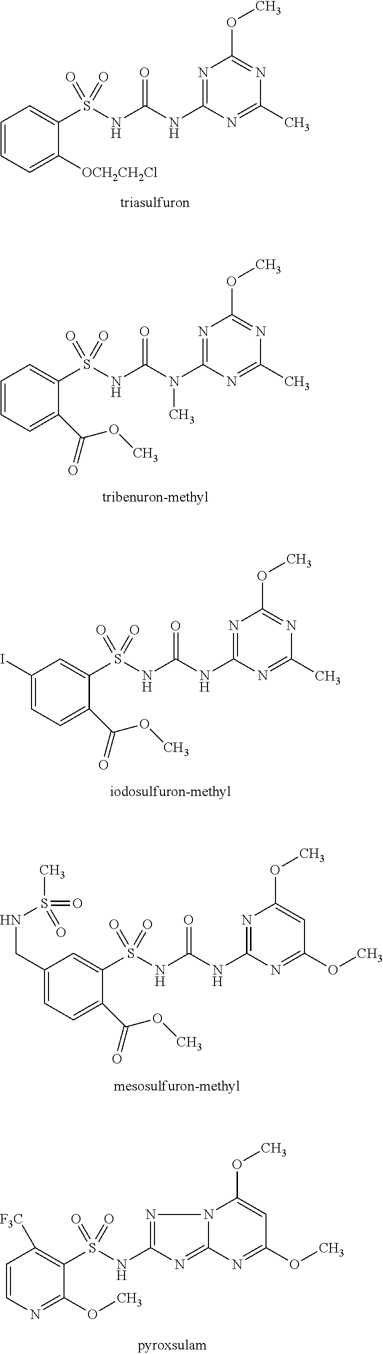

WO 2011/162944 A1 (Syngenta Participations AG), a copending PCT application filed on 7 Jun. 2011 and published on 29 Dec. 2011, discloses an aqueous liquid dispersion concentrate composition comprising (a) a continuous aqueous liquid phase, and (b) at least one dispersed, solid phase comprising polymer particles having a mean particle size of at least one micron and prepared from either a curable or a polymerizable resin or a solidifiable thermoplastic polymer, wherein the outside surfaces of the polymer particles comprise a colloidal solid material and wherein the polymer particles have at least one chemical agent (e.g. agrochemically active ingredient) distributed therein.

EP 0 517 669 A1 (Sandoz Ltd) discloses a process for micro-encapsulating a rapidly leaching agrochemical (e.g. dicamba, MCPA or 2,4-D) comprising the steps of: (a) dissolving or suspending the agrochemical in a nonaqueous liquid mixture comprising unsaturated polyester resin and vinyl monomer; (b) emulsifying said solution or suspension in water to a desired particle size; and (c) effecting crosslinking of the unsaturated polyester resin and vinyl monomer to produce the microcapsules. Example 1 of EP 0 517 669 A1 discloses polymeric microcapsules (formed from polymerizing/crosslinking a polyester/styrene liquid resin mixed with dicamba and a peroxyester) suspended in an aqueous medium containing a low amount of polyvinyl alcohol and significant amounts of two anionic surfactants (lignosulfonate, and methyl vinyl ether/maleic acid copolymer). The polymeric microcapsules of EP 0 517 669 A1 are disclosed as potentially reducing leaching below the targeted soil zone, for rapidly leaching agrochemicals. However, EP 0 517 669 A1 does not disclose or suggest that the polymeric microcapsules therein can be tank-mixed with pinoxaden-containing compositions, and there is no suggestion therein of their suitability (or otherwise) for reducing auxin- (e.g. dicamba-) generated antagonism of pinoxaden grass-herbicidal activity.

Also, it is now thought that the specific dicamba microcapsule composition disclosed in Example 1 of EP 0 517 669 A1 is not ideal for tank-mixing in water with a mixture of the commercially-available pinoxaden-containing emulsifiable concentrate (“EC”) composition Axial™ 100EC (a THFA-containing EC of the type disclosed and claimed in WO 2007/073933 A2) and the associated tank-mix adjuvant Adigor™ (an EC composition comprising methylated rapeseed oil as an adjuvant), because of the flocculation which is thought to result, which increases the risk of nozzle blockage and/or impaired sprayability in agricultural spray equipment (see Polymeric Microparticle Example 14 hereinafter for details). So it would be preferable, if possible, to improve the dicamba-microcapsule compositions of EP 0 517 669 A1 so as to make them more clearly sprayable after tank-mixing in water with typical pinoxaden-containing EC compositions and/or Adigor™.

### BRIEF SUMMARY OF THE INVENTION

Surprisingly, it has now been found that, in a mixture of a synthetic auxin herbicide (preferably dicamba and/or an agrochemically acceptable salt thereof) with the ACCase inhibitor herbicide pinoxaden, where the mixture is at risk of the pinoxaden-mediated grassy-weed control being antagonised (reduced) by the presence of the synthetic auxin herbicide, then this potential antagonism can be reduced, when the synthetic auxin herbicide is contained within polymeric microparticles.

Preferably, the polymeric microparticles containing the synthetic auxin herbicide are characterised by a reduced rate of release or reduced amount released over a specified time period, e.g. within 1 hour or 3 hours, of the synthetic auxin herbicide (e.g. dicamba and/or a salt thereof) from the microparticles into an aqueous medium in which the microparticles are suspended or dispersed, compared to the rate of release or dissolution or amount released or dissolved of the same synthetic auxin herbicide (e.g. dicamba and/or a salt thereof) from a substantially pure sample of the same synthetic auxin herbicide (e.g. dicamba and/or a salt thereof) which is not contained within polymeric microparticles.

It is thought likely that the same technical effect is likely to be achievable when an acetolactate synthase (ALS) inhibitor herbicide, instead of the synthetic auxin herbicide, is contained within polymeric microparticles.

Therefore, a first aspect of the present invention provides a herbicidal composition comprising a mixture of (e.g. a herbicidally effective amount of a mixture of):

(a) polymeric microparticles containing a first herbicide, wherein the first herbicide is a synthetic auxin herbicide or an acetolactate synthase (ALS) inhibitor herbicide;
wherein the first herbicide, when in a salt-free form and when not contained within polymeric microparticles, antagonises the herbicidal activity of pinoxaden;
and (b) pinoxaden;
wherein the polymeric microparticles are controlled-release matrices, within which is the first herbicide, and which function in such a way as to control and/or slow down the release of the first herbicide from the polymeric microparticles into a liquid medium (preferably an aqueous liquid medium) when the polymeric microparticles are placed (preferably dispersed) in and in contact with the liquid medium.

The relevance, importance and/or technical significance of the first aspect of the invention is thought to be as follows. Without being bound by theory, the first herbicide being contained within polymeric microparticles which function as a controlled-release matrices is thought to be an important factor as follows. When the herbicidal composition of the invention is applied to the foliage, e.g. cuticula, of a plant such as a weed, it is thought that the polymeric microparticles functioning as controlled-release matrices help to mitigate (reduce) the tendency in some circumstances of the first herbicide to reduce (antagonise) the monocotyledonous weed (e.g. grass-weed) herbicidal activity of pinoxaden. Such antagonism of the activity of pinoxaden might otherwise be caused to an extent by the first herbicide if it were released onto the plant at the same time as the pinoxaden, dependent on the circumstances such as e.g. the application rates of the pinoxaden and/or of the first herbicide and/or the weed type.

Without being bound by theory, it is thought that the polymeric microparticles functioning as controlled-release matrices slow down the release of the first herbicide in such a way as to allow the pinoxaden to enter the plant first, thereby damaging or controlling monocotyledonous e.g. grassy weeds, while much or most of the first herbicide enters the plant later (e.g. ca. 30-60 minutes or ca. 30-180 minutes later). Without being bound by theory, it is thought that because much or most of the first herbicide enters the plant after the pinoxaden has entered the plant and after the pinoxaden has already had its herbicidal effect, then the first herbicide therefore has a reduced opportunity to antagonise the pinoxaden herbicidal activity by whatever biochemical and/or other pathway(s) by which antagonism takes place.

All this happens while retaining the convenience of applying to the crops and/or weeds (preferably post-emergence) a single herbicidal composition containing both the first herbicide and pinoxaden, i.e. allowing just a single spraying of the field, which reduces the monetary costs (herbicide, fuel and labour costs) and environmental costs of spraying. Where the first herbicide controls dicotyledonous weeds, this allows monocotyledonous e.g. grassy weed control to be obtained via pinoxaden and dicotyledonous weed control to be obtained via the first herbicide in a single spraying.

Further, a second aspect of the present invention provides a herbicidal composition, comprising a mixture of:

(a) polymeric microparticles containing a first herbicide, wherein the first herbicide is a synthetic auxin herbicide or an acetolactate synthase (ALS) inhibitor herbicide;
wherein the first herbicide, when in a salt-free form and when not contained within polymeric microparticles, antagonises the herbicidal activity of pinoxaden;
and (x) a nonionic surfactant (preferably comprising a nonionic polymeric barrier surfactant, more preferably polyvinyl alcohol);
wherein the herbicidal composition is a dispersion composition in which the polymeric microparticles are dispersed in a continuous liquid phase or medium,
and wherein the nonionic surfactant is present in the continuous liquid phase or medium, such that the nonionic surfactant stabilizes the dispersion of the polymeric microparticles in the continuous liquid phase or medium,
and wherein the weight ratio of the polymeric microparticles to the nonionic surfactant in the herbicidal composition is from 40:1 to 1:2;
and wherein either the composition comprises no ionic surfactant, or the composition comprises an ionic surfactant and the weight ratio of the polymeric microparticles to the ionic surfactant in the herbicidal composition is 200:1 or more.

Further, a third aspect of the present invention provides a herbicidal composition, comprising a mixture of:

(a) polymeric microparticles containing a first herbicide, wherein the first herbicide is a synthetic auxin herbicide or an acetolactate synthase (ALS) inhibitor herbicide;
wherein the first herbicide, when in a salt-free form and when not contained within polymeric microparticles, antagonises the herbicidal activity of pinoxaden;
and (y) a surface-modified clay;
wherein the herbicidal composition is a dispersion composition in which the polymeric microparticles are dispersed in a continuous liquid phase or medium,
and wherein the surface-modified clay is present in the continuous liquid phase or medium and/or is present at the interface between the continuous liquid phase or medium and the polymeric microparticles, such that the surface-modified clay stabilizes the dispersion of the polymeric microparticles in the continuous liquid phase or medium.

In these second and third aspects of the invention, the herbicidal dispersion compositions, as defined herein, comprising (a) polymeric microparticles (“PMPs”) as defined herein containing the first herbicide (e.g. synthetic auxin herbicide), and either (x) a nonionic surfactant (e.g. as defined herein) or (y) a surface-modified clay, are novel PMP-containing compositions. These compositions may optionally be marketed as a source of PMPs containing the first herbicide. These compositions may optionally be mixed in a tank (tank-mixed), e.g. just before spraying on a field, with an emulsifiable concentrate (“EC”) composition containing pinoxaden (e.g. a pinoxaden EC containing an alcohol solvent such as THFA, as disclosed such as claimed in WO 2007/073933 A2 which encompasses the commercial EC composition Axial™ 100EC e.g. available from Syngenta), and optionally also with a tank-mix adjuvant such as Adigor™ (which is an emulsifiable concentrate containing 47% by weight of the formulation of methylated rapeseed oil as an adjuvant, e.g. available from Syngenta), usually together with water. The resulting tank mixtures, which are within the first aspect of the invention, may serve to reduce antagonism of pinoxaden grass-herbicidal activity.

More importantly for the second or third aspects of the invention, the Polymeric Microparticle Examples 1, 2, 4 to 9, 10 to 13, and 16 as disclosed hereinafter, which are embodiments of the PMP-containing compositions according to the second or third aspects of the invention, have been found to be suitable for tank mixing with all of: (i) a pinoxaden-containing EC of the type used in Axial™ 100EC (e.g. as disclosed such as claimed in WO 2007/073933 A2), and (ii) the Adigor™ adjuvant EC containing methylated rapeseed oil, and (iii) water. This tank-mixability is shown in or suggested by Biological Examples 1-2, 3, and 6-11 and Polymeric Microparticle Example 16 hereinafter. More specifically, these tank mixtures containing: one PMP composition selected from PMP Examples 1, 2, 4 to 9, 10 to 13, and 16; plus Axial™ 100EC; plus Adigor™; plus water; appear to be sprayable. By “sprayable”, it is meant that any flocullation (e.g. heteroflocullation) that occurs (if it does occur) in the tank-mixture is thought not generally to be serious enough so as to cause significant blockage of spray nozzles (e.g. typical spray nozzles) of agricultural spraying equipment. This sprayability, and/or this zero blockage or functionally-insignificant blockage of agricultural spray nozzles, can for example be characterized by a generally low (functionally-insignificant) or zero amount of solid residue collected on a sieve of 150 micrometre aperture size when a tank-mixture containing:
a composition according to a second or third aspect of the invention, such as one PMP composition selected from PMP Examples 1, 2, 4 to 9, 10 to 13, and 16;
plus (i) a pinoxaden-containing EC of the type used in Axial™ 100EC e.g. available from Syngenta (i.e. an emulsifiable concentrate (“EC”) containing 100 g/L of pinoxaden, plus 25 g/L of cloquintocet-mexyl as a safener, plus tetrahydrofurfuryl alcohol and aromatic hydrocarbons as solvents, plus one, two or three surfactants; such as an EC as disclosed in or similar to Example 1 (EC3) and/or Example 4 disclosed on pages 5-6 and 7 of WO 2007/073933 A2, incorporated herein by reference);
plus (ii) a tank-mix adjuvant of the type used in Adigor™ e.g. available from Syngenta (i.e. an emulsifiable concentrate containing 47% by weight of the formulation of methylated rapeseed oil as an adjuvant);
plus (iii) water;
   is passed through the 150-micrometre-aperture sieve, e.g. at a time 0.5 to 24 hours, such as 1-4 hours or 10-24 hours, after the tank-mixture is first prepared. For example, see Polymeric Microparticle Example 16 hereinafter to show how this sieve test works to determine sprayability.

In contrast to the second and third aspects of the invention, Example 1 of EP 0 517 669 A1 (Sandoz Ltd) discloses polymeric microcapsules (formed from polymerizing/crosslinking a polyester/styrene liquid resin mixed with dicamba and a peroxyester) suspended in an aqueous medium containing a low amount of polyvinyl alcohol and significant amounts of two anionic surfactants (lignosulfonate, and methyl vinyl ether/maleic acid copolymer). A substantial repeat of Example 1 of EP 0 517 669 A1 has been performed in Polymeric Microparticle Example 14 disclosed hereinafter. It appears from PMP Example 14 that the dicamba-PMPs produced by Example 1 of EP 0 517 669 A1, though they could be used as a solo herbicide, cannot easily satisfactorily be tank-mixed with all of: (i) a pinoxaden-containing EC of the type used in Axial™ 100EC, plus (ii) Adigor™; plus (iii) water; because this tank-mixture flocullates (e.g. heteroflocullates) in a way that is likely to block typical spray nozzles of agricultural spraying equipment, as measured by significant solid residues collected on a 150-micrometre-aperture-sieve. See Polymeric Microparticle Example 14 disclosed hereinafter.

It is thought, e.g. from the data shown in PMP Example 16, that the PMP-containing compositions according to the second and third aspects of the invention should mitigate this problem of the poor-sprayability of [Axial™ 100EC+Adigor™+water] tank-mixtures of the dicamba-PMPs disclosed in Example 1 of EP 0 517 669 A1.

Also, with respect to the third aspect of the invention, the mentioned surface-modified clay (particularly the amino-silane-modified clay e.g. as used in some of the Examples herein) is thought to be superior to regular clay (e.g. china clay), in that the quality of the final aqueous dispersion (and/or the quality of the aqueous emulsion, before curing of a polyester resin to form the PMPs) is superior when an amino-silane-modified kaolin clay is used instead of regular china clay, for dicamba-containing PMPs based on a crosslinked polyester. Without being bound by theory, it is postulated that the surface modification helps the clay to sit better at the interface between the PMPs and the aqueous continuous phase of an aqueous dispersion.

Further, a fourth aspect of the present invention provides a herbicidal composition, comprising a mixture of:

(a) polymeric microparticles containing a first herbicide, wherein the first herbicide is a synthetic auxin herbicide or an acetolactate synthase (ALS) inhibitor herbicide;
wherein the first herbicide, when in a salt-free form and when not contained within polymeric microparticles, antagonises the herbicidal activity of pinoxaden;
and (x) a nonionic surfactant (preferably comprising a nonionic polymeric barrier surfactant, more preferably polyvinyl alcohol);
wherein the herbicidal composition is a dispersion composition in which the polymeric microparticles are dispersed in a continuous liquid phase or medium,
and wherein the nonionic surfactant is present in the continuous liquid phase or medium, such that the nonionic surfactant stabilizes the dispersion of the polymeric microparticles in the continuous liquid phase or medium,
wherein the polymer microparticles comprise a polymeric matrix or matrices comprising a crosslinked polyester polymer or co-polymer (preferably a crosslinked polyester polymer formed from the polymerization of an unsaturated (alkene-containing) polyester resin mixed with an alkenyl-group-containing monomer);
and wherein the mean diameter by volume of the polymeric microparticles containing the first herbicide is from 0.5 to 15 micrometres (preferably from 0.7 to 15 micrometres or from 1.0 to 15 micrometres or from 2.0 to 15 micrometres, more preferably from 0.7 to 13 micrometres or from 1.0 to 13 micrometres or from 2.0 to 13 micrometres or from 2.5 to 13 micrometres or from 3.0 to 13 micrometres, most preferably from 2.0 to 12 micrometres or from 3.0 to 12 micrometres or from 4.0 to 12 micrometres), as measured by light scattering laser diffraction (such as dynamic or static light scattering laser diffraction).

With respect to the fourth aspect of the invention, Polymeric Microparticle (PMP) Examples 10 and 11, which have good properties (especially PMP Example 11, whose herbicidal field trial results are shown in Biological Example no. 3), are preferred embodiments of the fourth aspect of the invention. The particle size (especially, the mean diameter by volume (i.e. volume-weighted mean diameter), as measured by light scattering laser diffraction) of the dicamba polymeric microparticles defined in the fourth aspect of the invention (and within PMP Examples 10 and 11—see FIGS. 4 and 5 herein) is thought to be smaller than the particle size of the dicamba polymeric microparticles prepared in PMP Example 14 (see FIG. 8 herein) which is a substantial repeat of Example 1 of EP 0 517 669 A1 (Sandoz Ltd). In PMP Example 14 the dispersion includes a large number of quite large polymeric microparticles whose diameters are in the 13 to 50 micrometre, or 15 to 50 micrometre, range.

### BRIEF DESCRIPTION OF THE DRAWINGS

FIG. 1 is an optical microscope photograph of the dicamba-containing polymeric microparticles formed in Polymeric Microparticle Example 1, wherein the scale-bar shown is 10 micrometres.

FIG. 2 is an optical microscope photograph of the dicamba-containing polymeric microparticles formed in Polymeric Microparticle Example 2, in which the scale-bar shown is 10 micrometres.

FIG. 3 is a graph of percentage dicamba released versus time (hours), showing the release and release rate data, into water, for Polymeric Microparticle Examples 1, 2 and 3.

FIG. 4 is an optical microscope photograph of the dicamba-containing polymeric microparticles formed in Polymeric Microparticle Example 10, wherein the scale-bar shown is 50 micrometres.

FIG. 5 is an optical microscope photograph of the dicamba-containing polymeric microparticles formed in Polymeric Microparticle Example 11, wherein the scale-bar shown is 20 micrometres.

FIG. 6 is an optical microscope photograph of the dicamba-containing polymeric microparticles formed in Polymeric Microparticle Example 12, wherein the scale-bar shown is 50 micrometres.

FIG. 7 is an optical microscope photograph of the dicamba-containing polymeric microparticles formed in Polymeric Microparticle Example 13, wherein the scale-bar shown is 50 micrometres.

FIG. 8 is an optical microscope photograph of the dicamba-containing polymeric microparticles formed in Polymeric Microparticle Example 14 (experiment SJH001/035/002, a substantial repeat of Example 1 of EP 0 517 669 A1 (Sandoz Ltd)), wherein the two scale-bars shown are 20 micrometres (at left side of photograph) and 50 micrometres (at bottom of photograph).

FIG. 9 is an optical microscope photograph, taken after 5 minutes of mixing, of the tank mixture comprising Polymeric Microparticle Example 14, Axial™ 100EC (an emulsifiable concentrate (“EC”) containing pinoxaden), Adigor™ (an emulsifiable concentrate containing methylated rapeseed oil as an adjuvant), and water; in FIG. 9, the scale-bar shown is 500 micrometres.

FIG. 10 is an optical microscope photograph, taken after 2.5 hours of mixing, of the tank mixture comprising Polymeric Microparticle Example 14, Axial™ 100EC, Adigor™, and water; in FIG. 10, the scale-bar shown is 200 micrometres.

FIG. 11 is an optical microscope photograph of the dicamba-containing polymeric microparticles formed in Polymeric Microparticle Example 15 (experiment SJH001/035/003), wherein the scale-bar shown is 20 micrometres.

FIG. 12 is an optical microscope photograph, taken after 5 minutes of mixing, of the tank mixture comprising Polymeric Microparticle Example 15, Axial™ 100EC (an emulsifiable concentrate containing pinoxaden), Adigor™ (an emulsifiable concentrate containing methylated rapeseed oil as an adjuvant), and water; in FIG. 12, the scale-bar shown is 200 micrometres.

FIG. 13 is an optical microscope photograph, taken after 2.5 hours of mixing, of the tank mixture comprising Polymeric Microparticle Example 15, Axial™ 100EC, Adigor™, and water; in FIG. 13, the scale-bar shown is 1000 micrometres.

FIG. 14 is an optical microscope photograph of the dicamba-containing polymeric microparticles formed in Polymeric Microparticle Example 16 (experiment SJH001/035/004), wherein the scale-bar shown is 20 micrometres.

FIG. 15 is an optical microscope photograph, taken after 5 minutes of mixing, of the tank mixture comprising Polymeric Microparticle Example 16, Axial™ 100EC (an emulsifiable concentrate containing pinoxaden), Adigor™ (an emulsifiable concentrate containing methylated rapeseed oil as an adjuvant), and water; in FIG. 15, the two scale-bars shown are 20 micrometres (top left of photograph) and 200 micrometres (bottom left of photograph).

FIG. 16 is an optical microscope photograph, taken after 2.5 hours of mixing, of the tank mixture comprising Polymeric Microparticle Example 16, Axial™ 100EC, Adigor™, and water; in FIG. 16, the scale-bar shown is 100 micrometres.

FIG. 17 is a graph of the release and release rate data, for water as receiving material, for Polymeric Microparticle Example 11 (experiment SJH001/011/002), plotting the concentration of dicamba acid (in g/L) released from the polymeric microparticles versus time (hours).

FIG. 18 is a graph of the release and release rate data, for water as receiving material, for Polymeric Microparticle Example 11 (experiment SJH001/011/002), plotting the percentage of total dicamba acid released from the polymeric microparticles versus time (hours); based on a theoretical 0.5095 g/L dicamba acid concentration for 100% dicamba release.

FIG. 19 is an optical microscope photograph of the triasulfuron-containing polymeric microparticles formed in Polymeric Microparticle Example 18, in which the scale-bar shown is 20 micrometres.

### DETAILED DESCRIPTION OF THE INVENTION

Preferred, particular and/or optional embodiments of the first, second, third and/or fourth aspects of the present invention are presented hereinafter. Unless mentioned otherwise, and except when inappropriate, these preferred, particular and/or optional embodiments apply to any and all of the first, second, third and/or fourth aspects of the present invention, with any necessary changes to the wording being made.

Preferred, Particular and/or Optional Embodiments of the Polymeric Microparticles

Preferably, in all aspects (e.g. the first, second, third and/or fourth aspects) of the present invention, the polymeric microparticles are controlled-release polymeric microparticles. Preferably, the polymeric microparticles are controlled-release matrices, within which is the first herbicide, and which function in such a way as to control and/or slow down the release of the first herbicide from the polymeric microparticles into a liquid medium (preferably an aqueous liquid medium) when the polymeric microparticles are placed (preferably dispersed) in and in contact with the liquid medium.

Preferably, the polymeric microparticles containing the first herbicide are controlled-release matrices within which is the first herbicide, and which are characterized by:

an amount of the first herbicide released, over a specified time period (preferably over the first 1 hour of contact, or over the first 3 hours of contact), from the polymeric microparticles into a liquid medium (preferably an aqueous liquid medium e.g. water) after the polymeric microparticles are placed (preferably dispersed) in and in contact with the liquid medium,
which is reduced (typically reduced by at least 30%, preferably by at least 40% or at least 50%, more preferably by at least 60% or by at least 70% or by at least 75%, typically measured by numbers of moles of the first herbicide or measured by weight of the first herbicide calculated in a salt-free form),
compared to an amount of the same first herbicide released or dissolved over the same specified time period, from a sample (typically a solid sample) of the same first herbicide which is in substantially pure form (e.g. at least 85%, preferably at least 97% or at least 98% or at least 99% pure, by weight) and in which the first herbicide is not contained within polymeric microparticles, into the same liquid medium (preferably the same aqueous liquid medium e.g. water) used for the polymeric microparticle release analysis, after the substantially pure sample of the first herbicide is placed (preferably dispersed) in and in contact with the liquid medium.

More preferably, the polymeric microparticles are controlled-release matrices within which is the first herbicide, and which are such that the amount of the first herbicide released, over the first 3 hours of contact, from the polymeric microparticles into an aqueous liquid medium (preferably water) after the polymeric microparticles are placed (preferably dispersed) in and in contact with the liquid medium, is equal to or less than 35% (more preferably equal to or less than 30%, still more preferably equal to or less than 26%, typically measured by numbers of moles of the first herbicide or measured by weight of the first herbicide calculated in a salt-free form),

compared to an amount of the same first herbicide released or dissolved, over the first 3 hours of contact, from a sample (typically a solid sample) of the same first herbicide which is in substantially pure form (e.g. at least 85%, preferably at least 97% or at least 98% or at least 99% pure, by weight) and in which the first herbicide is not contained within polymeric microparticles, into the same aqueous liquid medium (preferably water) used for the polymeric microparticle release analysis, after the substantially pure sample of the first herbicide is placed (preferably dispersed) in and in contact with the liquid medium.

Alternatively or additionally, more preferably, the polymeric microparticles are controlled-release matrices within which is the first herbicide, and which are such that the amount of the first herbicide released, over the first 1 hour of contact, from the polymeric microparticles into an aqueous liquid medium (preferably water) after the polymeric microparticles are placed (preferably dispersed) in and in contact with the liquid medium, is equal to or less than 32% (more preferably equal to or less than 28%, still more preferably equal to or less than 24%, typically measured by numbers of moles of the first herbicide or measured by weight of the first herbicide calculated in a salt-free form),

compared to an amount of the same first herbicide released or dissolved, over the first 1 hour of contact, from a sample (typically a solid sample) of the same first herbicide which is in substantially pure form (e.g. at least 85%, preferably at least 97% or at least 98% or at least 99% pure, by weight) and in which the first herbicide is not contained within polymeric microparticles, into the same aqueous liquid medium (preferably water) used for the polymeric microparticle release analysis, after the substantially pure sample of the first herbicide is placed (preferably dispersed) in and in contact with the liquid medium.

Alternatively or additionally, preferably, the polymeric microparticles containing the first herbicide are controlled-release matrices within which is the first herbicide, characterized by:

a rate of release, over a specified time period (preferably over the first 1 hour of contact, or over the first 3 hours of contact), of the first herbicide from the polymeric microparticles into a liquid medium (preferably an aqueous liquid medium e.g. water) after the polymeric microparticles are placed (preferably dispersed) in and in contact with the liquid medium,
which is reduced (typically reduced by at least 30%, preferably by at least 40% or at least 50%, more preferably by at least 60% or by at least 70% or by at least 75%, typically measured by numbers of moles of the first herbicide or measured by weight of the first herbicide calculated in a salt-free form),
compared to a rate of release or dissolution of the same first herbicide over the same specified time period, from a sample (typically a solid sample) of the same first herbicide which is in substantially pure form (e.g. at least 85%, preferably at least 97% or at least 98% or at least 99% pure, by weight) and in which the first herbicide is not contained within polymeric microparticles, into the same liquid medium (preferably the same aqueous liquid medium e.g. water) used for the polymeric microparticle release analysis, after the substantially pure sample of the first herbicide is placed (preferably dispersed) in and in contact with the liquid medium.

Preferably, in all aspects (e.g. in the first, second, third and/or fourth aspects) of the invention, the polymeric microparticles containing the first herbicide have a particle size as defined in the following paragraphs.

Particle size(s), e.g. of the polymeric microparticles containing the first herbicide, is or are typically measured by microscopy (e.g. optical microscopy or electron microscopy), or by laser diffraction and/or by light scattering. In one preferred embodiment, particle size is measured by optical or electron microscopy; more preferably by optical microscopy (light microscopy); in the optical microscopy particle size measurements, typically the particle size (e.g. of the polymeric microparticles containing the first herbicide) is measured or stated by number. In an alternative preferred embodiment, particle size (e.g. of the polymeric microparticles containing the first herbicide) is measured by laser diffraction and/or by light scattering, more preferably by light scattering laser diffraction (in particular by dynamic or static light scattering laser diffraction, typically using a Malvern Mastersizer™ instrument e.g. Malvern Mastersizer™ 2000 instrument, e.g. available from Malvern Instruments, UK); in these laser diffraction and/or light scattering particle size measurements, preferably the particle size is measured or stated by volume (e.g. by stating the mean diameter by volume=the volume-weighted mean diameter).

Generally, for particle size analysis, sphericity of the particles is assumed. Typically, in the present invention, the polymeric microparticles are substantially spherical.

When measuring particle size(s) (e.g. by number or by volume), especially by optical microscopy, particles which are generally too small to be detected by particle size analysis method (e.g. by the microscope such as an optical microscope) are preferably ignored (i.e. not taken into account) in the particle size analysis (e.g., depending on the microscope such as an optical microscope, ignoring particles smaller than 0.5 micrometres in diameter). For example, particles smaller than 0.5 micrometres in diameter are preferably ignored when measuring using a Leica Diaplan optical microscope, because 0.5 micrometres is the limit of resolution of this optical microscope (e.g. as was done in the Examples hereinafter).

Preferably, 90% or more (e.g. by volume or by number) of the polymeric microparticles containing the first herbicide have a particle size of less than or equal to 100 micrometres (microns). More preferably, 90% or more (e.g. by volume or by number) of the polymeric microparticles containing the first herbicide have a particle size of less than or equal to 50 micrometres (microns). Still more preferably, 90% or more (e.g. by volume or by number) of the polymeric microparticles containing the first herbicide have a particle size of less than or equal to 30 micrometres (microns). Yet more preferably, 90% or more (e.g. by volume or by number) of the polymeric microparticles containing the first herbicide have a particle size of less than or equal to 10 micrometres (microns). Most preferably, 90% or more (e.g. by volume or by number) of the polymeric microparticles containing the first herbicide have a particle size of less than or equal to 8 micrometres (microns). In one particular embodiment, these particle sizes are as measured by optical microscopy (especially when measured or stated by number); more particularly as measured by optical microscopy and ignoring particles smaller than 0.5 micrometres in diameter. In an alternative preferred embodiment, these particle sizes are measured by laser diffraction and/or by light scattering (especially when measured or stated by volume), in particular by light scattering laser diffraction, such as by dynamic or static light scattering laser diffraction (e.g. using a Malvern Mastersizer™ instrument).

Preferably, 50% or more (e.g. by volume or by number) of the polymeric microparticles containing the first herbicide have a particle size of less than or equal to 50 micrometres (microns). More preferably, 50% or more (e.g. by volume or by number) of the polymeric microparticles containing the first herbicide have a particle size of less than or equal to 25 micrometres (microns). Still more preferably, 50% or more (e.g. by volume or by number) of the polymeric microparticles containing the first herbicide have a particle size of less than or equal to 15 micrometres (microns). Yet more preferably, 50% or more (e.g. by volume or by number) of the polymeric microparticles containing the first herbicide have a particle size of less than or equal to 7 micrometres (microns). Most preferably, 50% or more (e.g. by volume or by number) of the polymeric microparticles containing the first herbicide have a particle size of less than or equal to 5 micrometres (microns). In one particular embodiment, these particle sizes are as measured by optical microscopy (especially when measured or stated by number); more particularly as measured by optical microscopy and ignoring particles smaller than 0.5 micrometres in diameter. In an alternative preferred embodiment, these particle sizes are measured by laser diffraction and/or by light scattering (especially when measured or stated by volume), in particular by light scattering laser diffraction, such as by dynamic or static light scattering laser diffraction (e.g. using a Malvern Mastersizer™ instrument).

Preferably, 90% or more (e.g. by volume or by number) of the polymeric microparticles containing the first herbicide have a particle size of more than or equal to 0.1 micrometres (microns). More preferably, 90% or more (e.g. by volume or by number) of the polymeric microparticles containing the first herbicide have a particle size of more than or equal to 0.3 micrometres (microns). Still more preferably, 90% or more (e.g. by volume or by number) of the polymeric microparticles containing the first herbicide have a particle size of more than or equal to 0.5 micrometres (microns). Most preferably, 90% or more (e.g. by volume or by number) of the polymeric microparticles containing the first herbicide have a particle size of more than or equal to 0.7 micrometres (microns). In one particular embodiment, these particle sizes are as measured by optical microscopy (especially when measured or stated by number); more particularly as measured by optical microscopy and ignoring particles smaller than 0.5 micrometres in diameter. In an alternative preferred embodiment, these particle sizes are measured by laser diffraction and/or by light scattering (especially when measured or stated by volume), in particular by light scattering laser diffraction, such as by dynamic or static light scattering laser diffraction (e.g. using a Malvern Mastersizer™ instrument).

Preferably, 90% or more by number or by volume of the polymeric microparticles containing the first herbicide have a particle size of less than or equal to 50 micrometres (microns); and 50% or more by number or by volume of the polymeric microparticles containing the first herbicide have a particle size of less than or equal to 25 micrometres (microns); and 90% or more by number or by volume of the polymeric microparticles containing the first herbicide have a particle size of more than or equal to 0.1 micrometres (microns) (or more than or equal to 0.3 micrometres, or more than or equal to 0.5 micrometres). In one particular embodiment, these particle sizes are as measured by optical microscopy (especially when measured or stated by number); more particularly as measured by optical microscopy and ignoring particles smaller than 0.5 micrometres in diameter. In an alternative preferred embodiment, these particle sizes are measured by laser diffraction and/or by light scattering (especially when measured or stated by volume), in particular by light scattering laser diffraction, such as by dynamic or static light scattering laser diffraction (e.g. using a Malvern Mastersizer™ instrument).

More preferably, 90% or more by number or by volume of the polymeric microparticles containing the first herbicide have a particle size of less than or equal to 30 micrometres (microns); and 50% or more by number or by volume of the polymeric microparticles containing the first herbicide have a particle size of less than or equal to 15 micrometres (microns); and 90% or more by number or by volume of the polymeric microparticles containing the first herbicide have a particle size of more than or equal to 0.1 micrometres (microns) (or more than or equal to 0.3 micrometres, or more than or equal to 0.5 micrometres). In one particular embodiment, these particle sizes are as measured by optical microscopy (especially when measured or stated by number); more preferably as measured by optical microscopy and ignoring particles smaller than 0.5 micrometres in diameter. In an alternative preferred embodiment, these particle sizes are measured by laser diffraction and/or by light scattering (especially when measured or stated by volume), in particular by light scattering laser diffraction, such as by dynamic or static light scattering laser diffraction (e.g. using a Malvern Mastersizer™ instrument).

Yet more preferably, 90% or more by number or by volume of the polymeric microparticles containing the first herbicide have a particle size of less than or equal to 10 micrometres (microns); and 50% or more by number or by volume of the polymeric microparticles containing the first herbicide have a particle size of less than or equal to 7 micrometres (microns); and 90% or more by number or by volume of the polymeric microparticles containing the first herbicide have a particle size of more than or equal to 0.3 micrometres (microns) (or more than or equal to 0.5 micrometres). In one particular embodiment, these particle sizes are as measured by optical microscopy (especially when measured or stated by number); more preferably as measured by optical microscopy and ignoring particles smaller than 0.5 micrometres in diameter. In an alternative preferred embodiment, these particle sizes are measured by laser diffraction and/or by light scattering (especially when measured or stated by volume), in particular by light scattering laser diffraction, such as by dynamic or static light scattering laser diffraction (e.g. using a Malvern Mastersizer™ instrument).

Most preferably, 90% or more by number or by volume of the polymeric microparticles containing the first herbicide have a particle size of less than or equal to 8 micrometres (microns); and 50% or more by number or by volume of the polymeric microparticles containing the first herbicide have a particle size of less than or equal to 5 micrometres (microns); and 90% or more by number or by volume of the polymeric microparticles containing the first herbicide have a particle size of more than or equal to 0.3 micrometres (microns) (or more than or equal to 0.5 micrometres, or more than or equal to 0.7 micrometres). In one particular embodiment, these particle sizes are as measured by optical microscopy (especially when measured or stated by number); more preferably as measured by optical microscopy and ignoring particles smaller than 0.5 micrometres in diameter. In an alternative preferred embodiment, these particle sizes are measured by laser diffraction and/or by light scattering (especially when measured or stated by volume), in particular by light scattering laser diffraction, such as by dynamic or static light scattering laser diffraction (e.g. using a Malvern Mastersizer™ instrument).

Preferably, the mean diameter (preferably by number (e.g. when measured by optical microscopy) or by volume (e.g. when measured by laser diffraction and/or by light scattering)) of the polymeric microparticles containing the first herbicide is from 0.2 to 50 or from 0.5 to 50 micrometres (microns), more preferably from 0.2 to 30 or from 0.5 to 30 micrometres, still more preferably from 0.5 to 20 micrometres or from 0.7 to 20 micrometres, yet more preferably from 0.5 to 15 micrometres or from 0.7 to 15 micrometres or from 1.0 to 15 micrometres; further more preferably from 0.5 to 10 micrometres or from 0.7 to 10 micrometres or from 1.0 to 10 micrometres, most preferably from 1.0 to 7 micrometres or from 1.0 to 5 micrometres or from 1.5 to 5 micrometres. Preferably, the standard deviation of the diameter (e.g. by number or by volume) of the polymeric microparticles containing the first herbicide is from 0.3 to 15 or from 0.5 to 10 or from 0.5 to 5 or from 0.7 to 4 micrometres. In one particular embodiment, these particle sizes (mean diameter and/or standard devisation of diameter) are as measured by optical microscopy, especially when measured or stated by number; more particularly as measured by optical microscopy and ignoring particles smaller than 0.5 micrometres in diameter. In an alternative preferred embodiment, these particle sizes are measured by laser diffraction and/or by light scattering (especially when measured or stated by volume), in particular by light scattering laser diffraction, such as by dynamic or static light scattering laser diffraction (e.g. using a Malvern Mastersizer™ instrument).

Preferably, the polymer microparticles comprise a polymeric matrix or matrices comprising:
a crosslinked polyester polymer or co-polymer, preferably a crosslinked polyester polymer formed from the polymerization of an unsaturated (alkene-containing) polyester resin mixed with an alkenyl-group-containing (e.g. vinyl-group-containing) monomer;
an epoxy polymer or co-polymer;
a phenolic, urea or melamine polymer or co-polymer;
a silicone or rubber polymer or co-polymer;
a polyisocyanate, polyamine or polyurethane polymer or co-polymer;
an acrylic polymer or co-polymer; such as a polymer or co-polymer of an acrylate, C₁-C₂alkyl acrylate, a methacrylate or C₁-C₂alkyl methacrylate; in particular poly(acrylic acid), an alkali metal (e.g. sodium, potassium or lithium) polyacrylate, a poly(methyl acrylate), poly(methacrylic acid), an alkali metal (e.g. sodium, potassium or lithium) polymethacrylate, or a poly(methyl methacrylate), as a polymer or co-polymer;
a polymer or co-polymer of styrene, vinyltoluene, alpha-methylstyrene, divinylbenzene, or diallylphthalate; such as polystyrene, polystyrene-co-butadiene, polystyrene-co-acrylonitrile, poly(vinyltoluene), poly(alpha-methylstyrene), poly(divinylbenzene), a copolymer of divinylbenzene with sodium or potassium methacrylate, or poly(diallylphthalate);
a polyacrylonitrile polymer or co-polymer;
a polyalkylacetate polymer or co-polymer;
a cellulose derivative; e.g. a C₁-C₃alkyl and/or hydroxypropyl derivative of cellulose (e.g. hydroxypropylmethylcellulose (HPMC), hydroxypropylcellulose (HPC), ethylcellulose (EtC) or methylcellulose (MeC)), or carboxymethylcellulose (CMC), sodium carboxymethylcellulose (NaCMC) or calcium carboxymethylcellulose (CaCMC); e.g. a cellulose derivative (e.g. HPMC, HPC, EtC, MeC, CMC, NaCMC or CaCMC) having a molecular weight of from 2000 to 4000000 or more typically from 20000 to 1000000 or from 50000 to 1000000;
polyvinylpyrrolidone (PVP) (crosslinked or non-crosslinked), e.g. PVP having a molecular weight of from 30000 to 400000;
a polyoxyethylene-polyoxypropylene copolymer (poloxamer); and/or
a cured aminoplast resin polymer.

See for example WO 2011/162944 A1 (e.g. see pages 3-9, claims 18-26, claims 30-33, and/or Examples 1-24 therein) for more details of potentially suitable polymers (often prepared from curable resins) which may be comprised in (or which may be) the polymeric matrix or matrices according to the present invention.

More preferably, the polymer microparticles comprise a polymeric matrix or matrices comprising:
a crosslinked polyester polymer or co-polymer, preferably a crosslinked polyester polymer formed from the polymerization of an unsaturated (alkene-containing) polyester resin mixed with an alkenyl-group-containing (e.g. vinyl-group-containing) monomer; and/or
an epoxy polymer or co-polymer.

Still more preferably, the polymer microparticles comprise a polymeric matrix or matrices comprising a crosslinked polyester polymer or co-polymer, preferably a crosslinked polyester polymer formed from the polymerization of an unsaturated (alkene-containing) polyester resin mixed with an alkenyl-group-containing (e.g. vinyl-group-containing) monomer.

In this crosslinked polyester polymer or co-polymer embodiment of the invention, preferably, the alkenyl-group-containing (e.g. vinyl-group-containing) monomer comprises (e.g. consists essentially of) styrene, vinyltoluene, alpha-methylstyrene, divinylbenzene, diallylphthalate, acrylonitrile, an acrylate, C₁-C₂alkyl acrylate, a methacrylate or C₁-C₂alkyl methacrylate. More preferably, the alkenyl-group-containing (e.g. vinyl-group-containing) monomer comprises (e.g. consists essentially of) styrene, vinyltoluene, alpha-methylstyrene or divinylbenzene. Most preferably, the alkenyl-group-containing (e.g. vinyl-group-containing) monomer comprises (e.g. consists essentially of) styrene.

In this crosslinked polyester polymer or co-polymer embodiment of the invention, preferably, the unsaturated (alkene-containing) polyester resin has been formed from a non-alkene-containing di-carboxylic acid (such as ortho-phthalic acid) polymerised with a alkene-containing diol or glycol.

In particular, a highly preferred crosslinked polyester polymer is formed from the polymerization of a resin mixture of (i) an unsaturated (alkene-containing) polyester resin formed from ortho-phthalic acid polymerised with an alkene-containing diol or glycol, and (ii) styrene. A preferred example of such an uncured (unpolymerised) resin mixture, having a styrene content of about 45% by weight of the resin mixture, is for example available as VIAPAL™ VUP 4779/55, from Cytec Industries Inc., Smyrna, Ga., USA, or from Cytec Surface Specialities in Belgium and Germany (www.cytec.com). Polymerization (curing) of such a resin mixture (e.g. VIAPAL™ VUP 4779/55), typically in the presence of a radical initiator such as AIBN or a suitable peroxy compound such as a peroxyester, preferably at a temperature sufficiently high so as to initiate the radical curing reaction typically at a temperature of 55-95° C. (such as at 65-90° C., preferably at 70-85° C.), and/or preferably for from 0.3 to 15 hours (in particular 0.7 to 8 hours), leads to formation of a crosslinked polyester polymer. Preferably, the uncured polyester-containing resin mixture is liquid at room temperature (e.g. at 15-30° C.).

In an alternative optional embodiment of the crosslinked polyester polymer or co-polymer embodiment of the invention, the unsaturated (alkene-containing) polyester resin can have been formed at least partly from an alkene-containing di-carboxylic acid (such as fumaric acid, alone or with a further di-carboxylic acid such as isophthalic acid) polymerised with a saturated diol or glycol such as ethylene glycol. See for example EP 0 517 669 A1, page 3 lines 19-28, and Example 1 section b and Example 2 section b, all incorporated herein by reference, for unsaturated polyester resins formed from fumaric acid+isophthalic acid+glycol, thought to be available from Ashland Chemicals e.g. under the AROPOL trademark.

Preferably, in the crosslinked polyester polymer formed from the polymerization of the unsaturated (alkene-containing) polyester resin mixed with the alkenyl-group-containing (e.g. vinyl-group-containing) monomer, and/or in the uncured (unpolymerized) mixture of the unsaturated (alkene-containing) polyester resin and the alkenyl-group-containing (e.g. vinyl-group-containing) monomer, the alkenyl-group-containing (e.g. vinyl-group-containing) monomer, such as e.g. styrene, is (or was before polymerization) present at a concentration of from 25% to 60% (e.g. from 35 to 55%, e.g. about 45%) by weight of the crosslinked polyester polymer and/or by weight of the pre-polymerization resin.

When the polymer microparticles comprise a polymeric matrix or matrices comprising an epoxy polymer or co-polymer, then preferably the polymeric matrix or matrices comprise (e.g. are) a cured epoxy resin polymer matrix prepared from curing an epoxy resin mixed with a hardener, optionally also mixed with a tertiary amine catalyst (e.g. an aliphatic, cycloaliphatic and/or aromatic tertiary amine catalyst). Preferably, the epoxy resin is selected from di- and poly-epoxide monomers, prepolymers and blends thereof. In particular, in the epoxy resin, a di- or poly-epoxide can be aliphatic, cycloaliphatic or aromatic, with typical examples including the diglycidyl ethers of bisphenol A, glycerol or resorcinol. More preferably, the epoxy resin comprises resorcinol diglycidyl ether. Preferably, the epoxy resin is liquid at room temperature (e.g. at 15 to 30° C.). Preferably, the hardener, e.g. for curing the epoxy resin, is selected from primary and secondary amines and their adducts, cyanamide, dicyandiamide, polycarboxylic acids, anhydrides of polycarboxylic acids (e.g. phthalic anhydride, or a methyl-substituted derivative and/or a tetrahydro- or hexahydro-derivative of phthalic anhydride, or nadic anhydride), polyamines (e.g. a diamine and/or a triamine, such as polyoxypropylene diamine), polyamides, polysulfides, mercaptanes, polyamino-amides, polyadducts of amines and polyepoxides, polyols, and mixtures thereof. In a particular embodiment, the hardener, e.g. for curing the epoxy resin, comprises a diamine and/or triamine such as an aliphatic, cycloaliphatic or aromatic diamine and/or triamine, in particular polyoxypropylene diamine, diaminocyclohexane, xylene diamine, phenylene diamine, diethylene triamine and/or polyoxypropylene triamine. In an alternative particular embodiment, the hardener, e.g. for curing the epoxy resin, comprises an anhydride of a polycarboxylic acid, in particular phthalic anhydride, or a methyl-substituted derivative and/or a tetrahydro- or hexahydro-derivative of phthalic anhydride, or nadic anhydride. Preferably, where the hardener comprises an anhydride of a polycarboxylic acid, the hardener is mixed with a tertiary amine catalyst such as an aliphatic, cycloaliphatic and/or aromatic tertiary amine catalyst. Typically, in order to cure the epoxy resin, a mixture comprising the epoxy resin and the hardener, and optionally also a tertiary amine catalyst (e.g. the mixture being dispersed in a continuous liquid (e.g. aqueous) phase or medium), is held at a temperature of from 30 to 120° C. (e.g. from 60-95° C. or from 70-90° C.) for from 0.1 to 15 hours (e.g. from 1-12 hours), in order to effect the curing reaction to prepare the cured epoxy resin polymer matrix.

Preferably, the amount of the first herbicide contained within the polymeric microparticles is up to 50%, preferably from 1 to 50% or from 5 to 50%, by weight of the polymeric microparticles containing the first herbicide.

More preferably, the amount of the first herbicide contained within the polymeric microparticles is up to 40%, preferably from 1 to 40% or from 5 to 40% or from 10 to 40%, in particular from 15 to 40%, by weight of the polymeric microparticles containing the first herbicide.

Still more preferably, the amount of the first herbicide contained within the polymeric microparticles is up to 35%, preferably from 1 to 35% or from 5 to 35% or from 10 to 35%, in particular from 15 to 35%, by weight of the polymeric microparticles containing the first herbicide.

Yet more preferably, the amount of the first herbicide contained within the polymeric microparticles is up to 30%, preferably from 5 to 30% or from 10 to 30%, in particular from 15 to 30% or from 15 to 25%, by weight of the polymeric microparticles containing the first herbicide.

Preferably, in all aspects of the present invention, the amount of the first herbicide present in the herbicidal composition is up to 50%, or from 1 to 50% or from 5 to 50%; or more preferably up to 40%, or from 1 to 40% or from 5 to 40% or from 10 to 40% or from 15 to 40%; or still more preferably up to 35%, or from 1 to 35% or from 5 to 35% or from 10 to 35% or from 15 to 35%; or yet more preferably up to 30%, or from 1 to 30% or from 5 to 30% or from 10 to 30% or from 15 to 30%; of the weight of the polymeric microparticles present in the herbicidal composition.

For the polymeric microparticles, when the polymer has been formed by radical initiation, then preferably the polymeric microparticles contain a radical initiator and/or the reacted residue(s) therefrom, generally present in from 0.3 to 5%, preferably from 0.5 to 4% or from 1 to 3%, by weight of the polymeric microparticles containing the first herbicide. The radical initiator preferably comprises an azo compound such as azo-bis-isobutyronitrile (AIBN), or a suitable peroxy compound such as: a di(C₁-C₈alkyl) peroxide such as di-tert-butyl peroxide, a peroxyacid such as benzoyl peroxide, a ketone peroxide such as methyl ethyl ketone peroxide, a peroxyketal such as 1,1-di(tert-amylperoxy)-cyclohexane, a peroxyester such as tert-butyl peroxy benzoate or 2,5-dimethyl-2,5-di(2-ethylhexanoylperoxy)hexane, a hydroperoxide such as cumene hydroperoxide, or a peroxycarbonate such as tert-butyl peroxy-2-ethylhexyl carbonate. Preferably, the radical initiator comprises azo-bis-isobutyronitrile (AIBN). For example, a radical initiator is suitably used, e.g. for forming the polymer, when the polymeric microparticles comprise a polymeric matrix or matrices comprising a crosslinked polyester polymer formed from the polymerization of an unsaturated (alkene-containing) polyester resin mixed with an alkenyl-group-containing (e.g. vinyl-group-containing) monomer.

Optionally, the polymeric microparticles can contain a non-volatile solvent, an oil and/or a plasticizer (in particular a plasticizer); which for example can be present in up to about 30% (e.g. 0.1 to 30%), in particular up to about 20% (e.g. 0.1 to about 20%) and more particularly up to about 10% (e.g. 0.1 to about 10%), by weight of the polymeric microparticles containing the first herbicide. Particularly, the non-volatile solvent, oil and/or plasticizer is a phthalate ester such as dibutylphthalate, a polyadipate such as Edenol 1215™ (from Cognis), a benzoate ester such as methyl benzoate, dipropylene glycol dibenzoate (e.g. Benzoflex 9-88™, from Genovique), or diethylene glycol dibenzoate (e.g. Benzoflex 2-45™, from Genovique), a polybutene such as the Indopol H™ series e.g. Indopol H050 (from Ineos), an aromatic hydrocarbon solvent such as Solvesso 200, or a C₁-C₄alkyl fatty acid ester such as methyl oleate.

Preferably, however, the polymeric microparticles either contain no non-volatile solvent, oil or plasticizer, or contain up to 5% (e.g. 0.1 to 5%), or more preferably up to 2% (e.g. 0.1 to 2%) or up to 1% (e.g. 0.1 to 1%) of the non-volatile solvent, oil and/or plasticizer (in particular plasticizer), by weight of the polymeric microparticles containing the first herbicide. As is shown by Polymeric Microparticle Examples 2 and 3, higher percentages of non-volatile solvent, oil and/or plasticizer (in particular plasticizer), e.g. ca. 10% or ca. 20% of plasticizer, by weight of the polymeric microparticles containing the first herbicide, are generally best avoided, at least when the polymeric microparticles comprise a polymeric matrix or matrices comprising a crosslinked polyester polymer or co-polymer.

In all aspects of the invention, especially in the second, third, fourth and/or later aspects of the invention, preferably, the polymeric microparticles are present in from 0.3 to 70% or from 1 to 60%, more preferably from 3 to 50% or from 7 to 50%, still more preferably from 10 to 45%, yet more preferably from 13 to 40%, most preferably from 18 to 35%, by weight of the herbicidal composition (e.g. by weight of a or the dispersion or dispersion composition).

In all aspects of the invention, especially in the second, third, fourth and/or later aspects of the invention, preferably, the amount of the first herbicide present in the composition (or the amount of the first herbicide contained within the polymeric microparticles) is from 0.1 to 25%, more preferably from 0.5 to 20% or from 1 to 20%, still more preferably from 0.5 to 15% or from 1 to 15% or from 2 to 15%, yet more preferably from 1 to 10% or from 2 to 10%, by weight of the herbicidal composition (e.g. by weight of a or the dispersion or dispersion composition).

Typically, in a composition comprising pinoxaden (such as in the first aspect of the invention and later methods of use referring back to this first aspect, which compositions are usually diluted e.g. aqueous diluted compositions suitable for spraying directly onto a field), the polymeric microparticles are present in from 0.0003 to 10% or from 0.001 to 5%, more preferably from 0.005 to 1% or from 0.01 to 0.5%, by weight of the herbicidal composition (e.g. by weight of a or the diluted e.g. aqueous diluted composition suitable for spraying directly onto a field).

Preferred, Particular and/or Optional Embodiments of the First Herbicide

The preferred, particular, suitable or optional features of the first herbicide are now described, for all aspects of the invention.

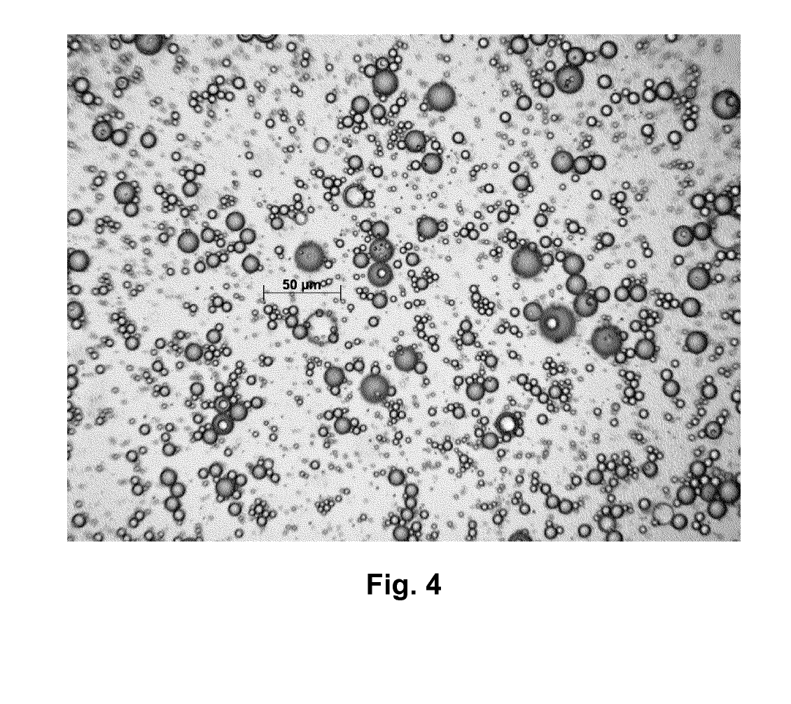

Preferably, the synthetic auxin herbicide is defined as a compound that is a herbicide and that, either itself or after the removal of any procide groups present thereon, stimulates the expression of B-glucuronidase (GUS) in transgenic Arabidopsis plantlets line AtEM101 (e.g. as disclosed in Lindsey and Topping, The Plant Cell, 1997, vol. 9, pp. 1713-1725) in an assay/test in which:
seeds of AtEM101 are germinated aseptically on half-strength Murashige and Skoog medium containing a test compound at a range of doses between 0 and 200 uM and assayed for GUS activity at 6 days post-germination; and
either, for a quantitative GUS assay, protein crude extracts of the plantlets are prepared and a fluorometric assay is used, e.g. as described by Jefferson et al. EMBO J., 1987, vol. 6, pp. 3901-3907;
or, whole plantlets are transferred to 100 mM sodium phosphate buffer at pH 7.0 containing 10 mM EDTA, 0.1% Triton X-100, 1 mM potassium ferricyanide, 1 mM potassium ferrocyanide and 1 mM 5-bromo-4-chloro-3-indolyl β-D-glucuronic acid (X-gluc) and incubated for 12 hours at 37° C.; stained plantlets are then removed and cleared of chlorophyll by soaking in 70% (v/v) ethanol; the amount of overall blue staining is then assessed and compared visually; and
a synthetic auxin is defined in this assay/test as a test compound which exhibits a dose response of GUS activity or blue staining dependent on the concentration of test compound present during the germination and growth of the AtEM101 Arabidopsis plantlet (and for example can be as depicted in FIG. 4A of Lindsey and Topping, The Plant Cell, 1997, vol. 9, pp. 1713-1725 and in respect of napthylacetic acid); and
a synthetic auxin is further defined in this assay/test as a compound that, when assayed/tested under the above conditions, and at a concentration of 50 μM (50 micromolar), results in at least about a doubling (e.g. a doubling or more) of GUS activity or of the amount of blue staining, relative to the amount of GUS activity or blue staining obtained with like AtEM101 plantlets like-grown in the absence of the test compound.

Preferably, an acetolactate synthase (ALS) inhibitor herbicide is defined as a compound that is a herbicide and that, either itself or after the removal of any procide groups present thereon, inhibits, at a concentration less than 100 μM, the specific activity of acetolactate synthase by more than 90% relative to similar controls run in the absence of the compound; and preferably where the comparative rate measurements are made at or after a reaction time of at least 200 minutes. Preferably, the acetolactate synthase is a non-herbicide-resistant version of ALS. Preferably, the acetolactate synthase has been prepared as described in T. Hawkes et al., in ‘Herbicides and Plant Metabolism’: ed. A. D. Dodge, Society for Experimental Biology Seminar Series 38, Cambridge University Press, Untied Kingdom, 1989, pp. 113-136; or more preferably has been prepared according to the Legend to Table 1 on page 119 of said publication.

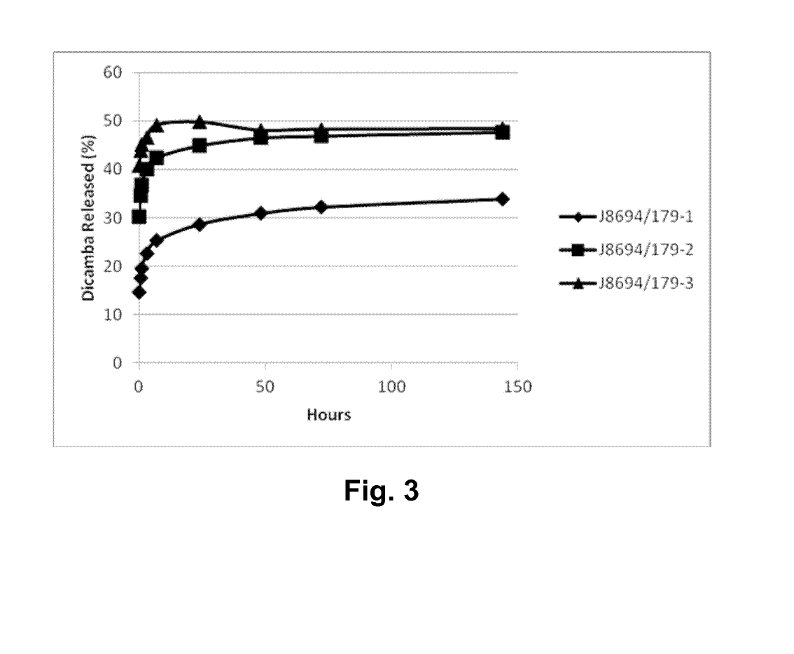

More preferably, an ALS inhibitor herbicide is defined as a compound that is a herbicide and that, either itself or after the removal of any procide groups present thereon, inhibits acetolactate synthase according to a assay (test) method comprising the steps of:
providing an ALS enzyme which has been prepared as described in the Legend to Table 1 on page 119 of T. Hawkes et al., in ‘Herbicides and Plant Metabolism’: ed. A. D. Dodge, Society for Experimental Biology Seminar Series 38, Cambridge University Press, United Kingdom, 1989, pp. 113-136; and
assaying (testing) the compound at a range of doses between 0 and 200 μM, in the presence of the ALS enzyme, according to the method described in the legend of FIG. 3 on page 124 of T. Hawkes et al. (from ‘Herbicides and Plant Metabolism’: ed. A. D. Dodge, Society for Experimental Biology Seminar Series 38, Cambridge University Press, United Kingdom, 1989, pp. 113-136); and
defining the test compound as being an ALS inhibitor if it inhibits, at a concentration less than 100 μM, the specific activity of ALS by more than 90% relative to similar controls run in the absence of the test compound, and where the comparative rate measurements are made at or after a reaction time of at least 200 minutes.

In the invention, the first herbicide, when in a salt-free form or when in a non-aluminium salt form, antagonises the herbicidal activity of pinoxaden. This can be measured using the glasshouse assay for pinoxaden antagonism as described in Assay 3 hereinafter.

Preferably, the first herbicide, contained within polymeric microparticles, is selective on (i.e. suitable for use on) non-oat cereal crops, such as wheat, barley, rye and/or triticale, more preferably wheat and/or barley. This can be measured using the glasshouse assay as described in Assay 4 hereinafter [“glasshouse assay for measuring the selectivity on, i.e. suitability for use on, non-oat cereals (e.g. wheat and/or barley) of the first herbicide”].

When the first herbicide is a synthetic auxin herbicide, then preferably it is dicamba, 2,4-D or MCPA; or an agrochemically acceptable salt thereof.

Dicamba is 3,6-dichloro-2-methoxybenzoic acid. 2,4-D is (2,4-dichlorophenoxy)acetic acid]. MCPA is (4-chloro-2-methylphenoxy)acetic acid.

When the first herbicide is an ALS inhibitor herbicide, then preferably it is:
a sulfonyl urea herbicide, preferably triasulfuron, tribenuron-methyl, iodosulfuron-methyl, mesosulfuron-methyl, sulfosulfuron, or flupyrsulfuron-methyl; or an agrochemically acceptable salt thereof;
or a triazolopyrimidine herbicide, preferably pyroxsulam or an agrochemically acceptable salt thereof.

More preferably, when the first herbicide is an ALS inhibitor herbicide, then it is: triasulfuron, tribenuron-methyl, iodosulfuron-methyl, mesosulfuron-methyl, sulfosulfuron, flupyrsulfuron-methyl, or pyroxsulam; or an agrochemically acceptable salt thereof.

Still more preferably, when the first herbicide is an ALS inhibitor herbicide, then it is: triasulfuron, tribenuron-methyl, or pyroxsulam; or an agrochemically acceptable salt thereof.

Preferably, the first herbicide is: dicamba, 2,4-D, MCPA, triasulfuron, tribenuron-methyl, iodosulfuron-methyl, mesosulfuron-methyl, sulfosulfuron, flupyrsulfuron-methyl, or pyroxsulam; or an agrochemically acceptable salt thereof.

More preferably, the first herbicide is: dicamba, 2,4-D, MCPA, triasulfuron, tribenuron-methyl, or pyroxsulam; or an agrochemically acceptable salt thereof.

Still more preferably, the first herbicide is: dicamba, MCPA, triasulfuron, or pyroxsulam; or an agrochemically acceptable salt thereof.

In the composition, the weight ratio of dicamba or an agrochemically acceptable salt thereof (measured as the free acid) to pinoxaden preferably is 80:1 to 4:3, more preferably is 16:1 to 4:3, or still more preferably is 14:3 to 5:3, or yet more preferably is from 14:3 to 20:9.

In the composition, the weight ratio of MCPA or an agrochemically acceptable salt thereof (measured as the free acid) to pinoxaden preferably is from 450:1 to 14:3, more preferably from 110:1 to 35:6, or still more preferably is from 110:3 to 35:6.

In the composition, the weight ratio of 2,4-D or an agrochemically acceptable salt thereof (measured as the free acid) to pinoxaden preferably is from 460:1 to 14:3, or more preferably is from 110:1 to 35:6, or still more preferably is from 100:3 to 20:3.

In the composition, the weight ratio of triasulfuron or an agrochemically acceptable salt thereof (measured as the free acid) to pinoxaden preferably is from 3:1 to 1:12, or more preferably is from 1:1 to 1:12, or still more preferably is from 1:3 to 1:12.

In the composition, the weight ratio of tribenuron-methyl or an agrochemically acceptable salt thereof (measured as the free acid) to pinoxaden preferably is from 6:1 to 1:8, or more preferably is from 2:1 to 5:24, or still more preferably is from 1:1 to 1:4.

In the composition, the weight ratio of iodosulfuron-methyl or an agrochemically acceptable salt thereof (measured as the free acid) to pinoxaden preferably is from 3:1 to 1:12, or more preferably is from 1:1 to 1:12, or still more preferably is from 1:3 to 1:6.

In the composition, the weight ratio of mesosulfuron-methyl or an agrochemically acceptable salt thereof (measured as the free acid) to pinoxaden preferably is from 4:1 to 1:6, or more preferably is from 4:3 to 1:6, or still more preferably is from 1:2 to 1:4.

In the composition, the weight ratio of sulfosulfuron or an agrochemically acceptable salt thereof (measured as the free acid) to pinoxaden preferably is from 7:1 to 1:6, or more preferably is from 7:3 to 1:6, or still more preferably is from 7:6 to 1:6.

In the composition, the weight ratio of flupyrsulfuron-methyl or an agrochemically acceptable salt thereof (measured as the free acid) to pinoxaden preferably is from 3:1 to 1:12, or more preferably is from 1:1 to 1:12, or still more preferably is from 1:3 to 1:6.

In the composition, the weight ratio of pyroxsulam or an agrochemically acceptable salt thereof (measured as the free acid) to pinoxaden preferably is from 15:4 to 3:20, or more preferably is from 15:12 to 3:20, or still more preferably is from 1:2 to 11:60.

In a particular embodiment of the herbicidal composition (e.g. liquid or solid composition), at least part of, preferably 50% or more (more preferably 70% or more, e.g. 90% or more, e.g. 95% or more) by weight of, the first herbicide contained within the polymeric microparticles (e.g. a synthetic auxin herbicide or an ALS inhibitor herbicide) is present within the polymeric microparticles in non-crystalline form; especially for a synthetic auxin herbicide such as dicamba or a salt thereof.

In an alternative particular embodiment of the herbicidal composition (e.g. liquid or solid composition), at least part of, preferably 50% or more (more preferably 70% or more, e.g. 90% or more, e.g. 95% or more) by weight of, the first herbicide contained within the polymeric microparticles (e.g. a synthetic auxin herbicide, such as MCPA or 24-D or a salt thereof, or more preferably for an ALS inhibitor herbicide, such as a sulfonyl urea herbicide) is present as solid (e.g. milled solid) particles of the first herbicide dispersed within the polymeric microparticles, in particular as solid particles (e.g. crystalline or amorphous solid particles) of the first herbicide whose “mean” or “D90” particle size is less than 10 micrometres, more preferably less than 5 micrometres or less than 3 micrometres.

Preferred, Particular and/or Optional Embodiments of the Herbicidal Composition

Preferred, particular and/or optional embodiments of the herbicidal composition, for any or all aspects (especially the first, second, third and/or fourth aspects) of the present invention, except where mentioned otherwise and except where inappropriate, are as follows.

Preferably, in the first aspect of the invention, the herbicidal composition is a dispersion composition (preferably aqueous) in which the polymeric microparticles are dispersed in a continuous (preferably aqueous) liquid phase or medium, a suspension concentrate composition (e.g. aqueous or non-aqueous), a suspoemulsion composition (e.g. aqueous suspoemulsion, in particular a suspoemulsion comprising an emulsified oily and/or non-aqueous liquid phase and a dispersed/suspended solid both in a continuous [preferably aqueous] liquid phase or medium), or a solid composition (e.g. granule or powder composition). In these compositions, in a particular embodiment at least part of, preferably 50% of more (more preferably 70% or more, e.g. 90% or more, e.g. 95% or more) by weight of, the first herbicide contained within the polymeric microparticles is present within the polymeric microparticles in non-crystalline form.

In all aspects (especially the first, second, third and/or fourth aspects) of the present invention, in one particularly preferred embodiment, the herbicidal composition (and/or the first herbicidal composition e.g. as described in the seventh (tank-mixing) aspect of the invention hereinafter) is a dispersion composition (preferably aqueous) in which the polymeric microparticles are dispersed in a continuous (preferably aqueous) liquid phase or medium. In these compositions, in a particular embodiment at least part of, preferably 50% of more (more preferably 70% or more, e.g. 90% or more, e.g. 95% or more) by weight of, the first herbicide contained within the polymeric microparticles is present within the polymeric microparticles in non-crystalline form.

In all aspects of the present invention, “dispersion composition” means any composition in which the polymeric microparticles are dispersed in a continuous liquid phase or medium The continuous liquid phase or medium can be aqueous (preferably water, but alternatively a mixture of water and a water-miscible organic solvent), or can be non-aqueous e.g. comprising one or more organic solvents. Therefore, in all aspects of the present invention, the term “dispersion composition” encompasses, for example, a type of suspoemulsion in which an oily and/or non-aqueous liquid phase is emulsified in, and a dispersed/suspended solid comprising the polymeric microparticles is dispersed in, the continuous (preferably aqueous) liquid phase or medium.

In the dispersion composition embodiments of the present invention, preferably, the dispersion of the polymeric microparticles in the continuous (preferably aqueous) liquid phase or medium is stabilised by a stabilizer and/or a dispersant and/or a surfactant.

In the dispersion composition embodiments or aspects of the invention, the stabilizer and/or the dispersant and/or the surfactant (e.g. nonionic surfactant) is preferably present in from 0.2 to 30%, or more preferably is present in from 0.3 to 20% or from 1 to 15% or from 1 to 10% (most preferably (especially for polyvinyl alcohol) from 3 to 6%) by weight of the dispersion (dispersion composition).

More preferably, the stabilizer and/or dispersant and/or surfactant comprises:
a polymeric barrier dispersant or surfactant (preferably nonionic) such as polyvinyl alcohol; and/or
a dispersant comprising an alkali metal (e.g. sodium) or alkaline earth metal (e.g. calcium) lignosulfonate (e.g. which generally acts as a dispersant with also some emulsifying activity), an alkali metal (e.g. sodium) or alkaline earth metal (e.g. calcium) naphthalenesulfonate (e.g. which generally acts as a dispersant with also some emulsifying activity), a naphthalenesulfonate-formaldehyde copolymer, poly(methylvinylether/maleic acid), and/or a polyethyleneoxide/polypropyleneoxide (EO-PO) block copolymer (e.g. Pluronic™, from BASF); and/or
a surfactant (e.g. non-ionic, anionic and/or cationic surfactant; e.g. as disclosed hereinafter).

The above listed stabilizers and/or dispersants generally give “regular” dispersions of the polymeric microparticles.

In the first, second, fourth, and/or later aspects of the invention, a polymeric barrier dispersant or surfactant (particularly nonionic, more preferably polyvinyl alcohol) is the preferred stabilizer and/or dispersant.

In the first, second, fourth, and/or later aspects of the invention, preferably, the composition comprises a nonionic surfactant (preferably a nonionic polymeric barrier surfactant, more preferably polyvinyl alcohol).

Typical nonionic surfactants, e.g. for use in the present invention, include polyglycol ether derivatives of aliphatic or cycloaliphatic alcohols, of saturated or unsaturated fatty acids or of alkyl phenols which may contain approximately 3 to approximately 30 glycol ether groups and approximately 8 to approximately 20 carbon atoms in the (cyclo)aliphatic hydrocarbon radical or approximately 6 to approximately 18 carbon atoms in the alkyl moiety of the alkyl phenols. Also typical are water-soluble polyethylene oxide adducts with polypropylene glycol, ethylenediaminopolypropylene glycol or alkyl polypropylene glycol having 1 to approximately 10 carbon atoms in the alkyl chain and approximately 20 to approximately 250 ethylene glycol ether groups and approximately 10 to approximately 100 propylene glycol ether groups. Normally, the abovementioned compounds contain 1 to approximately 5 ethylene glycol units per propylene glycol unit. Examples which may be mentioned are nonylphenoxypolyethoxyethanol, castor oil polyglycol ether, polypropylene glycol/polyethylene oxide adducts, tributylphenoxypolyethoxyethanol, polyethylene glycol or octylphenoxypolyethoxyethanol. Also typical are fatty acid esters of polyoxyethylene sorbitan, such as polyoxyethylene sorbitan trioleate.

When the herbicidal composition is a dispersion composition in which the polymeric microparticles are dispersed in a continuous liquid phase or medium, then preferably a or the nonionic surfactant (preferably a nonionic polymeric barrier surfactant, more preferably polyvinyl alcohol) is present in the continuous liquid phase or medium, such that the nonionic surfactant stabilizes the dispersion of the polymeric microparticles in the continuous liquid phase or medium (e.g. as in the second or fourth aspects of the invention—but also preferred for other aspects eg the first aspect of the invention).

In all aspects (e.g. the first, second, fourth and/or later aspects) of the present invention, especially for a dispersion composition, preferably, the weight ratio of the polymeric microparticles to a or the nonionic surfactant (preferably a nonionic polymeric barrier surfactant, more preferably polyvinyl alcohol) in the herbicidal composition is from 40:1 to 1:2. This feature is always mentioned in the second aspect of the invention.

In all aspects (especially the second aspect) of the present invention, especially for a dispersion composition, more preferably, the weight ratio of the polymeric microparticles to a or the nonionic surfactant (preferably a nonionic polymeric barrier surfactant, more preferably polyvinyl alcohol) in the herbicidal composition is from 20:1 to 1:1.5 or from 20:1 to 1:1 or from 20:1 to 1.25:1, still more preferably from 15:1 to 1.25:1 or from 15:1 to 2.0:1, even more preferably from 10:1 to 2.0:1 or from 10:1 to 2.5:1, yet more preferably from 7.5:1 to 2.0:1 or from 7.5:1 to 2.5:1 or from 7.5:1 to 3.0:1, further more preferably from 6.8:1 to 2.5:1 or from 6.8:1 to 3.0:1 or from 6.3:1 to 3.0:1, most preferably from 6.0:1 to 4.0:1 from 6.0:1 to 3.5:1 or or from 5.0:1 to 4.0:1.

In all aspects of the present invention, especially for a dispersion composition and/or especially where a nonionic surfactant is present, then preferably, either the composition comprises no ionic surfactant, or the composition comprises an ionic surfactant and the weight ratio of the polymeric microparticles to the ionic surfactant in the herbicidal composition is 200:1 or more (e.g. from 200:1 to 50000:1). This feature is always mentioned in the second aspect of the invention.

In all aspects (especially the second aspect) of the present invention, especially for a dispersion composition, more preferably, either the composition comprises no ionic surfactant, or the composition comprises an ionic surfactant and the weight ratio of the polymeric microparticles to the ionic surfactant in the herbicidal composition is 300:1 or more (e.g. from 300:1 to 50000:1), still more preferably no ionic surfactant or the weight ratio is 330:1 or more (e.g. from 330:1 to 50000:1), even more preferably no ionic surfactant or the weight ratio is 500:1 or more (e.g. from 500:1 to 50000:1), yet more preferably no ionic surfactant or the weight ratio is 670:1 or more (e.g. from 670:1 to 50000:1), further more preferably no ionic surfactant or the weight ratio is 1200:1 or more (e.g. from 1200:1 to 50000:1). Most preferably, the composition comprises essentially no (or no) ionic surfactant.

In an alternative particular embodiment (e.g. an embodiment of the first aspect of the invention), especially in a dispersion composition, the stabilizer or dispersant comprises a colloidal and/or nanoparticulate solid which is capable of staying at the interface between a continuous and dispersed phase, such as silicon dioxide or clay (e.g. to give “Pickering” dispersions of the polymeric microparticles).

When the stabilizer or dispersant comprises a colloidal and/or nanoparticulate clay solid, the clay typically comprises (i) a kaolin group clay such as kaolinite, dicksite, halloysite, nacrite or serpentine (typically kaolinite), (ii) a smectite group clay such as montmorillonite, nontronite or saponite (typically montmorillonite), (iii) an illite group clay such as illite, and/or (iv) attapulgite or sepiolite. Preferably, the clay comprises (e.g. is) a kaolin group clay (typically kaolinite) or montmorillonite. For example, the clay can be bentonite, which is an impure clay comprising montmorillonite, a particular example of bentonite being a mixture of montmorillonite and kaolinite. More preferably, however, the clay comprises (e.g. is) a kaolin group clay, typically kaolinite. In one particular embodiment, in a composition according to any aspect of the invention, the composition comprises a clay stabilizer or dispersant comprising (e.g. being) a kaolin group clay, such as kaolinite, and a xanthan gum capable of contacting the kaolin group clay.

More preferably, the clay stabilizer or dispersant is a surface-modified clay (e.g. smectite group or preferably kaolin group clay). The presence of a surface-modified clay is mentioned in the third aspect of the invention.

Even more preferably, e.g. in the first and/or third aspects of the invention, the clay stabilizer or dispersant (or the surface-modified clay) is a clay (in particular, an aminated clay, such as an aminated smectite group or preferably kaolin group clay) which has been surface-modified such that the surface-modified clay (i) is capable of being at least partially wetted by an aqueous liquid phase, (ii) is capable of being at least partially wetted by a non-aqueous oil liquid phase, and (iii) is capable of stabilizing an oil-and-water-containing emulsion (e.g. Pickering emulsion) through adsorption at a or the oil/water interface.

Still more preferably, e.g. in the first and/or third aspects of the invention, the clay stabilizer or dispersant (or the surface-modified clay) is an amino-silane-modified clay (e.g. an amino-silane-modified smectite group or preferably kaolin group clay). The amino-silane-modified clay is preferably prepared by reacting or adsorbing the silane group of an amino-silane surface-modifying agent with or to the surface of the clay so as to form free amine groups attached to the clay surface. Preferably, in the amino-silane-modified clay, the free amine groups are attached via a C₂₋₆alkylene linker, such as a propylene or ethylene linker, to the clay surface (see e.g. page 8 line 26 to page 9 line 17 of WO2009/063257, incorporated herein by reference). Preferably, the amino-silane surface-modifying agent is an (amino-C₂₋₆alkylene)-substituted silane wherein the amino-C₂₋₆alkylene substituent is bonded to the silicon atom though a carbon atom; more preferably the surface-modifying agent is aminopropyltriethoxysilane; e.g. see pages 8-9 and Example 1 of WO2009/063257 incorporated herein by reference. Most preferably, the amino-silane-modified clay is Imerys™ RLO 7645, which is generally described in Example 1 of patent application WO2009/063257 (incorporated herein by reference), and which is available from Imerys Group, USA (www.imerys.com). More specifically, Imerys™ RLO 7645 is a tabular ultrafine kaolin clay that has been surface-modified by the addition of 1.6% by weight of aminopropyltriethoxysilane. In Imerys™ RLO 7645, the kaolin clay is tabular (ie “blocky”, flat or plate-like in shape), and the surface-modified (amino-silane modified) kaolin clay is ultrafine, typically having a particle size distribution in which: at least 98% of the particles are smaller than 1 micron (micrometre), 82% of the particles are smaller than 0.25 microns (micrometres), and the D50 (median diameter) is 0.12 microns (micrometres). As an example only, it is thought that a surface-modified (amino-silane-modified) kaolin clay should be capable of being prepared by mixing the clay with a solution of an amino-silane surface-modifying agent (e.g. aminopropyltriethoxysilane) in a solvent (e.g. aqueous and/or organic solvent), typically in a suitable mixer such as food blender.

The clay, in particular the surface-modified clay, typically has a particle size defined by a median diameter (e.g. by number) of from 0.01 to 2 microns, in particular from 0.05 to 0.5 microns (micrometres), e.g. as measured by scanning electron microscopy. The clay's particle size is small.

In dispersion compositions, especially in the third aspect of the invention, preferably, the clay (especially surface-modified clay) is present in from 0.2 to 20%, more preferably from 0.5 to 12%, still more preferably from 1 to 7%, yet more preferably from 1.25 to 5%, by weight of the dispersion composition.

In all aspect of the invention, especially in the third aspect of the invention (relating to surface-modified clay), preferably, the weight ratio of the polymeric microparticles to the clay (in particular surface-modified clay) in the herbicidal composition is from 100:1 to 2:1 or from 100:1 to 3:1, more preferably from 40:1 to 2:1 or from 40:1 to 3:1 or from 40:1 to 4:1, yet more preferably from 20:1 to 4:1 or from 20:1 to 5:1, in particular from 15:1 to 6:1.

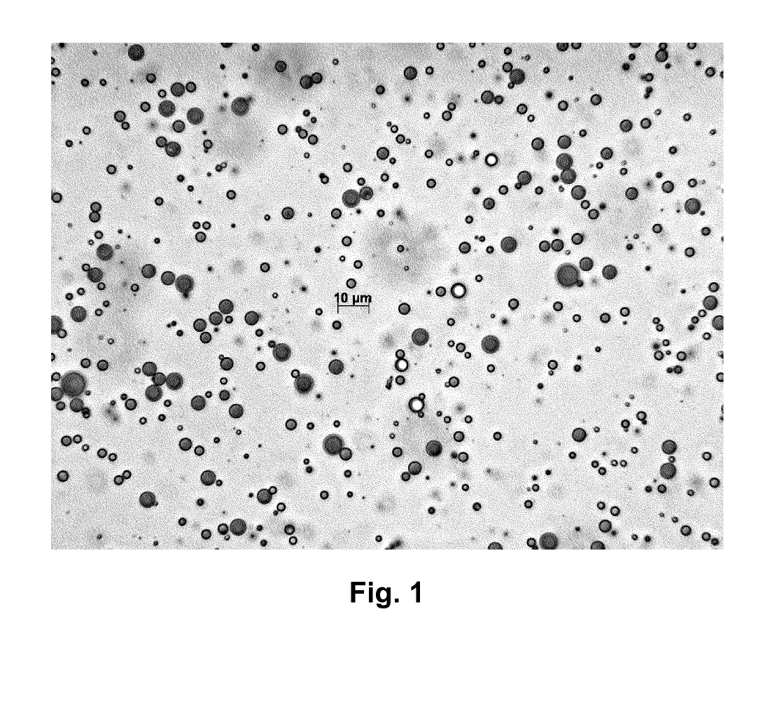

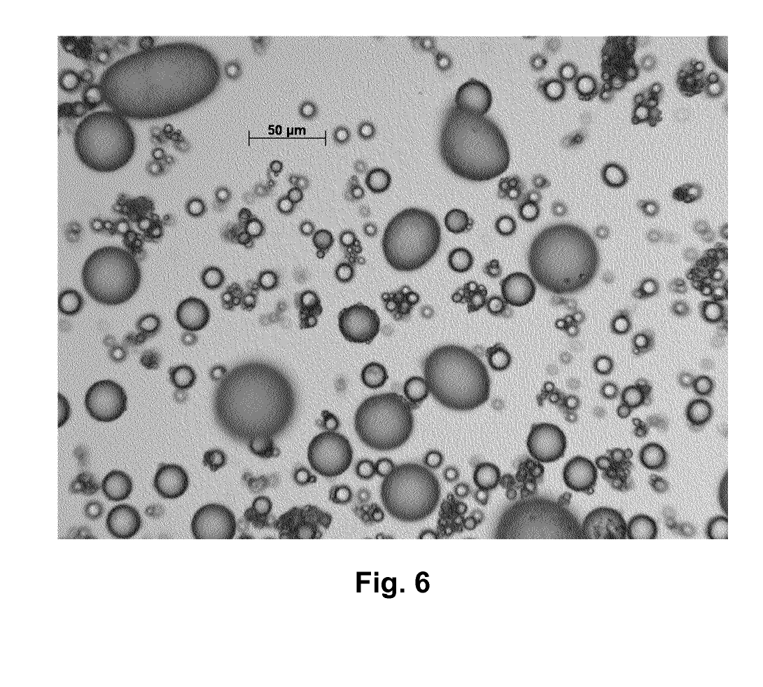

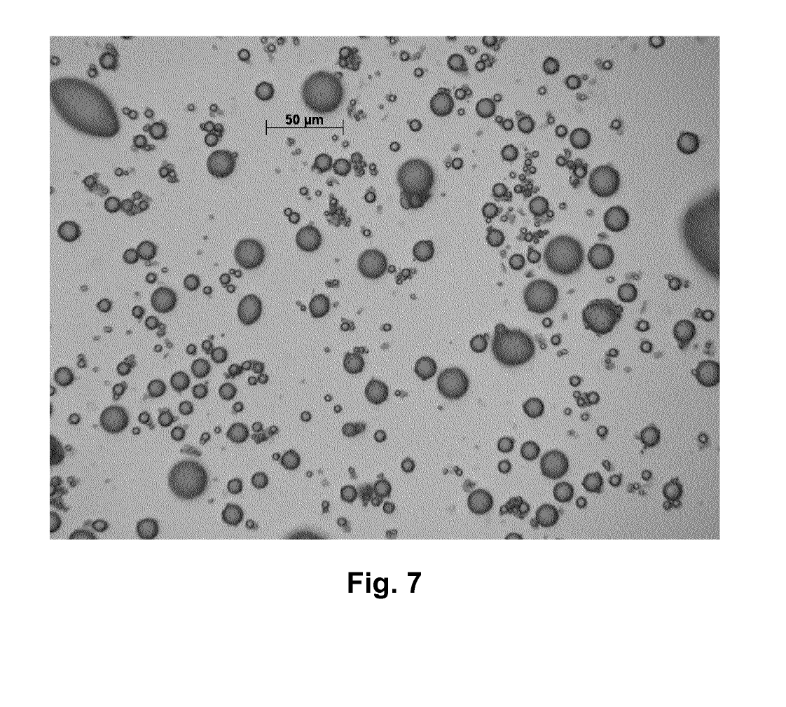

In the third aspect of the invention (relating to surface-modified clay), typically, the mean diameter by volume of the polymeric microparticles containing the first herbicide is from 1.0 to 50 micrometres, in particular from 5 to 40 micrometres such as from 10 to 35 micrometres, as measured by light scattering laser diffraction (e.g. by Malvern Mastersizer™). This type of particle size measurement probably includes in the measured diameter a small or very small contribution attributable to any attached or adsorbed surface-modified clay, as well as the greater part of the measured diameter attributable to the polymeric microparticle (PMP) itself. However, it is clearly seen from PMP Examples 12 and 13 and FIGS. 6 and 7 herein that that PMPs according to the third aspect of the invention, stabilized by surface-modified clay, tend to have a larger particle size than PMPs according to the second aspect of the invention stabilized by polyvinyl alcohol (for polyvinyl alcohol stabilized PMPs, see e.g. FIGS. 1, 2, 4, 5 and 14).

In a particularly preferred embodiment of the first aspect of the present invention, the herbicidal composition of the first aspect of the invention comprises a mixture of (e.g. a herbicidally effective amount of a mixture of):

a) polymeric microparticles containing a synthetic auxin herbicide being dicamba, 2,4-D or MCPA, or an agrochemically acceptable salt thereof; and
b) pinoxaden.

The synthetic auxin and ALS inhibitor herbicides mentioned above are generally known products and commercially available. The ACCase inhibitor herbicide pinoxaden can be used in the composition according to this invention in any available or preparable form.

Preferably in the herbicidal composition according to the invention, (a) are polymeric microparticles containing dicamba, 2,4-D or MCPA, or an agrochemically acceptable salt thereof. More preferably, (a) are polymeric microparticles containing dicamba or MCPA, or an agrochemically acceptable salt thereof.

Most preferably, (a) are polymeric microparticles containing dicamba or an agrochemically acceptable salt thereof.

In the present invention, (b) is pinoxaden.

Preferably, the herbicidal composition according to the invention additionally contain optionally (c) a safener and, optionally, (d) an additional herbicide and, optionally, (e) an oil additive.

Preferably, a safener (c) is present and comprises cloquintocet-mexyl, cloquintocet acid or an agrochemically acceptable salt thereof, fenchlorazole, or mefenpyr-diethyl. Preferably, in the composition, the weight ratio of the pinoxaden to the safener is 20:1 to 1:1, e.g. 20:1 to 2:1, e.g. 10:1 to 2:1, e.g. 4:1. Preferably, the safener is cloquintocet-mexyl or mefenpyr-diethyl, more preferably cloquintocet-mexyl.

Preferred additional herbicides (d) are sulfonyl urea herbicides selected from triasulfuron, tribenuron-methyl, iodosulfuron-methyl, mesosulfuron-methyl, sulfosulfuron and flupyrsulfuron-methyl, or triazolopyrimidine herbicides selected from pyroxsulam and penoxsulam, or sulphonylamino-carbonyl-triazolinone herbicides selected from flucarbazone-sodium, propoxycarbazone-sodium and thiencarbazone.

In one particular embodiment, (e) is present and is an oil additive selected from an oil of vegetable or animal origin, a mineral oil, alkyl esters of such oils, mixtures of such oils and oil derivatives, tris-esters of phosphoric acid with aliphatic or aromatic alcohols and bis-esters of alkyl phosphonic acids with aliphatic or aromatic alcohols.

### Methods of Use

A fifth aspect of the present invention provides a method of reducing the antagonistic effect on the control of weeds (preferably monocotyledonous weeds e.g. grassy weeds) in cereals (preferably non-oat cereals, such as wheat, barley, rye and/or triticale, more preferably wheat and/or barley) which is shown by an herbicidal mixture of either a synthetic auxin herbicide with pinoxaden or an ALS inhibitor herbicide with pinoxaden, which comprises: applying a herbicidal composition according to the first aspect of the present invention, or applying a herbicidal composition according to the second, third and/or fourth aspects of the present invention mixed (e.g. in water) with pinoxaden or a herbicidal composition (e.g. EC composition) comprising pinoxaden, to the plants (i.e. to the weeds and/or to the cereal crops) or to the locus thereof.

A sixth aspect of the present invention provides a method of controlling weeds (preferably monocotyledonous weeds e.g. grassy weeds) in cereal crops (preferably non-oat cereal crops, such as wheat, barley, rye and/or triticale, more preferably wheat and/or barley) comprising: applying a herbicidal composition according to a first aspect of the present invention, or applying a herbicidal composition according to the second, third and/or fourth aspects of the present invention mixed (e.g. in water) with pinoxaden or a herbicidal composition (e.g. EC composition) comprising pinoxaden, to the plants (i.e. to the weeds and/or to the cereal crops) or to the locus thereof.

A seventh aspect of the present invention provides a method of controlling weeds (preferably monocotyledonous weeds e.g. grassy weeds) in cereal crops (preferably non-oat cereal crops, such as wheat, barley, rye and/or triticale, more preferably wheat and/or barley), comprising the steps of:

(i) mixing in a tank a first herbicidal composition and a second herbicidal composition, and optionally a solvent suitable for applying the first and second compositions to plants or to a locus thereof (preferably an aqueous solvent such as water), and optionally a tank-mix adjuvant (e.g. comprising methylated rapeseed oil), to provide a tank-mixed herbicidal composition;
wherein the first herbicidal composition (which can for example be a dispersion (e.g. a dispersion and/or suspension concentrate), or a granule or powder composition) comprises polymeric microparticles containing a first herbicide, wherein the first herbicide is a synthetic auxin herbicide or an acetolactate synthase (ALS) inhibitor herbicide;
wherein the first herbicide, when in a salt-free form and when not contained within polymeric microparticles, antagonises the herbicidal activity of pinoxaden; and
wherein the second herbicidal composition (preferably a liquid composition, e.g. an emulsifiable concentrate composition) comprises pinoxaden; and
(ii) applying the tank-mixed herbicidal composition to the plants (i.e. to the weeds and/or to the cereal crops) or to the locus thereof.

In the seventh aspect of the invention, the polymeric microparticles and/or the first herbicide and/or the pinoxaden can be as defined herein in any of the first, second, third and/or fourth aspects of the invention in their broadest aspects or in any preferred embodiment(s) thereof.

In the seventh aspect of the invention, the first herbicidal composition is preferably as defined in any of the second, third and/or fourth aspects of the invention in their broadest aspects or in any preferred embodiment(s) thereof.

In the seventh aspect of the invention, the tank-mixed herbicidal composition can for example be as defined for the herbicidal composition of the first aspect of the present invention in their broadest aspects or in any preferred embodiment(s) thereof.

Preferred aspects of the fifth, sixth and/or seventh aspects of the invention are as follows.

Preferably, for pinoxaden (e.g. on cereal crops, preferably non-oat cereal crops, such as wheat, barley, rye and/or triticale, more preferably wheat and/or barley, e.g. spring or winter wheat or spring or winter barley), an application rate of from 5 to 60 g pinoxaden/ha is used, more preferably from 15 to 60 g or from 15 to 45 g or from 30 to 60 g or from 30 to 45 g pinoxaden/ha, still more preferably 30, 40, 45 or 60 g pinoxaden/ha, most preferably 30, 40 or 45 g pinoxaden/ha.

Preferably, for polymeric microparticles containing dicamba or an agrochemically acceptable salt thereof (e.g. on cereal crops, preferably non-oat cereal crops, e.g. wheat, barley and/or rye, e.g. spring or winter wheat, spring barley or spring rye), an application rate of from 80 to 400 g or from 100 to 400 g of dicamba/ha, measured as the free acid, is used. More preferably, from 80 to 240 g or from 100 to 240 g or from 120 to 240 g of dicamba/ha, measured as the free acid (such as for example from 100 to 140 g such as 120 g, or 150 g, or 240 g, of dicamba/ha, measured as the free acid) is used.

Preferably, for a mixture of (a) polymeric microparticles containing dicamba or an agrochemically acceptable salt thereof and (b) pinoxaden (e.g. on cereal crops, preferably non-oat cereal crops, such as wheat, barley, rye and/or triticale, more preferably wheat and/or barley, e.g. spring or winter wheat or spring or winter barley), an application rate of from 80 to 400 g or from 100 to 400 g of dicamba/ha, measured as the free acid, and from 5 to 60 g or from 10 to 60 g pinoxaden/ha, is used. More preferably, from 80 to 240 g or from 100 to 240 g or from 120 to 240 g of dicamba/ha, measured as the free acid (still more preferably from 100 to 140 g, in particular 120 g, or 240 g, of dicamba/ha, measured as the free acid), and from 10 to 60 g or from 15 to 60 g or more preferably from 30 to 60 g or from 30 to 45 g pinoxaden/ha, is used.

Specifically preferred examples of application rates, for a mixture of (a) polymeric microparticles containing dicamba or an agrochemically acceptable salt thereof and (b) pinoxaden (e.g. on cereal crops, preferably non-oat cereal crops, such as wheat, barley, rye and/or triticale, more preferably wheat and/or barley, e.g. spring or winter wheat or spring or winter barley), are:
from 100 to 140 g, in particular 120 g, of dicamba/ha, measured as the free acid, and from 30 to 60 g (e.g. 30, 40, 45 or 60 g) or from 30 to 45 g (e.g. 30 or 45 g) pinoxaden/ha; or
240 g of dicamba/ha, measured as the free acid, and from 10 to 60 g (e.g. 10, 20, 30, 40, 45 or 60 g) or from 30 to 60 g (e.g. 30, 40, 45 or 60 g) or from 30 to 45 g (e.g. 30, 40 or 45 g) pinoxaden/ha.

Preferably, for polymeric microparticles containing MCPA or an agrochemically acceptable salt thereof (e.g. on cereal crops, preferably non-oat cereal crops, e.g. wheat and/or barley), an application rate of from 280 to 2250 g of MCPA/ha, measured as the free acid, is used. More preferably, from 350 to 1650 g of MCPA/ha, measured as the free acid, is used. Still more preferably, from 350 to 1100 g of MCPA/ha, measured as the free acid (e.g. from 400 to 900 g, such as 500 g, of MCPA/ha, measured as the free acid) is used.

Preferably, for polymeric microparticles containing 2,4-D or an agrochemically acceptable salt thereof (e.g. on cereal crops, preferably non-oat cereal crops, e.g. wheat and/or barley), an application rate of from 280 to 2300 g of 2,4-D/ha, measured as the free acid, is used. More preferably, from 350 to 1650 g of 2,4-D/ha, measured as the free acid (e.g. from 400 to 1000 g of 2,4-D/ha, measured as the free acid) is used.

Preferably, for polymeric microparticles containing triasulfuron or an agrochemically acceptable salt thereof (e.g. on cereal crops, preferably non-oat cereal crops, such as wheat, barley and/or triticale), an application rate of from 5 to 15 g (more preferably from 5 to 10 g) of triasulfuron/ha, measured as the free compound, is used.

Preferably, for polymeric microparticles containing tribenuron-methyl or an agrochemically acceptable salt thereof (e.g. on cereal crops, preferably non-oat cereal crops, such as wheat, barley, rye and/or triticale), an application rate of from 7.5 to 30 g (more preferably from 12.5 to 30 g or from 15 to 30 g (e.g. 15, 20 or 30 g), still more preferably from 20 to 30 g) of tribenuron-methyl/ha, measured as the free compound, is used.

Preferably, for polymeric microparticles containing iodosulfuron-methyl or an agrochemically acceptable salt thereof (e.g. on cereal crops, preferably non-oat cereal crops, e.g. wheat, barley, triticale and/or rye, such as winter, spring or durum wheat, triticale, rye or spring barley), an application rate of from 5 to 15 g (more preferably 10 g) of iodosulfuron-methyl/ha, measured as the free compound, is used. Preferably, polymeric microparticles containing iodosulfuron-methyl or an agrochemically acceptable salt thereof are used in admixture with a safener such as mefenpyr-diethyl or cloquintocet-mexyl.

Preferably, for polymeric microparticles containing mesosulfuron-methyl or an agrochemically acceptable salt thereof (e.g. on cereal crops, preferably non-oat cereal crops, e.g. wheat, triticale and/or rye, such as winter, spring or durum wheat, triticale or rye), an application rate of from 10 to 20 g (more preferably 15 g) of mesosulfuron-methyl/ha, measured as the free compound, is used.

Preferably, for polymeric microparticles containing sulfosulfuron or an agrochemically acceptable salt thereof (e.g. on cereal crops, preferably non-oat cereal crops, e.g. wheat), an application rate of from 10 to 35 g of sulfosulfuron/ha, measured as the free compound, is used.

Preferably, for polymeric microparticles containing flupyrsulfuron-methyl or an agrochemically acceptable salt thereof (e.g. on cereal crops, preferably non-oat cereal crops, e.g. wheat), an application rate of from 5 to 15 g (more preferably 10 g) of flupyrsulfuron-methyl/ha, measured as the free compound, is used.

Preferably, for polymeric microparticles containing pyroxsulam or an agrochemically acceptable salt thereof (e.g. on cereal crops, preferably non-oat cereal crops, e.g. wheat, rye and/or triticale, such as spring or winter wheat, winter rye or winter triticale), an application rate of from 9 to 18.75 g (e.g. from 11 to 15 g) of pyroxsulam/ha, measured as the free compound, is used. Preferably, polymeric microparticles containing pyroxsulam or an agrochemically acceptable salt thereof are used in admixture with a safener, more preferably cloquintocet-mexyl or cloquintocet acid or an agrochemically acceptable salt thereof.

### Compositions—Miscellaneous

The herbicidal compositions of the present invention can be prepared in a variety of ways using formulation additives, such as carriers, solvents and surface-active substances. The resulting formulations can be in various physical forms, for example in the form of suspension concentrates, dusting powders, gels, wettable powders, water-dispersible granules, water-dispersible tablets, effervescent compressed tablets, emulsifiable concentrates, microemulsifiable concentrates, oil-in-water emulsions, oil flowables, aqueous dispersions, oily dispersions, suspoemulsions, capsule suspensions, emulsifiable granules, soluble liquids, water-soluble concentrates (with water or a water-miscible organic solvent as carrier), impregnated polymer films or in other forms known, for example, from the Manual on Development and Use of FAO Specifications for Plant Protection Products, 5th Edition, 1999. Such formulations can either be used directly or are diluted prior to use. Diluted formulations can be prepared, for example, with water, liquid fertilisers, micronutrients, biological organisms, oil or solvents.

The formulations (compositions) can be prepared, for example, by mixing the active ingredient with formulation additives in order to obtain compositions in the form of finely divided solids, granules, solutions, dispersions or emulsions. The active ingredients can also be formulated with other additives, for example finely divided solids, mineral oils, vegetable oils, modified vegetable oils, organic solvents, water, surface-active substances or combinations thereof.

The formulation additives suitable for the preparation of the composition according to the invention are generally known per se.

As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylenes carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethyl hexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol (PEG 400), propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, or higher molecular weight alcohols, such as amyl alcohol, tetrahydrofurfuryl alcohol, hexanol, octanol, ethylene glycol, propylene glycol, glycerol, N-methyl-2-pyrrolidone, or the like. Water is generally the carrier of choice for the dilution of the concentrates, e.g. suspension concentrates and dispersions.

Suitable solid carriers are, for example, talc, kaolin, titanium dioxide, pyrophyllite clay, silica, attapulgite clay, kieselguhr, limestone, calcium carbonate, bentonite, calcium montomorillonite, cottonseed husks, wheatmeal, soybean flour, pumice, wood flour, ground walnut shells, lignin, or similar materials, as described, for example, in CFR 180.1001. (c) & (d).

In general, surface-active compounds are, depending on the type of the active ingredient to be formulated, non-ionic, cationic and/or anionic surfactants or surfactant mixtures which have good emulsifying, dispersing and/or wetting properties. However, as mentioned previously herein, nonionic surfactants are preferred; separately, ionic (anionic and/or cationic) surfactants are not preferred and are best avoided in the present invention. The surfactants mentioned below are only to be considered as examples; a large number of further surfactants which are conventionally used in the art of formulation and suitable according to the invention are described in the relevant literature.

Suitable non-ionic surfactants are, especially, polyglycol ether derivatives of aliphatic or cycloaliphatic alcohols, of saturated or unsaturated fatty acids or of alkyl phenols which may contain approximately 3 to approximately 30 glycol ether groups and approximately 8 to approximately 20 carbon atoms in the (cyclo)aliphatic hydrocarbon radical or approximately 6 to approximately 18 carbon atoms in the alkyl moiety of the alkyl phenols. Also suitable are water-soluble polyethylene oxide adducts with polypropylene glycol, ethylenediaminopolypropylene glycol or alkyl polypropylene glycol having 1 to approximately 10 carbon atoms in the alkyl chain and approximately 20 to approximately 250 ethylene glycol ether groups and approximately 10 to approximately 100 propylene glycol ether groups. Normally, the abovementioned compounds contain 1 to approximately 5 ethylene glycol units per propylene glycol unit. Examples which may be mentioned are nonylphenoxypolyethoxyethanol, castor oil polyglycol ether, polypropylene glycol/polyethylene oxide adducts, tributylphenoxypolyethoxyethanol, polyethylene glycol or octylphenoxypolyethoxyethanol. Also suitable are fatty acid esters of polyoxyethylene sorbitan, such as polyoxyethylene sorbitan trioleate.

Cationic surfactants can include, for example, quaternary ammonium salts which generally have at least one alkyl radical of approximately 8 to approximately 22 C atoms as substituents and as further substituents (unhalogenated or halogenated) lower alkyl or hydroxyalkyl or benzyl radicals. The salts can for example be in the form of halides, methylsulfates or ethylsulfates. Examples are stearyltrimethylammonium chloride and benzylbis(2-chloroethyl)ethyl-ammonium bromide.

Examples of anionic surfactants are water-soluble soaps or water-soluble synthetic surface-active compounds. Examples of soaps are the alkali, alkaline earth or (unsubstituted or substituted) ammonium salts of fatty acids having approximately 10 to approximately 22 C atoms, such as the sodium or potassium salts of oleic or stearic acid, or of natural fatty acid mixtures which are obtainable for example from coconut or tall oil; mention must also be made of the fatty acid methyl taurates. However, synthetic surfactants are optionally used, in particular fatty sulfonates, fatty sulfates, sulfonated benzimidazole derivatives or alkylaryl sulfonates. As a rule, the fatty sulfonates and fatty sulfates are present as alkali, alkaline earth or (substituted or unsubstituted) ammonium salts and they generally have an alkyl radical of approximately 8 to approximately 22 C atoms, alkyl also to be understood as including the alkyl moiety of acyl radicals; examples which may be mentioned are the sodium or calcium salts of lignosulfonic acid, of the dodecylsulfuric ester or of a fatty alcohol sulfate mixture prepared from natural fatty acids. This group also includes the salts of the sulfuric esters and sulfonic acids of fatty alcohol/ethylene oxide adducts. The sulfonated benzimidazole derivatives in particular contain 2 sulfonyl groups and a fatty acid radical of approximately 8 to approximately 22 C atoms. Examples of alkylarylsulfonates are the sodium, calcium or triethanolammonium salts of decylbenzenesulfonic acid, of dibutylnaphthalenesulfonic acid or of a naphthalenesulfonic acid/formaldehyde condensate.

Also possible are, furthermore, suitable phosphates, such as salts of the phosphoric ester of a p-nonylphenol/(4-14)ethylene oxide adduct, or phospholipids. Further suitable phosphates are tris-esters of phosphoric acid with aliphatic or aromatic alcohols and/or bis-esters of alkyl phosphonic acids with aliphatic or aromatic alcohols, which are a high performance oil-type additive. These tris-esters have been described, for example, in WO01/47356, WO00/56146, EP-A-0579052 or EP-A-1018299 or are commercially available under their chemical name. Preferred tris-esters of phosphoric acid for use in the new compositions are tris-(2-ethylhexyl) phosphate, tris-n-octyl phosphate and tris-butoxyethyl phosphate, where tris-(2-ethylhexyl) phosphate is most preferred. Suitable bis-ester of alkyl phosphonic acids are bis-(2-ethylhexyl)-(2-ethylhexyl)-phosphonate, bis-(2-ethylhexyl)-(n-octyl)-phosphonate, dibutyl-butyl phosphonate and bis(2-ethylhexyl)-tripropylene-phosphonate, where bis-(2-ethylhexyl)-(n-octyl)-phosphonate is particularly preferred.

The compositions according to the invention can preferably additionally include an additive comprising an oil of vegetable or animal origin, a mineral oil, alkyl esters of such oils or mixtures of such oils and oil derivatives. The amount of oil additive used in the composition according to the invention is generally from 0.01 to 10%, based on the spray mixture. For example, the oil additive can be added to the spray tank in the desired concentration after the spray mixture has been prepared. Preferred oil additives comprise mineral oils or an oil of vegetable origin, for example rapeseed oil such as MERO®, olive oil or sunflower oil, emulsified vegetable oil, such as AMIGO® (Rhône-Poulenc Canada Inc.), alkyl esters of oils of vegetable origin, for example methyl esters such as methylated rapeseed oil (which is contained in ADIGOR®, which is an emulsifiable concentrate containing 47% by weight of the formulation of methylated rapeseed oil as an adjuvant, available from Syngenta), or an oil of animal origin, such as fish oil or beef tallow. A preferred additive contains, for example, as active components essentially 80% by weight alkyl esters of fish oils and 15% by weight methylated rapeseed oil, and also 5% by weight of customary emulsifiers and pH modifiers. Especially preferred oil additives comprise alkyl esters of C₈-C₂₂ fatty acids, especially the methyl derivatives of C₁₂-C₁₈ fatty acids, for example the methyl esters of lauric acid, palmitic acid and oleic acid, being important. Those esters are known as methyl laurate (CAS-111-82-0), methyl palmitate (CAS-112-39-0) and methyl oleate (CAS-112-62-9). A preferred fatty acid methyl ester derivative is Emery® 2230 and 2231 (Cognis GmbH). Those and other oil derivatives are also known from the Compendium of Herbicide Adjuvants, 5th Edition, Southern Illinois University, 2000. Also, alkoxylated fatty acids can be used as additives in the inventive compositions as well as polymethylsiloxane based additives, which have been described in WO2008/037373.

The application and action of the oil additives can be further improved by combining them with surface-active substances, such as non-ionic, anionic or cationic surfactants. Examples of such anionic, non-ionic and cationic surfactants are listed on pages 7 and 8 of WO 97/34485. Examples of surface-active substances are anionic surfactants of the dodecylbenzylsulfonate type, especially the calcium salts thereof, and also non-ionic surfactants of the fatty alcohol ethoxylate type. Further examples are ethoxylated C₁₂-C₂₂ fatty alcohols having a degree of ethoxylation of from 5 to 40. Examples of commercially available surfactants are the Genapol types (Clariant AG). Further examples are silicone surfactants, especially polyalkyl-oxide-modified heptamethyltrisiloxanes, which are commercially available e.g. as Silwet L-77®, and also perfluorinated surfactants. The concentration of surface-active substances in relation to the total additive is generally from 1 to 30% by weight. Examples of oil additives that consist of mixtures of oils or mineral oils or derivatives thereof with surfactants are Edenor ME SU®, Turbocharge® (Syngenta AG) and Actipron® (BP Oil UK Limited).

The said surface-active substances may also be used in the formulations alone, that is to say without oil additives.

Furthermore, the addition of an organic solvent to the oil additive/surfactant mixture can contribute to a further enhancement of action. Suitable solvents are, for example, Solvesso® (ESSO) and Aromatic Solvent® (Exxon Corporation). The concentration of such solvents can be from 10 to 80% by weight of the total weight. Such oil additives, which may be in admixture with solvents, are described, for example, in U.S. Pat. No. 4,834,908. A commercially available oil additive disclosed therein is known by the name MERGE® (BASF Corporation). A further oil additive that is preferred according to the invention is SCORE® (Syngenta Crop Protection Canada.)

In addition to the oil additives listed above, in order to enhance the activity of the composition according to the invention it is also possible for formulations of alkylpyrrolidones, (e.g. Agrimax®) to be added to the spray mixture. Formulations of synthetic latices, such as, for example, polyacrylamide, polyvinyl compounds or poly-1-p-menthene (e.g. Bond®, Courier® or Emerald®) can also be used. Solutions that contain propionic acid, for example Eurogkem Pen-e-trate®, can also be mixed into the spray mixture as activity-enhancing agents.

Further additives which can usually be used in pesticidal formulations include crystallisation inhibitors, viscosity-modifying substances, suspending agents, dyes, anti-oxidants, foaming agents, light absorbers, mixing aids, anti-foams, complexing agents, neutralising or pH-modifying substances and buffers, corrosion-inhibitors, fragrances, wetting agents, absorption improvers, micronutrients, plasticisers, glidants, lubricants, dispersants, thickeners, anti-freezes, microbiocides, and also liquid and solid fertilisers.

The herbicidal formulations (compositions), especially according to the first aspect of the invention, generally contain from 0.001 to 99% or 0.01 to 99% or 0.1 to 99% by weight, especially from 0.1 to 95% (e.g. from 1 to 95%, e.g. from 1 to 50%), in particular from 0.001 to 30% or from 0.01 to 30% such as from 0.02 to 20% and/or from 0.01 to 10%, by weight, of herbicide (a) and (b), and from 1 to 99.9% (e.g. 10 to 99.9% or 50 to 99.9% or 50 to 99%) by weight of one or more formulation additives, which preferably includes from 0 to 25% (e.g. from 0.05 to 25%, e.g. from 1 to 25%) by weight of a surface-active substance. Whereas commercial products will generally be formulated as a concentrate (e.g. suspension concentrate or dispersion concentrate) or as a solid composition, the end user will normally employ dilute formulations.

The formulations may also comprise additional active substances, for example plant growth regulators, fungicides or insecticides, and in particular further herbicides or herbicide safeners.

The rate of application of the herbicides (first herbicide (a) in admixture with pinoxaden (b)) may vary within wide limits and depends upon the nature of the soil, the method of application (pre- or post-emergence; seed dressing; application to the seed furrow; no tillage application etc.), the crop plant, the weed or grass to be controlled, the prevailing climatic conditions, and other factors governed by the method of application, the time of application and the target crop. The mixture according to the invention (first herbicide (a) together with pinoxaden (b)) for example can be applied at a rate of 1 to 4000 g/ha, especially from 5 to 1000 g/ha.

Preferably, for pinoxaden (e.g. on cereal crops, preferably non-oat cereal crops, such as wheat, barley, rye and/or triticale, more preferably wheat and/or barley, e.g. spring or winter wheat or spring or winter barley), an application rate of from 5 to 60 g pinoxaden/ha is used, more preferably from 15 to 60 g or from 15 to 45 g or from 30 to 60 g or from 30 to 45 g pinoxaden/ha, still more preferably 30, 40, 45 or 60 g pinoxaden/ha, most preferably 30, 40 or 45 g pinoxaden/ha.

Preferably, for polymeric microparticles containing dicamba or an agrochemically acceptable salt thereof (e.g. on cereal crops, preferably non-oat cereal crops, e.g. wheat, barley and/or rye, e.g. spring or winter wheat, spring barley or spring rye), an application rate of from 80 to 400 g or from 100 to 400 g of dicamba/ha, measured as the free acid, is used. More preferably, from 80 to 240 g or from 100 to 240 g or from 120 to 240 g of dicamba/ha, measured as the free acid (still more preferably from 100 to 140 g, such as 120 g, or 240 g, of dicamba/ha, measured as the free acid) is used.

Preferably, for a mixture of (a) polymeric microparticles containing dicamba or an agrochemically acceptable salt thereof and (b) pinoxaden (e.g. on cereal crops, preferably non-oat cereal crops, such as wheat, barley, rye and/or triticale, more preferably wheat and/or barley, e.g. spring or winter wheat or spring or winter barley), an application rate of from 80 to 400 g or from 100 to 400 g of dicamba/ha, measured as the free acid, and from 5 to 60 g or from 10 to 60 g pinoxaden/ha, is used. More preferably, from 80 to 240 g or from 100 to 240 g or from 120 to 240 g of dicamba/ha, measured as the free acid (still more preferably from 100 to 140 g, in particular 120 g, or 240 g, of dicamba/ha, measured as the free acid), and from 10 to 60 g or from 15 to 60 g or more preferably from 30 to 60 g or from 30 to 45 g pinoxaden/ha, is used.

Specifically preferred examples of application rates, for a mixture of (a) polymeric microparticles containing dicamba or an agrochemically acceptable salt thereof and (b) pinoxaden (e.g. on cereal crops, preferably non-oat cereal crops, such as wheat, barley, rye and/or triticale, more preferably wheat and/or barley, e.g. spring or winter wheat or spring or winter barley), are:
from 100 to 140 g, in particular 120 g, of dicamba/ha, measured as the free acid, and from 30 to 60 g (e.g. 30, 40, 45 or 60 g) or from 30 to 45 g (e.g. 30 or 45 g) pinoxaden/ha; or
240 g of dicamba/ha, measured as the free acid, and from 10 to 60 g (e.g. 10, 20, 30, 40, 45 or 60 g) or from 30 to 60 g (e.g. 30, 40, 45 or 60 g) or from 30 to 45 g (e.g. 30, 40 or 45 g) pinoxaden/ha.

Preferably, for polymeric microparticles containing MCPA or an agrochemically acceptable salt thereof (e.g. on cereal crops, preferably non-oat cereal crops, e.g. wheat and/or barley), an application rate of from 280 to 2250 g of MCPA/ha, measured as the free acid, is used. More preferably, from 350 to 1650 g of MCPA/ha, measured as the free acid, is used. Still more preferably, from 350 to 1100 g of MCPA/ha, measured as the free acid (e.g. from 400 to 900 g, such as 500 g, of MCPA/ha, measured as the free acid) is used.

Preferably, for polymeric microparticles containing 2,4-D or an agrochemically acceptable salt thereof (e.g. on cereal crops, preferably non-oat cereal crops, e.g. wheat and/or barley), an application rate of from 280 to 2300 g of 2,4-D/ha, measured as the free acid, is used. More preferably, from 350 to 1650 g of 2,4-D/ha, measured as the free acid (e.g. from 400 to 1000 g of 2,4-D/ha, measured as the free acid) is used.

Preferably, for polymeric microparticles containing triasulfuron or an agrochemically acceptable salt thereof (e.g. on cereal crops, preferably non-oat cereal crops, such as wheat, barley and/or triticale), an application rate of from 5 to 15 g (more preferably from 5 to 10 g) of triasulfuron/ha, measured as the free compound, is used.

Preferably, for polymeric microparticles containing tribenuron-methyl or an agrochemically acceptable salt thereof (e.g. on cereal crops, preferably non-oat cereal crops, such as wheat, barley, rye and/or triticale), an application rate of from 7.5 to 30 g (more preferably from 12.5 to 30 g or from 15 to 30 g (e.g. 15, 20 or 30 g), still more preferably from 20 to 30 g) of tribenuron-methyl/ha, measured as the free compound, is used.

Preferably, for polymeric microparticles containing iodosulfuron-methyl or an agrochemically acceptable salt thereof (e.g. on cereal crops, preferably non-oat cereal crops, e.g. wheat, barley, triticale and/or rye, such as winter, spring or durum wheat, triticale, rye or spring barley), an application rate of from 5 to 15 g (more preferably 10 g) of iodosulfuron-methyl/ha, measured as the free compound, is used. Preferably, polymeric microparticles containing iodosulfuron-methyl or an agrochemically acceptable salt thereof are used in admixture with a safener such as mefenpyr-diethyl or cloquintocet-mexyl.

Preferably, for polymeric microparticles containing mesosulfuron-methyl or an agrochemically acceptable salt thereof (e.g. on cereal crops, preferably non-oat cereal crops, e.g. wheat, triticale and/or rye, such as winter, spring or durum wheat, triticale or rye), an application rate of from 10 to 20 g (more preferably 15 g) of mesosulfuron-methyl/ha, measured as the free compound, is used.

Preferably, for polymeric microparticles containing sulfosulfuron or an agrochemically acceptable salt thereof (e.g. on cereal crops, preferably non-oat cereal crops, e.g. wheat), an application rate of from 10 to 35 g of sulfosulfuron/ha, measured as the free compound, is used.

Preferably, for polymeric microparticles containing flupyrsulfuron-methyl or an agrochemically acceptable salt thereof (e.g. on cereal crops, preferably non-oat cereal crops, e.g. wheat), an application rate of from 5 to 15 g (more preferably 10 g) of flupyrsulfuron-methyl/ha, measured as the free compound, is used.

Preferably, for polymeric microparticles containing pyroxsulam or an agrochemically acceptable salt thereof (e.g. on cereal crops, preferably non-oat cereal crops, e.g. wheat, rye and/or triticale, such as spring or winter wheat, winter rye or winter triticale), an application rate of from 9 to 18.75 g (e.g. from 11 to 15 g) of pyroxsulam/ha, measured as the free compound, is used. Preferably, polymeric microparticles containing pyroxsulam or an agrochemically acceptable salt thereof are used in admixture with a safener, more preferably cloquintocet-mexyl or cloquintocet acid or an agrochemically acceptable salt thereof.

Preferred formulations have especially the following compositions:

(%=percent by weight):
Emulsifiable concentrates:
active ingredient: 1 to 95%, preferably 60 to 90%
surface-active agent: 1 to 30%, preferably 5 to 20%
liquid carrier: 1 to 80%, preferably 1 to 35%

### Dusts:

active ingredient: 0.1 to 10%, preferably 0.1 to 5%
solid carrier: 99.9 to 90%, preferably 99.9 to 99%
Suspension concentrates:
active ingredient: 5 to 75%, preferably 10 to 50%
water: 94 to 24%, preferably 88 to 30%
surface-active agent: 1 to 40%, preferably 2 to 30%
Wettable powders:
active ingredient: 0.5 to 90%, preferably 1 to 80%
surface-active agent: 0.5 to 20%, preferably 1 to 15%
solid carrier: 5 to 95%, preferably 15 to 90%

### Granules:

active ingredient: 0.1 to 30%, preferably 0.1 to 15%
solid carrier: 99.5 to 70%, preferably 97 to 85%,
where the term “active ingredient” refers to the mixture of herbicide a) with herbicide b).

The following Examples further illustrate, but do not limit, the invention.

| F1. Emulsifiable concentrates | a) | b) | c) | d) |
|---|---|---|---|---|
| active ingredient | 5% | 10% | 25% | 50% |
| calcium dodecylbenzene- | 6% | 8% | 6% | 8% |
| sulfonate | | | | |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| NMP | — | — | 10% | 20% |
| arom. hydrocarbon | 85% | 78% | 55% | 16% |
| mixture C₉-C₁₂ | | | | |

Emulsions of any desired concentration can be prepared from such concentrates by dilution with water.

| F2. Solutions | a) | b) | c) | d) |
|---|---|---|---|---|
| active ingredient | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| NMP | — | — | 30% | 10% |
| arom. hydrocarbon | 75% | 60% | — | — |
| mixture C₉-C₁₂ | | | | |

The solutions are suitable for application in the form of microdrops.

| F3. Wettable powders | a) | b) | c) | d) |
|---|---|---|---|---|
| active ingredient | 5% | 25% | 50% | 80% |
| sodium lignosulfona | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly disperse silicic acid | 1% | 3% | 5% | 10% |
| kaolin | 88% | 62% | 35% | — |

The active ingredient is thoroughly mixed with the additives and the mixture is thoroughly ground in a suitable mill, yielding wettable powders which can be diluted with water to give suspensions of any desired concentration.

| F4. Coated granules | a) | b) | c) |
|---|---|---|---|
| active ingredient | 0.1% | 5% | 15% |
| highly disperse silicic acid | 0.9% | 2% | 2% |
| inorg. carrier | 99.0% | 93% | 83% |
| (diameter 0.1-1 mm) | | | |
| e.g. CaCO₃ or SiO₂ | | | |

The active ingredient is dissolved in methylene chloride, the solution is sprayed onto the carrier and the solvent is subsequently evaporated off in vacuo.

| F5. Coated granules | a) | b) | c) |
|---|---|---|---|
| active ingredient | 0.1% | 5% | 15% |
| polyethylene glycol MW 200 | 1.0% | 2% | 3% |
| highly disperse silicic acid | 0.9% | 1% | 2% |
| inorg. carrier | 98.0% | 92% | 80% |
| (diameter 0.1-1 mm) | | | |
| e.g. CaCO₃ or SiO₂ | | | |

The finely ground active ingredient is applied uniformly, in a mixer, to the carrier moistened with polyethylene glycol. Non-dusty coated granules are obtained in this manner.

| F6. Extruder granules | a) | b) | c) | d) |
|---|---|---|---|---|
| active ingredient | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the additives and the mixture is moistened with water. The resulting mixture is extruded and then dried in a stream of air.

| F7. Dusts | a) | b) | c) |
|---|---|---|---|
| active ingredient | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the additives, yielding a suspension concentrate from which suspensions of any desired concentration can be prepared by dilution with water.

The term “active ingredient” in the examples mentioned above refers to the mixture of herbicide a) with herbicide b.

### Crops of Useful Plants and Weeds

Crops of useful plants in which the compositions according to the invention can be used include especially cereals, cotton, soybeans, sugar beet, sugar cane, plantation crops, rape, maize and/or rice, and/or for non-selective weed control. In a particular embodiment, the herbicidal composition of the invention is for use on cereal crops; preferably non-oat cereal crops; more preferably wheat, barley, rye and/or triticale; most preferably wheat (e.g. winter wheat, spring wheat or durum wheat) and/or barley (e.g. winter or spring barley). The term “crops” is to be understood as also including crops that have been rendered tolerant to herbicides or classes of herbicides (for example ALS, GS, EPSPS, PPO, ACCase and HPPD inhibitors) as a result of conventional methods of breeding or genetic engineering. An example of a crop that has been rendered tolerant e.g. to imidazolinones, such as imazamox, by conventional methods of breeding is Clearfield® summer rape (Canola). Examples of crops that have been rendered tolerant to herbicides by genetic engineering methods include e.g. glyphosate- and glufosinate-resistant maize varieties commercially available under the trade names RoundupReady® and LibertyLink®.

The weeds to be controlled may be monocotyledonous weeds (e.g. grassy weeds) and/or dicotyledonous weeds; such as, for example, Stellaria, Nasturtium, Agrostis, Digitaria, Avena, Setaria, Sinapis, Lolium, Solanum, Echinochloa, Scirpus, Monochoria, Sagittaria, Bromus, Alopecurus, Sorghum, Rottboellia, Cyperus, Abutilon, Sida, Xanthium, Amaranthus, Chenopodium, Ipomoea, Chrysanthemum, Galium, Viola and/or Veronica.

Preferably, the weeds to be controlled comprise Avena, Lolium, Alopecurus, and/or Setaria species, such as, in particular, Avena fatua, Lolium multiflorum, Lolium rigidum, Lolium perenne, Alopecurus myosuroides, Setaria viridis and/or Setaria lutescens. More preferably the weeds comprise Avena, Lolium, and/or Alopecurus species. Most preferably, the weeds comprise Avena fatua.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt-176 maize hybrids of NK® (Syngenta Seeds). The Bt toxin is a protein that is formed naturally by Bacillus thuringiensis soil bacteria. Examples of toxins and transgenic plants able to synthesise such toxins are described in EP-A-451 878, EP-A-374 753, WO 93/07278, WO 95/34656, WO 03/052073 and EP-A-427 529. Examples of transgenic plants that contain one or more genes which code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops and their seed material can be resistant to herbicides and at the same time also to insect feeding (“stacked” transgenic events). Seed can, for example, have the ability to express an insecticidally active Cry3 protein and at the same time be glyphosate-tolerant. The term “crops” is to be understood as also including crops obtained as a result of conventional methods of breeding or genetic engineering which contain so-called output traits (e.g. improved flavour, storage stability and nutritional content). Areas under cultivation are to be understood as including land where the crop plants are already growing as well as land intended for the cultivation of those crop plants.

The rates of application of the herbicide mixture are generally from 0.001 to 2 kg/ha, but typically from 0.005 to 1 kg/ha.

The ratio by weight of herbicide a) and b) in the composition according to the invention is typically from 1:100 to 100:1, in particular 1:20 to 20:1.

The rate of application of safener in relation to herbicide depends largely on the method of application. In the case of field treatment, which is effected either using a tank mixture comprising a combination of safener and herbicide mixture or by separate application of safener and herbicide mixture, the ratio of herbicides to safener is generally from 100:1 to 1:10, preferably from 20:1 to 1:1. In the case of field treatment, from 0.001 to 1.0 kg of safener/ha, preferably from 0.001 to 0.25 kg of safener/ha, is generally applied.

In the composition according to the invention, the amounts of oil additive employed are generally from 0.01 to 2%, based on the spray mixture. The oil additive can, for example, be added to the spray tank in the desired concentration after the spray mixture has been prepared.

### EXAMPLES

### Polymeric Microparticle and Composition Examples

### Preparations for Use in the Biological Examples

The specific details of the preparations of polymeric microparticles and compositions, used in or suitable for use in the Biological Examples, are given below.

All formulations (compositions) are quoted as “acid equivalent” (AE) of dicamba, MCPA, triasulfuron and so on. For example, MCPA-potassium SL050 represents 50 g/L MCPA acid equivalent (present as the potassium salt) in water.

### Abbreviations

AE acid equivalent
AIBN azo-bis-isobutyronitrile
DI deionised
d.p. decimal place(s)
EC emulsifiable concentrate
PMP polymeric microparticle
R.M.M. relative molecular mass
s.f. significant figure(s)
THFA tetrahydrofurfuryl alcohol

### Materials for Use in Polymeric Microparticle Synthesis and Formulation

VIAPAL™ VUP 4779/55, available from Cytec Industries Inc., Smyrna, Ga., USA, or from Cytec Surface Specialities in Belgium and Germany (www.cytec.com), is a resin mixture of:

(i) an unsaturated (alkene-containing) polyester resin formed from ortho-phthalic acid polymerised with an alkene-containing diol or glycol; and
(ii) styrene;
wherein the uncured (unpolymerised) resin mixture has a styrene content of about 45% by weight of the resin mixture. Polymerization (curing) of the VIAPAL VUP 4779/55 resin mixture, typically in the presence of a radical initiator such as AIBN, leads to formation of a crosslinked polyester polymer.

Gohsenol™ GL05 is a polyvinyl alcohol (86.5-89% hydrolysed polyvinyl acetate), which is e.g. suitable for use as dispersant and stabiliser in aqueous preparations, available from Nippon Gohsei (www.gohsenol.com).

SAG™ 1572 Antifoam (foam control agent) (available from Momentive Performance Materials; http://www.momentive.com) is a silicone antifoam emulsion in water, e.g. suitable for water-based formulations (e.g. Ag formulations) or related surfactant concentrates.

Azo-bis-isobutyronitrile (AIBN) is a radical initiator, and was obtained or is obtainable from BDH Chemicals.

Methyl benzoate can be used as co-solvent and plasticizer. For Polymeric Microparticle Examples 2 and 3, the methyl benzoate used was obtained from Merck Chemicals. For the other, later-mentioned Polymeric Microparticle Examples, if methyl benzoate was used then it was a high (99%) purity grade of methyl benzoate obtained and/or available from Sigma-Aldrich (http://www.sigmaaldrich.com).

Morwet™ D425 (available from Akzo Nobel; www.akzonobel.com) is a naphthalene-based dispersant suitable for preparing agrochemical suspension concentrate formulations.

Rhodopol™ 23 is an anionic hetero-polysaccharide, also known as “xanthan gum”, formed from fermentation of hydrocarbons by microorganism type Xanthomonas. It is commercially available from Rhodia (www.rhodia.com).

Imerys™ RLO 7645 is a surface-modified (amino-silane-modified) kaolin clay, generally described in Example 1 of patent application WO2009/063257 (incorporated herein by reference), and is available from Imerys Group, USA (www.imerys.com). More specifically, Imerys™ RLO 7645 is a tabular ultrafine kaolin clay that has been surface-modified by the addition of 1.6% by weight of aminopropyltriethoxysilane. In Imerys™ RLO 7645, the kaolin clay is tabular (ie “blocky”, flat or plate-like in shape), and the surface-modified (amino-silane-modified) kaolin clay is ultrafine, typically having a particle size distribution in which: at least 98% of the particles are smaller than 1 micron (micrometre), 82% of the particles are smaller than 0.25 microns (micrometres), and the D50 (median diameter) is 0.12 microns (micrometres). It is thought that such a surface-modified (amino-silane-modified) kaolin clay should be capable of being prepared, for example, by mixing tabular ultrafine kaolin clay with a solution of an amino-silane surface-modifying agent (which, for Imerys™ RLO 7645, is aminopropyltriethoxysilane) in a solvent (e.g. aqueous and/or organic solvent), typically in a suitable mixer such as food blender. In such surface modification of clay, the silane groups of the amino-silane surface-modifying agent (preferably, e.g. for Imerys™ RLO 7645, aminopropyltriethoxysilane) are thought to react with the surface of the clay so as to form free amine groups attached to the clay surface; typically the free amine groups are attached via a propylene or ethylene linker to the clay surface (see e.g. page 8 line 26 to page 9 line 17 of WO2009/063257, incorporated herein by reference).

### Polymeric Microparticle Example 1

### Preparation of Dicamba Microparticle Sample #1 (Experiment J8694/165/1)

The organic phase was prepared by dissolving dicamba acid of 87.9% purity (0.682 g, providing 0.599 g=2.71 mmol of actual dicamba acid whose R.M.M. (relative molecular mass) is 221.0) in Viapal™ VUP 4779/55 resin (2.288 g) by stirring with a magnetic stirrer, after which initiator azo-bis-isobutyronitrile (AIBN, 0.059 g, 0.36 mmol, where its R.M.M.=164.2) was added and dissolved in the mixture.

For the aqueous phase, firstly a stock solution of Gohsenol GL05 (polyvinyl alcohol) of 15% by weight was prepared (i) by adding 15 g of Gohsenol GL05 to 85 g of water at 60° C. while stirring, and then (ii) stirring was continued for 20 minutes until all material had dissolved.

The aqueous phase was then prepared by adding 2.694 g of the 15% Gohsenol™ GL05 stock solution and 2 drops of SAG™ 1572 foam control agent to 4.345 g of deionised (DI) water.

To prepare the microparticles, the organic phase (2.386 g) was added drop-wise to the entire aqueous phase while mixing with a high shear mixer (Ultra-Turrax T25) with a “small head” (known as “dispersing element S 25 N-10 G”). Mixing was continued for 5 minutes until the emulsion droplets were smaller than 10 micrometres. The emulsion was then stirred with a magnetic stirrer and heated to 80° C. for 2 hours, to cure (polymerize) the resin and thereby to form an aqueous dispersion of the polymeric microparticles containing the dicamba acid.

The ingredients and percentages for sample #1 (Polymeric Microparticle Example 1) were as follows:

| | | % by weight of the |
|---|---|---|
| Sample | Ingredient | aqueous dispersion |
| J8694/165/1 | dicamba acid * | 5.010 |
| | AIBN | 0.493 |
| | methyl benzoate | 0.000 |
| | VIAPAL ^{TM} VUP 4779/55 resin | 19.123 |
| | Gohsenol ^{TM} GL05 (polyvinyl | |
| | alcohol) | 4.288 |
| | DI water | rest |

* Impurities of dicamba are not included in this calculation

### Particle Size Analysis for Polymeric Microparticle Example 1

An optical microscope photograph of the microparticles formed in Polymeric Microparticle Example 1 is shown in FIG. 1 hereinafter, in which the scale-bar shown is 10 micrometres.

Particle size data were generated by printing the FIG. 1 images, selecting a common grid and counting the sphere dimensions (60 particles in all for each case) and then using embedded “scale bar” to determine the diameter, whereby 0.5 microns was the limit of resolution by this light microscopy technique (Leica Diaplan microscope). Particle size data was then calculated using a Microsoft Excel program to give the mean diameter and its standard deviation. These are effectively a “number” mean diameter (mean diameter by number), which is adequate inter alia because the formed microparticles are “near spherical” entities.

Particle size of microparticles from Polymeric Microparticle Example 1 (containing no plasticizer)=J8694-165-1 is as follows:

mean of diameter=2.8 microns (micrometres)
standard deviation of diameter=1.9 microns (micrometres)

### Polymeric Microparticle Example 2

### Preparation of Dicamba Microparticle Sample #2 (Experiment J8694/165/2)

The organic phase was prepared by dissolving dicamba acid of 87.9% purity (0.688 g, providing 0.605 g=2.74 mmol of actual dicamba acid, whose R.M.M.=221.0) in Viapal™ VUP 4779/55 resin (1.988 g) and methyl benzoate (0.325 g, 2.39 mmol, where its R.M.M.=136.2) by stirring with a magnetic stirrer, after which initiator azo-bis-isobutyronitrile (AIBN, 0.086 g, 0.52 mmol, where its R.M.M.=164.2) was added and dissolved in the mixture.

The aqueous phase was then prepared by adding 2.671 g of the 15% Gohsenol™ GL05 (polyvinyl alcohol) stock solution (as prepared in Polymeric Microparticle Example 1, herein) and 2 drops of SAG™ 1572 foam control agent to 4.343 g of deionised (DI) water.

To prepare the micro-particles, the organic phase (2.590 g) was added drop-wise to the entire aqueous phase while mixing with a high shear mixer (Ultra-Turrax T25) with a “small head” (known as “dispersing element S 25 N-10 G”). Mixing was continued for 5 minutes until the emulsion droplets were smaller than 10 micrometres. The emulsion was then stirred with a magnetic stirrer and heated to 80° C. for 2 hours, to cure (polymerize) the resin and thereby to form an aqueous dispersion of the polymeric microparticles containing the dicamba acid.

The ingredients and percentages for sample #2 (Polymeric Microparticle Example 2) were as follows:

| | | % by weight of the aqueous |
|---|---|---|
| Sample | Ingredient | dispersion |
| J8694/165/2 | dicamba acid * | 5.283 |
| | AIBN | 0.751 |
| | methyl benzoate | 2.839 |
| | VIAPAL ^{TM} VUP 4779/55 resin | 17.367 |
| | Gohsenol ^{TM} GL05 (polyvinyl | |
| | alcohol) | 4.172 |
| | DI water | rest |

* Impurities of dicamba are not included in this calculation

### Particle Size Analysis for Polymeric Microparticle Example 2

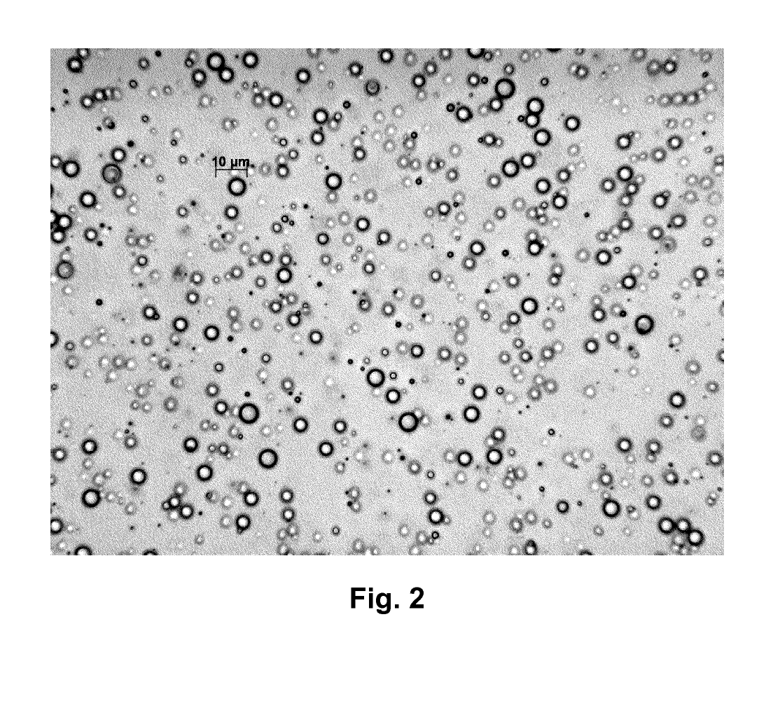

An optical microscope photograph of the microparticles formed in Polymeric Microparticle Example 2 is shown in FIG. 2 hereinafter, in which the scale-bar shown is 10 micrometres.

Particle size data were generated by printing the FIG. 2 images, selecting a common grid and counting the sphere dimensions (60 particles in all for each case) and then using embedded “scale bar” to determine the diameter, whereby 0.5 microns was the limit of resolution by this light microscopy technique (Leica Diaplan microscope). Particle size data was then calculated using a Microsoft Excel program to give the mean diameter and its standard deviation. These are effectively a “number” mean diameter (mean diameter by number), which is adequate inter alia because the formed microparticles are “near spherical” entities.

Particle size of microparticles from Polymeric Microparticle Example 2 (containing plasticizer)=J8694-165-2 is as follows:

mean of diameter=2.6 microns (micrometres)
standard deviation of diameter=1.4 microns (micrometres)

### Polymeric Microparticle Example 3

### Preparation of Dicamba Microparticle Sample #3 (Experiment J8694/165/3)

The organic phase was prepared by dissolving dicamba acid of 87.9% purity (0.691 g, providing 0.607 g=2.75 mmol of actual dicamba acid, whose R.M.M.=221.0) in Viapal™ VUP 4779/55 resin (1.662 g) and methyl benzoate (0.609 g, 4.47 mmol, where its R.M.M.=136.2) by stirring with a magnetic stirrer, after which initiator azo-bis-isobutyronitrile (AIBN, 0.056 g, 0.34 mmol, where its R.M.M.=164.2) was added and dissolved in the mixture.

The aqueous phase was then prepared by adding 2.683 g of the 15% Gohsenol™ GL05 stock (polyvinyl alcohol) solution (as prepared in Polymeric Microparticle Example 1, herein) and 2 drops of SAG™ 1572 foam control agent to 4.334 g of deionised (DI) water.

To prepare the microparticles, the organic phase (2.680 g) was added drop-wise to the entire aqueous phase while mixing with a high shear mixer (Ultra-Turrax T25) with a “small head” (known as “dispersing element S 25 N-10 G”). Mixing was continued for 5 minutes until the emulsion droplets were smaller than 10 micrometres. The emulsion was then stirred with a magnetic stirrer and heated to 80° C. for 2 hours, to cure (polymerize) the resin and thereby to form an aqueous dispersion of the polymeric microparticles containing the dicamba acid.

The ingredients and percentages for sample #3 (Polymeric Microparticle Example 3) were as follows:

| | | % by weight of the aqueous |
|---|---|---|
| Sample | Ingredient | dispersion |
| J8694/165/3 | dicamba acid * | 5.562 |
| | AIBN | 0.513 |
| | methyl benzoate | 5.577 |
| | VIAPAL ^{TM} VUP 4779/55 resin | 15.220 |
| | Gohsenol ^{TM} GL05 (polyvinyl | |
| | alcohol) | 4.150 |
| | DI water | Rest |

* Impurities of dicamba are not included in this calculation

### Polymeric Microparticle Example 4

### Preparation of Dicamba Microparticle Sample #4 (Experiment J8763-82-1)

### Introduction

This microparticle example (experiment J8763-82-1) contains approximately 50 g/L dicamba (measured as the free acid), is in general a substantial repeat of Polymeric Microparticle Example 1, and the prepared microparticle contains a “moderate dicamba:polymer” ratio (=approx. “0.2 dicamba acid/0.8 other ingredients” weight ratio within each microparticle). This sample was used in a glasshouse trial (described in Biological Example no. 6) when the sample was 1.5 months old (i.e. slightly aged) at the time of spraying onto plants.

### Method

The organic phase was prepared by dissolving dicamba acid of 87.9% purity (0.6832 g, providing 0.6005 g=2.717 mmol of actual dicamba acid whose R.M.M.=221.0) in Viapal™ VUP 4779/55 resin (2.2634 g) by stirring with a magnetic stirrer, after which initiator azo-bis-isobutyronitrile (AIBN, 0.0662 g, 0.403 mmol, where its R.M.M.=164.2) was added and dissolved in the mixture.

For the aqueous phase, firstly a stock solution of Gohsenol™ GL05 (polyvinyl alcohol) of 15% by weight was prepared (i) by adding 15 g of Gohsenol™ GL05 to 85 g of water at 60° C. while stirring, and then (ii) stirring was continued for 20 minutes until all material had dissolved.

The aqueous phase was then prepared by adding 2.6783 g of the 15% by weight Gohsenol™ GL05 stock solution (i.e. containing 0.40175 g of Gohsenol™ GL05 polyvinyl alcohol) and 2 drops of SAG™ 1572 foam control agent to 4.3542 g of deionised (DI) water.

To prepare the microparticles, 2.1270 g of the organic phase (which is [2.1270 g/3.0128 g]=ca. 70.60% by weight of the prepared organic phase, calculated as containing ca. 0.4240 g of actual dicamba acid, ca. 0.0467 g of AIBN and ca. 1.5979 g of Viapal™ resin) was added drop-wise to the entire aqueous phase while mixing with a high shear mixer (IKA™ Ultra-Turrax™ T25) with a “small head” (known as “dispersing element S 25 N-10 G”). The mixed organic+aqueous phase should weigh ca. 9.1595 g. Mixing was continued for 5 minutes until the emulsion droplets were smaller than 10 micrometres. The emulsion was then stirred with a magnetic stirrer and heated to 80° C. for 2 hours, to cure (polymerize) the resin and thereby to form an aqueous dispersion of the polymeric microparticles containing the dicamba acid.

The ingredients and their loading percentages for sample #4 (Polymeric Microparticle Example 4) were as follows:

| | | % by weight of the aqueous |
|---|---|---|
| Sample | Ingredient | dispersion (to 2 d.p.) |
| J8763-82-1 | dicamba acid * | 4.63 * |
| | AIBN | 0.51 |
| | VIAPAL ^{TM} VUP 4779/55 resin | 17.45 |
| | Gohsenol ^{TM} GL05 (polyvinyl | |
| | alcohol) | 4.39 |
| | DI water | 72.39 |

* impurities of dicamba are not included in this calculation

| | | Ratio by weight of (a) the |
|---|---|---|
| | | stated ingredient to (b) the |
| | | total non-aqueous phase |
| | | (total polymeric |
| | | microparticles), in the |
| Sample | Ingredient | aqueous dispersion |
| J8763-82-1 | Gohsenol ^{TM} GL05 (polyvinyl | 0.1889:1 ** = 1:5.29 (to 3 s.f.) |
| | alcohol) | |
| | dicamba acid | 0.1993:1 ** = 1:5.02 (to 3 s.f.) |
| | (excluding impurities) | |

** The total weight of the polymeric microparticles is calculated as [total weight of: resin + dicamba + dicamba impurities + initiator].

### Polymeric Microparticle Example 5

### Preparation of Dicamba Microparticle Sample #5 (Experiment J8763-130-1)

### Introduction

This microparticle example (experiment J8763-130-1) contains approximately 50 g/L dicamba (measured as the free acid), is in general a substantial repeat of Polymeric Microparticle Example 1, and the prepared microparticle contains a “moderate dicamba:polymer” ratio (=approx. “0.2 dicamba acid/0.8 other ingredients” weight ratio within each microparticle). This sample was used in a glasshouse trial (described in Biological Example no. 7) when the sample was 1.5 weeks old (i.e. very freshly made) at the time of spraying onto plants.

### Method

The organic phase was prepared by dissolving dicamba acid of 87.9% purity (0.6830 g, providing 0.6004 g=2.717 mmol of actual dicamba acid whose R.M.M.=221.0) in Viapal™ VUP 4779/55 resin (2.2763 g) by stirring with a magnetic stirrer, after which initiator azo-bis-isobutyronitrile (AIBN, 0.0609 g, 0.371 mmol, where its R.M.M.=164.2) was added and dissolved in the mixture.

For the aqueous phase, firstly a stock solution of Gohsenol™ GL05 (polyvinyl alcohol) of 15% by weight was prepared (i) by adding 15 g of Gohsenol™ GL05 to 85 g of water at 60° C. while stirring, and then (ii) stirring was continued for 20 minutes until all material had dissolved.

The aqueous phase was then prepared by adding 2.6710 g of the 15% by weight Gohsenol™ GL05 stock solution (i.e. containing 0.40065 g of Gohsenol™ GL05 polyvinyl alcohol) and 2 drops of SAG™ 1572 foam control agent to 4.4043 g of deionised (DI) water.

To prepare the microparticles, 2.0990 g of the organic phase (which is [2.0990 g/3.0202 g]=ca. 69.50% by weight of the prepared organic phase, calculated as containing ca. 0.4172 g of actual dicamba acid, ca. 0.0423 g of AIBN and ca. 1.5820 g of Viapal™ resin) was added drop-wise to the entire aqueous phase while mixing with a high shear mixer (IKA™ Ultra-Turrax™ T25) with a “small head” (known as “dispersing element S 25 N-10 G”). The mixed organic+aqueous phase should weigh ca. 9.1743 g. Mixing was continued for 5 minutes until the emulsion droplets were smaller than 10 micrometres. The emulsion was then stirred with a magnetic stirrer and heated to 80° C. for 2 hours, to cure (polymerize) the resin and thereby to form an aqueous dispersion of the polymeric microparticles containing the dicamba acid.

The ingredients and their loading percentages for sample #5 (Polymeric Microparticle Example 5) were as follows:

| | | % by weight of the aqueous |
|---|---|---|
| Sample | Ingredient | dispersion (to 2 d.p.) |
| J8763-130-1 | dicamba acid * | 4.55 * |
| | AIBN | 0.46 |
| | VIAPAL ^{TM} VUP 4779/55 resin | 17.24 |
| | Gohsenol ^{TM} GL05 (polyvinyl | |
| | alcohol) | 4.37 |
| | DI water | 72.75 |

* impurities of dicamba are not included in this calculation

| | | Ratio by weight of (a) |
|---|---|---|
| | | the stated ingredient to (b) |
| | | the total non-aqueous |
| | | phase (total polymeric |
| | | microparticles), in |
| Sample | Ingredient | the aqueous dispersion |
| J8763-130-1 | Gohsenol ^{TM} GL05 (polyvinyl | 0.1909:1 ** = 1:5.24 (to 3 s.f.) |
| | alcohol) | |
| | dicamba acid | 0.1988: 1 ** = 1:5.03 (to 3 s.f.) |
| | (excluding impurities) | |

** The total weight of the polymeric microparticles is calculated as [total weight of: resin + dicamba + dicamba impurities + initiator].

### Polymeric Microparticle Example 6

### Preparation of Dicamba Micro-Particle Sample #6 (Experiment J8763-87-1)

### Introduction

This microparticle example (experiment J8763-87-1) contains approximately 60 g/L dicamba (measured as the free acid), and the prepared microparticle contains a “higher dicamba:polymer” ratio (=approx. “0.4 dicamba acid/0.6 other ingredients” weight ratio within each microparticle). This sample was used in a glasshouse trial (described in Biological Example no. 8) when the sample was roughly 1 month old at the time of spraying onto plants.

### Method

First of all, dicamba acid (87.9% purity as a solid) was mortar-milled (using a Retsch™ RM 200 mill) for 10 minutes in order to reduce its crystalline particle size substantially from an average of 100 microns initially to 10 microns finally, as estimated by light microscopy measurement.

The organic phase was prepared by adding the milled dicamba acid of 87.9% purity (1.3657 g, providing 1.2005 g=5.432 mmol of actual dicamba acid, whose R.M.M.=221.0) to Viapal™ VUP 4779/55 resin (1.5770 g) and stirring with a magnetic stirrer. Initiator azo-bis-isobutyronitrile (AIBN, 0.0603 g, 0.367 mmol, where its R.M.M.=164.2) was then added to the mixture and stirring was continued for 1 hour.

For the aqueous phase, firstly a stock solution of Gohsenol™ GL05 (polyvinyl alcohol) of 15% by weight was prepared (i) by adding 15 g of Gohsenol™ GL05 to 85 g of water at 60° C. while stirring, and then (ii) stirring was continued for 20 minutes until all material had dissolved.

The aqueous phase was then prepared by adding 2.7053 g of the 15% by weight Gohsenol™ GL05 stock solution (i.e. containing 0.4058 g of Gohsenol™ GL05 polyvinyl alcohol) and 2 drops of SAG™ 1572 foam control agent to 4.3411 g of deionised (DI) water.

To prepare the microparticles, 1.2648 g of the highly-viscous organic phase (which is [1.2648 g/3.003 g]=ca. 42.12% by weight of the prepared organic phase, calculated as containing ca. 0.5056 g of actual dicamba acid, ca. 0.0254 g of AIBN and ca. 0.6642 g of Viapal™ resin) was added drop-wise to the entire aqueous phase while mixing with a high shear mixer (IKA™ Ultra-Turrax™ T25) with a “small head” (known as “dispersing element S 25 N-10 G”). The mixed organic+aqueous phase should weigh ca. 8.3112 g. Mixing was continued for 2-3 minutes until the emulsion droplets were smaller than 50 micrometres. The emulsion was then stirred with a magnetic stirrer and heated to 80° C. for 2 hours, to cure (polymerize) the resin and thereby to form an aqueous dispersion of the polymeric microparticles containing the dicamba acid.

The ingredients and their loading percentages for sample #6 (Polymeric Micro-particle Example 6) were as follows:

| | | % by weight of the aqueous |
|---|---|---|
| Sample | Ingredient | dispersion (to 2 d.p.) |
| J8763-87-1 | dicamba acid * | 6.08 * |
| | AIBN | 0.31 |
| | VIAPAL ^{TM} VUP 4779/55 resin | 7.99 |
| | Gohsenol ^{TM} GL05 (polyvinyl | |
| | alcohol) | 4.88 |
| | DI water | 79.90 |

* impurities of dicamba are not included in this calculation

| | | Ratio by weight of (a) the stated |
|---|---|---|
| | | ingredient to (b) the total non- |
| | | aqueous phase (total polymeric |
| | | microparticles), in the aqueous |
| Sample | Ingredient | dispersion |
| J8763-87-1 | Gohsenol ^{TM} GL05 (polyvinyl | 0.3208:1 ** = 1:3.12 (to 3 s.f.) |
| | alcohol) | |
| | dicamba acid | 0.3998: 1 ** = 1:2.50 (to 3 s.f.) |
| | (excluding impurities) | |

** The total weight of the polymeric microparticles is calculated as [total weight of: resin + dicamba + dicamba impurities + initiator ].

### Polymeric Microparticle Example 7

### Preparation of Dicamba Microparticle Sample #7 (Experiment J8763-126-1)

### Introduction

This microparticle example (experiment J8763-126-1) contains approximately 50 g/L dicamba (measured as the free acid), and the prepared microparticle contains an amino-silane-modified kaolin clay as a “Pickering” emulsion stabiliser (as opposed to polyvinyl alcohol stabiliser for previous samples), and has a “moderate dicamba:polymer” ratio (=approx. “0.2 dicamba acid/0.8 other ingredients” weight ratio within each microparticle). This sample was used in a glasshouse trial (described in Biological Example no. 9) when the sample was 2 weeks old (i.e. very freshly made) at the time of spraying onto plants.

### Method

The organic phase was prepared by dissolving dicamba acid of 87.9% purity (0.6835 g, providing 0.6008 g=2.719 mmol of actual dicamba acid, where its R.M.M.=221.0) in Viapal™ VUP 4779/55 resin (2.2690 g) by stirring with a magnetic stirrer, after which initiator azo-bis-isobutyronitrile (AIBN, 0.0607 g, 0.370 mmol, where its R.M.M.=164.2) was added and dissolved in the mixture.

For the aqueous phase, firstly a stock solution of Rhodopol™ 23 (xanthan gum) of target 1% by weight was prepared (i) by adding 0.3 g of Rhodopol™ 23 to 29.8 g of de-ionised water at 20° C. while shaking manually vigorously in a glass bottle, and then (ii) stirring was continued for 30 minutes until all material had dissolved to form a gel phase. The actual gel solution contained 0.997% by weight of Rhodopol™ 23 xanthan gum.

Furthermore, 0.3001 g of an amino-silane-modified kaolin clay known as Imerys™ RLO 7645 was dispersed into 6.2035 g of deionised (DI) water by using an ultrasonic probe (Ultrasonic Processor GEX 130; sonic probe head CV18)-30 seconds of pulsed sonication was employed (i.e. 1 second “on”, 1 second “off”, for 30 seconds). This gave a total aqueous phase of 6.5036 grams.

To prepare the microparticles, 2.3677 g of the organic phase (which is [2.3677 g/3.0132 g]=ca. 78.58% by weight of the prepared organic phase, calculated as containing ca. 0.4721 g of actual dicamba acid, ca. 0.0477 g of AIBN and ca. 1.7829 g of Viapal™ resin) was added drop-wise to the entire 6.5036 grams of the aqueous phase (as mentioned hereinabove) while mixing with a high shear mixer (IKA™ Ultra-Turrax™ T25) with a “small head” (known as “dispersing element S 25 N-10 G”). Mixing was continued for 20 minutes until the emulsion droplets were smaller than 50 micrometres. Furthermore, 0.5117 g of the 1% by weight Rhodopol™ 23 (xanthan gum) stock solution (containing ca. 0.00510 g xanthan gum) was added to the emulsion by rolling the sample for 15 minutes. The total mixed organic+aqueous phase should weigh ca. 9.383 g. This resulting emulsion was then stirred with a magnetic stirrer and heated to 80° C. for 2 hours, to cure (polymerize) the resin and thereby to form an aqueous dispersion of the polymeric microparticles containing the dicamba acid.

The ingredients and loading percentages for sample #7 (Polymeric Microparticle Example 7) were as follows:

| | | % by weight of the |
|---|---|---|
| | | aqueous dispersion (to |
| | | 2 d.p., except where |
| Sample | Ingredient | otherwise specified) |
| J8763-126-1 | dicamba acid * | 5.03% * |
| | AIBN | 0.51% |
| | VIAPAL ™ VUP | 19.00% |
| | 4779/55 resin | |
| | Imerys ™ RLO 7645 amino- | 3.20% |
| | silane-modified kaolin clay | |
| | Rhodopol ™ 23 | 0.0544% (to 3 s.f.) |
| | (xanthan gum) | |
| | DI water | 71.51% |

* impurities of dicamba are not included in this calculation

| | | Ratio by weight of (a) |
|---|---|---|
| | | the stated ingredient to |
| | | (b) the total non-aqueous |
| | | phase (total polymeric |
| | | microparticles), in the |
| Sample | Ingredient | aqueous dispersion |
| J8763-126-1 | Imerys ™ RLO 7645 amino- | 0.1267:1 ** = |
| | silane-modified kaolin clay | 1:7.89 (to 3 s.f.) |
| | Rhodopol ™ 23 | 0.00215:1 ** = |
| | (xanthan gum) | 1:464 (to 3 s.f.) |
| | dicamba acid | 0.1994:1 ** = |
| | (excluding impurities) | 1:5.02 (to 3 s.f.) |

** The total weight of the polymeric microparticles is calculated as [total weight of: resin + dicamba + dicamba impurities + initiator].

### Polymeric Microparticle Example 8

### Preparation of MCPA Microparticle Sample #8 (Experiment J8763-90-2)

### Introduction

This microparticle example (experiment J8763/090-2), contains approximately 35 g/L MCPA (measured as the free acid), and the prepared microparticle has a weight ratio of approximately “0.124 MCPA acid/0.876 other ingredients” within each microparticle. This sample was used in a glasshouse trial (described in Biological Example no. 10) when the sample was 1 month old at the time of spraying onto plants.

### Method

First of all, MCPA acid (96.8% purity as a solid) was mortar-milled (using a Retsch™ RM 200 mill) for 20 minutes in order to reduce its crystalline particle size substantially from an average of 100 microns initially to 5 microns finally, as estimated by light microscopy measurement.

The organic phase was prepared by adding the milled MCPA acid of 96.8% purity (0.517 grams, providing 0.5005 g=2.49 mmol of actual MCPA acid, where its R.M.M.=200.6) to Viapal™ VUP 4779/55 resin (3.4588 g) and stirring with a magnetic stirrer. Initiator azo-bis-isobutyronitrile (AIBN, 0.0611 g, 0.372 mmol, where its R.M.M.=164.2) was then added to the mixture and stirring was continued for 10 minutes.

For the aqueous phase, firstly a stock solution of Gohsenol™ GL05 (polyvinyl alcohol) of 15% by weight was prepared (i) by adding 15 g of Gohsenol™ GL05 to 85 g of water at 60° C. while stirring, and then (ii) stirring was continued for 20 minutes until all material had dissolved.

The aqueous phase was then prepared by adding 2.7069 g of the 15% by weight Gohsenol™ GL05 stock solution (i.e. containing 0.4060 g of Gohsenol™ GL05 polyvinyl alcohol) and 2 drops of SAG™ 1572 foam control agent to 3.3724 g of deionised (DI) water.

To prepare the microparticles, 2.4263 g of the highly-viscous organic phase (which is [2.4263 g/4.0369 g]=ca. 60.10% by weight of the prepared organic phase, calculated as containing ca. 0.3008 g of actual MCPA acid, ca. 0.0367 g of AIBN and ca. 2.0788 g of Viapal™ resin) was added drop-wise to the entire aqueous phase while mixing with a high shear mixer (IKA™ Ultra-Turrax™ T25) with a “small head” (known as “dispersing element S 25 N-10 G”). The mixed organic+aqueous phase should weigh ca. 8.5056 g. Mixing was continued for 5 minutes until the emulsion droplets were smaller than 10 micrometres. The emulsion was then stirred with a magnetic stirrer and heated to 80° C. for 2 hours, to cure (polymerize) the resin and thereby to form an aqueous dispersion of the polymeric microparticles containing the MCPA acid.

The ingredients and their loading percentages for sample #8 (Polymeric Microparticle Example 8) were as follows:

| | | % by weight of the |
|---|---|---|
| | | aqueous dispersion |
| Sample | Ingredient | (to 2 d.p.) |
| J8763/090-2 | MCPA acid * | 3.54 * |
| | AIBN | 0.43 |
| | VIAPAL ™ VUP | 24.44 |
| | 4779/55 resin | |
| | Gohsenol ™ GL05 | 4.77 |
| | (polyvinyl alcohol) | |
| | DI water | 66.70 |

* impurities of MCPA are not included in this calculation

| | | Ratio by weight of (a) |
|---|---|---|
| | | the stated ingredient to |
| | | (b) the total non-aqueous |
| | | phase (total polymeric |
| | | microparticles), in the |
| Sample | Ingredient | aqueous dispersion |
| J8763/090-2 | Gohsenol ™ GL05 | 0.1673:1 ** = |
| | (polyvinyl alcohol) | 1:5.98 (to 3 s.f.) |
| | MCPA acid | 0.1240:1 ** = |
| | (excluding impurities) | 1:8.07 (to 3 s.f.) |

** The total weight of the polymeric microparticles is calculated as [total weight of: resin + MCPA + MCPA impurities + initiator].

### Polymeric Microparticle Example 9

### Preparation of 2,4-D micro-particle sample #9 (Experiment J8763-90-1)

### Introduction

This microparticle example (experiment J8763/090-1), contains approximately 40 g/L 2,4-D (measured as the free acid), and the prepared microparticle has a weight ratio of approximately “0.124 of 2,4-D acid/0.876 of other ingredients” within each microparticle. This sample was used in a glasshouse trial (described in Biological Example no. 11) when the sample was 1 month old at the time of spraying onto plants.

### Method

First of all, 2,4-D acid (97.8% purity as a solid) was mortar-milled (using a Retsch™ RM 200 mill) for 15 minutes in order to reduce its crystalline particle size substantially from an average of 80 microns initially to 5 microns finally, as estimated by light microscopy measurement.

The organic phase was prepared by adding the milled 2,4-D acid of 97.8% purity (0.5109 grams, providing 0.4997 g=2.261 mmol of actual 2,4-D acid, where its R.M.M.=221.0) to Viapal™ VUP 4779/55 resin (3.4506 g) and stirring with a magnetic stirrer. Initiator azo-bis-isobutyronitrile (AIBN, 0.0605 g, 0.368 mmol, where its R.M.M.=164.2) was then added to the mixture and stirring was continued for 10 minutes.

For the aqueous phase, firstly a stock solution of Gohsenol™ GL05 (polyvinyl alcohol) of 15% by weight was prepared (i) by adding 15 g of Gohsenol™ GL05 to 85 g of water at 60° C. while stirring, and then (ii) stirring was continued for 20 minutes until all material had dissolved.

The aqueous phase was then prepared by adding 2.7029 g of the 15% by weight Gohsenol™ GL05 stock solution (i.e. containing 0.4054 g of Gohsenol™ GL05 polyvinyl alcohol) and 2 drops of SAG™ 1572 foam control agent to 3.3680 g of deionised (DI) water.

To prepare the microparticles, 2.7439 g of the highly-viscous organic phase (which is [2.7439 g/4.022 g]=68.22% by weight of the prepared organic phase, calculated as containing ca. 0.3409 g of actual 2,4-D acid, ca. 0.0413 g of AIBN and ca. 2.3541 g of Viapal™ resin) was added drop-wise to the entire aqueous phase while mixing with a high shear mixer (IKA™ Ultra-Turrax™ T25) with a “small head” (known as “dispersing element S 25 N-10 G”). The mixed organic+aqueous phase should weigh ca. 8.8148 g. Mixing was continued for 5 minutes until the emulsion droplets were smaller than 10 micrometres. The emulsion was then stirred with a magnetic stirrer and heated to 80° C. for 2 hours, to cure (polymerize) the resin and thereby to form an aqueous dispersion of the polymeric microparticles containing the dicamba acid.

The ingredients and their loading percentages for sample #9 (Polymeric Microparticle Example 9) were as follows:

| | | % by weight of the |
|---|---|---|
| | | aqueous dispersion |
| Sample | Ingredient | (to 2 d.p.) |
| J8763/090-1 | 2,4-D acid * | 3.87 * |
| | AIBN | 0.47 |
| | VIAPAL ™ VUP | 26.71 |
| | 4779/55 resin | |
| | Gohsenol ™ GL05 | 4.60 |
| | (polyvinyl alcohol) | |
| | DI water | 64.27 |

* impurities of 2,4-D acid are not included in this calculation

| | | Ratio by weight of (a) |
|---|---|---|
| | | the stated ingredient to |
| | | (b) the total non-aqueous |
| | | phase (total polymeric |
| | | microparticles), in the |
| Sample | Ingredient | aqueous dispersion |
| J8763/090-1 | Gohsenol ™ GL05 | 0.1478:1 ** = |
| | (polyvinyl alcohol) | 1:6.77 (to 3 s.f.) |
| | 2,4-D acid | 0.1242:1 ** = |
| | (excluding impurities) | 1:8.05 (to 3 s.f.) |

** The total weight of the polymeric microparticles is calculated as [total weight of: resin + 2,4-D + 2,4-D impurities + initiator].

### Polymeric Microparticle Example 10

### Preparation of Dicamba Microparticle Sample #10 (Experiment SJH001/006/002)

### Prepared for Field Trials

### Introduction

This microparticle example (experiment SJH001/006/002) has a target of 5% of dicamba (measured as the free acid) by weight of the aqueous dispersion and is, with some changes (e.g. xanthan gum added), a larger scale (ca. 250 grams target scale) substantial repeat of Polymeric Microparticle Example 1. The prepared microparticles contain a “moderate dicamba:polymer” ratio (=“0.2 dicamba acid/0.8 other ingredients” weight ratio within each microparticle). The date-of-Manufacture was 1 Feb. 2012, and the prepared microparticles were then sprayed in field trials in Europe during March 2012.

### Method

The organic phase (i.e. the “non-aqueous” phase) was prepared by dissolving dicamba acid of 87.9% purity (14.80 grams, providing 13.01 g=58.9 mmol of actual dicamba acid whose R.M.M.=221.0) in Viapal™ VUP 4779/55 resin (48.92 grams) by sonicating using Precision Ultrasonic Cleaning DP202-00 device for 5 minutes and then stirring at 50° C. with a magnetic stirrer (i.e. an Heidolph™ magnetic hot-plate stirrer) until all the dicamba acid had dissolved (several minutes), followed by cooling back to room temperature, after which initiator azo-bis-isobutyronitrile (AIBN, 1.31 grams, 7.98 mmol, where its R.M.M.=164.2) was added and dissolved in the mixture by magnetic flea stirrer method for 10 minutes at room temperature.

For the “aqueous phase”, first a stock solution of Gohsenol™ GL05 (polyvinyl alcohol) of 15% by weight was prepared (i) by adding 15 grams of Gohsenol™ GL05 to 85 grams of water at 60° C. while stirring with an IKA™ Labortechnik “Lab-Egg”™ RW-11 basic mixer, and then (ii) stirring was continued for 20 minutes until all material had dissolved.

Secondly, the aqueous phase was then prepared by adding 66.67 grams of this 15% by weight Gohsenol™ GL05 stock solution (i.e. containing 10.001 g of Gohsenol™ GL05 polyvinyl alcohol) and 2 drops (say, approximately 0.05 grams) of SAG™ 1572 foam control agent to 95.6 grams of deionised (DI) water. Homogenisation of this aqueous phase (ca. 162.32 g) was achieved by hand-shaking within a 300 ml volume sealed glass jar.

To prepare the microparticles in this afore-said glass jar, the majority (62.48 g) of the above-mentioned “organic phase” (which is [62.48 g/65.03 g]=ca. 96.08% by weight of the prepared organic phase, calculated as containing ca. 12.50 g of actual dicamba acid, ca. 1.26 g of AIBN and ca. 47.00 g of Viapal™ resin) was added in 0.5 ml aliquots to the entire above-mentioned “aqueous phase” while mixing for 15 minutes at 8000 rpm (the “yellow setting”) with a high shear mixer (IKA™ Ultra-Turrax™ T25) coupled with a “large head” attachment (known as “dispersing element S 25 N-18 G”). Mixing was continued for 2 minutes at 9500 rpm (the “green setting”) until the emulsion droplets were all smaller than 20 micrometres. The emulsion was then stirred with a magnetic stirrer and heated to 80° C. for 2 hours, to cure (i.e. polymerise) the Viapal™ VUP 4779/55 resin and thereby to form an aqueous dispersion of the polymeric microparticles containing the herbicidal dicamba acid. The emulsion was efficiently stirred using an IKA™ Labortechnik “Lab-Egg”™ RW-11 basic mixer with sufficient “cling film” covering the glass vessel aperture to avoid any significant evaporative water losses. Finally, 23.51 grams of a separately prepared Rhodopol™ 23 aqueous thickener solution (concentration 10 grams per litre of xanthan gum) was added to the polymeric microparticles preparation with stirring via a magnetic stirrer bar method. The final mixed organic+aqueous phase should weigh ca. 62.48+162.32+23.51 g=ca. 248.31 g in total. The final sample was accordingly bottled and labelled ready for shipment to the field trials in Europe.

The ingredients and their loading percentages for sample #10 (Polymeric Microparticle Example 10, experiment SJH001/006/002) were as follows:

| | | % by weight of the |
|---|---|---|
| | | aqueous dispersion |
| Sample | Ingredient | (to 2 d.p.) |
| SJH001- | dicamba acid * | 5.00 * |
| 006-002 | AIBN | 0.50 |
| | VIAPAL ™ VUP | 18.80 |
| | 4779/55 resin | |
| | Gohsenol ™ GL05 | 4.00 |
| | (polyvinyl alcohol) | |
| | Rhodopol ™ 23 | 0.10 |
| | (xanthan gum) | |
| | DI water | 70.91 |

* impurities of dicamba are not included in this calculation

For certain ingredients, for sample #10 (Polymeric Microparticle Example 10, experiment SJH001/006/002), the ratios by weight of (a) the stated ingredient to (b) the total non-aqueous phase (total polymeric microparticles), in the aqueous dispersion were as follows:

| | | Ratio by weight of (a) |
|---|---|---|
| | | the stated ingredient to |
| | | (b) the total non-aqueous |
| | | phase (total polymeric |
| | | microparticles), in the |
| Sample | Ingredient | aqueous dispersion |
| SJH001- | Gohsenol ™ GL05 | 0.1601:1 ** = |
| 006-002 | (polyvinyl alcohol) | 1:6.25 (to 3 s.f.) |
| | Rhodopol ™ 23 | 0.00401:1 ** = |
| | (xanthan gum) | 1:249 (to 3 s.f.) |
| | dicamba acid | 0.2000:1 ** = |
| | (excluding impurirties) | 1:5.00 (to 3 s.f.) |

** The total weight of the polymeric microparticles is calculated as [total weight of: resin + dicamba + dicamba impurities + initiator].

### Particle Size Analysis for Polymeric MicroParticle Example 10

An optical microscope photograph of the microparticles formed in Polymeric Microparticle Example 10 is shown in FIG. 4 hereinafter, in which the scale-bar shown is 50 micrometres.

Particle size data were measured by light scattering laser diffraction (either dynamic or static) using a Malvern Mastersizer™ 2000 (available from Malvern Instruments, UK) giving a result for the Polymeric MicroParticle Example 10 as follows:
D(4,3)=volume-weighted mean diameter (mean diameter by volume)=8.37 microns (=micrometres).

### Polymeric Microparticle Example 11

### Preparation of Dicamba Microparticle Sample #11 (Experiment SJH001/011/002)

### Prepared for Field Trials

### Introduction

This microparticle example (experiment SJH001/011/002) has a target of 5% of dicamba (measured as the free acid) by weight of the aqueous dispersion, and is at a large scale (ca. 250 grams target scale). The prepared microparticles contain a “moderately high dicamba acid:polymer” ratio (=“0.3 dicamba acid/0.7 other ingredients” weight ratio within each microparticle). The date-of-Manufacture was 21 Feb. 2012, and the prepared microparticles were then sprayed in field trials in Europe during March 2012.

### Method

The organic phase (i.e. the “non-aqueous” phase) was prepared by dissolving dicamba acid of 87.9% purity (20.51 grams, providing 18.03 g=81.58 mmol of actual dicamba acid whose R.M.M.=221.0) in Viapal™ VUP 4779/55 resin (38.34 grams) by sonicating using Precision Ultrasonic Cleaning DP202-00 device for 5 minutes and then stirring at 50° C. with a magnetic stirrer (i.e. an Heidolph™ magnetic hot-plate stirrer) until all the dicamba acid had dissolved (several minutes), followed by cooling back to room temperature, after which initiator azo-bis-isobutyronitrile (AIBN, 1.23 grams, 7.5 mmol, where its R.M.M.=164.2) was added and dissolved in the mixture by magnetic flea stirrer method for 10 minutes at room temperature.

For the “aqueous phase”, first a stock solution of Gohsenol™ GL05 (polyvinyl alcohol) of 15% by weight was prepared (i) by adding 15 grams of Gohsenol™ GL05 to 85 grams of water at 60° C. while stirring with an IKA™ Labortechnik “Lab-Egg”™ RW-11 basic mixer, and then (ii) stirring was continued for 20 minutes until all material had dissolved.

Secondly, the aqueous phase was then prepared by adding 66.96 grams of this 15% by weight Gohsenol™ GL05 stock solution (i.e. containing 10.044 g of Gohsenol™ GL05 polyvinyl alcohol) and 2 drops (say, approximately 0.05 grams) of SAG™ 1572 foam control agent to 119.18 grams of deionised (DI) water. Homogenisation of this aqueous phase (186.19 g) was achieved by hand-shaking within a 300 ml volume sealed glass jar.

To prepare the microparticles in this afore-said glass jar, the majority (42.09 g) of the above-mentioned “organic phase” (which is [42.09 g/60.08 g]=70.06% by weight of the prepared organic phase, calculated as containing ca. 12.63 g of actual dicamba acid, ca. 0.86 g of AIBN and ca. 26.86 g of Viapal™ resin) was added in 0.5 ml aliquots to the entire above-mentioned “aqueous phase” while mixing for 10 minutes at 8000 rpm (the “yellow setting”) with a high shear mixer (IKA™ Ultra-Turrax™ T25) coupled with a “large head” attachment (known as “dispersing element S 25 N-18 G”). Mixing was continued for 4 minutes at 9500 rpm (the “green setting”) until the emulsion droplets were all smaller than 20 micrometres. The emulsion was then stirred with a magnetic stirrer and heated to 80° C. for 2 hours, to cure (i.e. polymerise) the Viapal™ VUP 4779/55 resin and thereby to form an aqueous dispersion of the polymeric microparticles containing the herbicidal dicamba acid. The emulsion was efficiently stirred using an IKA™ Labortechnik “Lab-Egg”™ RW-11 basic mixer with sufficient “cling film” covering the glass vessel aperture to avoid any significant evaporative water losses. Finally, 25.3 grams of a separately prepared Rhodopol™ 23 aqueous thickener solution (concentration 10 grams per litre of xanthan gum) was added to the polymeric microparticles preparation with stirring via a magnetic stirrer bar method. The final mixed organic+aqueous phase should weigh ca. 42.09+186.19+25.3 g=ca. 253.58 g in total. The final sample was accordingly bottled and labelled ready for shipment to the field trials in Europe.

The ingredients and their loading percentages for sample #11 (Polymeric Microparticle Example 11) were as follows:

| | | % by weight of the |
|---|---|---|
| | | aqueous dispersion |
| Sample | Ingredient | (to 2 d.p.) |
| SJH001- | dicamba acid * | 4.98 * |
| 011-002 | AIBN | 0.34 |
| | VIAPAL ™ VUP | 10.59 |
| | 4779/55 resin | |
| | Gohsenol ™ GL05 | 3.96 |
| | (polyvinyl alcohol) | |
| | Rhodopol ™ 23 | 0.0988 (to 3 s.f.) |
| | (xanthan gum) | |
| | DI water | 79.32 |

* impurities of dicamba are not included in this calculation

For certain ingredients, for sample #11 (Polymeric Microparticle Example 11, experiment SJH001/011/002), the ratios by weight of (a) the stated ingredient to (b) the total non-aqueous phase (total polymeric microparticles), in the aqueous dispersion were as follows:

| | | Ratio by weight of (a) |
|---|---|---|
| | | the stated ingredient to |
| | | (b) the total non-aqueous |
| | | phase (total polymeric |
| | | microparticles), in the |
| Sample | Ingredient | aqueous dispersion |
| SJH001- | Gohsenol ™ GL05 | 0.2386:1 ** = |
| 011-002 | (polyvinyl alcohol) | 1:4.19 (to 3 s.f.) |
| | Rhodopol ™ 23 | 0.00595:1 ** = |
| | (xanthan gum) | 1:168 (to 3 s.f.) |
| | dicamba acid | 0.3001:1 ** = |
| | (excluding impurities) | 1:3.33 (to 3 s.f.) |

** The total weight of the polymeric microparticles is calculated as [total weight of: resin + dicamba + dicamba impurities + initiator].

### Particle Size Analysis for Polymeric MicroParticle Example 11

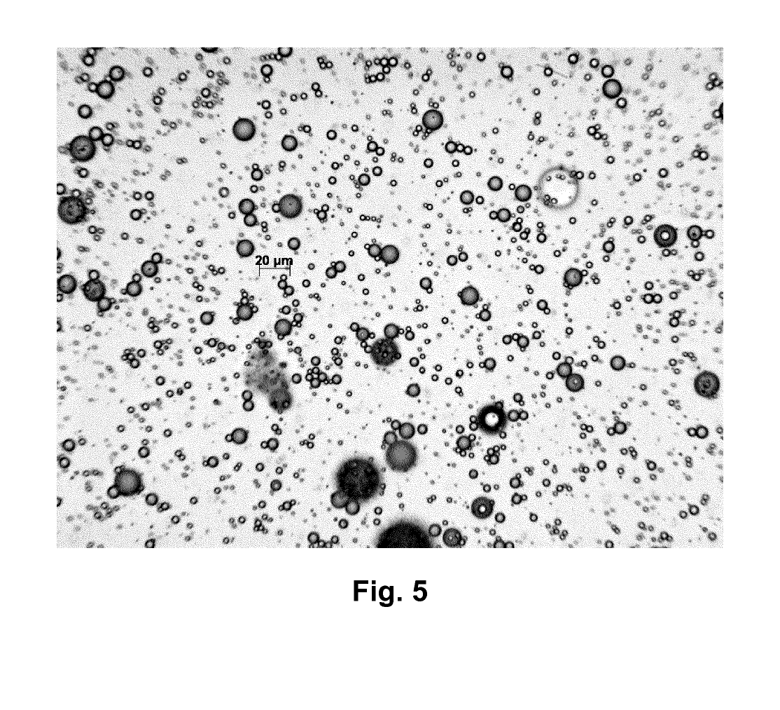

An optical microscope photograph of the microparticles formed in Polymeric Microparticle Example 11 is shown in FIG. 5 hereinafter, in which the scale-bar shown is 20 micrometres.

Particle size data were measured by light scattering laser diffraction (either dynamic or static) using a Malvern Mastersizer™ 2000 (available from Malvern Instruments, UK) giving a result for the Polymeric Microparticle Example 11, SJH001/011/002, as follows:
D(4,3)=volume-weighted mean diameter (mean diameter by volume)=10.51 microns (=micrometres).

### Polymeric Microparticle Example 12

### Preparation of Dicamba Microparticle Sample #12 (Experiment SJH001/008/002)

### Prepared for Field Trials

### Introduction

This microparticle example (experiment SJH001/008/002), has a target of 5% of dicamba (measured as the free acid) by weight of the aqueous dispersion, and is, with some small changes, a larger scale (250 grams target scale) substantial repeat of Polymeric Microparticle Example 7. The prepared microparticles contain a “moderate dicamba:polymer” ratio (=“0.2 dicamba acid/0.8 other ingredients” weight ratio within each microparticle), and again contain an amino-silane-modified kaolin clay as a “Pickering” emulsion stabiliser (as opposed to polyvinyl alcohol used in Polymeric Microparticle Examples 10 and 11). The date-of-Manufacture was 3 Feb. 2012, and the prepared microparticles were then sprayed in field trials in Europe during March 2012.

### Method

The organic phase (i.e. the “non-aqueous” phase) was prepared by dissolving dicamba acid of 87.9% purity (14.78 grams, providing 12.99 g=58.8 mmol of actual dicamba acid whose R.M.M.=221.0) in Viapal™ VUP 4779/55 resin (48.91 grams) by sonicating using Precision Ultrasonic Cleaning DP202-00 device for 5 minutes and then stirring at 50° C. with a magnetic stirrer (i.e. an Heidolph™ magnetic hot-plate stirrer) until all the dicamba acid had dissolved (several minutes), followed by cooling back to room temperature, after which initiator azo-bis-isobutyronitrile (AIBN, 1.32 grams, 8.0 mmol, where its R.M.M.=164.2) was added and dissolved in the mixture by magnetic flea stirrer method for 10 minutes at room temperature.

Furthermore, 6.25 grams of an amino-silane-modified kaolin clay known as Imerys™ RLO 7645 was dispersed into 143.4 grams of deionised (DI″) water by using an ultrasonic probe (Ultrasonic Processor GEX 130; sonic probe head CV18)—60 seconds of pulsed sonication was employed (i.e. 1 second “on”, 1 second “off”, for 60 seconds duration). This gave a total aqueous phase of 149.65 grams with final homogenisation by hand-shaking within the chosen 300 ml volume sealed glass jar.

To prepare the required micro-particles in this afore-said glass jar, the majority (62.22 grams) of the above-mentioned “organic phase” (which is [62.22 g/65.01 g]=95.71% by weight of the prepared organic phase, calculated as containing ca. 12.43 g of actual dicamba acid, ca. 1.26 g of AIBN and ca. 46.81 g of Viapal™ resin) was added in 0.5 ml aliquots to the entire above-mentioned “aqueous phase” while mixing for 10 minutes at the 8000 rpm (the “yellow setting”) with a high shear mixer (IKA™ Ultra-Turrax™ T25) coupled with a “large head” attachment (known as “dispersing element S 25 N-18 G”). Mixing was continued for 4 minutes at the 9500 rpm (the “green setting”) until the emulsion droplets were all smaller than 50 micrometres. In addition, 12.66 grams of a separately prepared Rhodopol™ 23 aqueous thickener solution (concentration 10 grams per litre of xanthan gum) was added to the polymeric micro-particles emulsion preparation. The emulsion was then further stirred with a magnetic stirrer and heated to 80° C. for 2 hours, to cure (i.e. polymerise) the Viapal™ VUP 4779/55 resin and thereby to form an aqueous dispersion of the polymeric micro-particles containing the herbicidal dicamba acid. The emulsion was efficiently stirred using an IKA™ Labortechnik “Lab-Egg”™ RW-11 basic mixer with sufficient “cling film” covering the glass vessel aperture to avoid any significant evaporative water losses. Finally, a further 25.29 grams of the separately prepared Rhodopol™ 23 aqueous thickener solution (concentration 10 grams per litre of xanthan gum) was added to the post-reaction polymeric micro-particles preparation with stirring via a magnetic stirrer bar method. The final mixed organic+aqueous phase should weigh ca. 62.22+149.65+12.66+25.29 g=ca. 249.82 g in total; and should contain 0.3757 g of xanthan gum. The final sample was accordingly bottled and labelled ready for shipment to the field trials in Europe.

The ingredients and their loading percentages for sample #12 (Polymeric Microparticle Example 12) were as follows:

| | | % by weight of the |
|---|---|---|
| | | aqueous dispersion |
| Sample | Ingredient | (to 2 d.p.) |
| SJH001- | dicamba acid * | 4.98 * |
| 008-002 | AIBN | 0.51 |
| | VIAPAL ™ VUP | 18.74 |
| | 4779/55 resin | |
| | Imerys ™ RLO 7645 amino- | 2.50 |
| | silane-modified kaolin clay | |
| | Rhodopol ™ 23 | 0.150 (to 3 s.f.) |
| | (xanthan gum) | |
| | DI water | 72.44 |

* impurities of dicamba are not included in this calculation

For certain ingredients, for sample #12 (Polymeric Microparticle Example 12, experiment SJH001/008/002), the ratios by weight of (a) the stated ingredient to (b) the total non-aqueous phase (total polymeric microparticles), in the aqueous dispersion were as follows:

| | | Ratio by weight of (a) |
|---|---|---|
| | | the stated ingredient to |
| | | (b) the total non-aqueous |
| | | phase (total polymeric |
| | | microparticles), in the |
| Sample | Ingredient | aqueous dispersion |
| SJH001- | Imerys ™ RLO 7645 amino- | 0.1005:1 ** = |
| 008-002 | silane-modified kaolin clay | 1:9.96 (to 3 s.f.) |
| | Rhodopol ™ 23 | 0.00604:1 ** = |
| | (xanthan gum) | 1 to 166 (to 3 s.f.) |
| | dicamba acid | 0.1998:1 ** = |
| | (excluding impurities) | 1:5.00 (to 3 s.f.) |

** The total weight of the polymeric microparticles is calculated as [total weight of: resin + dicamba + dicamba impurities + initiator].

### Particle Size Analysis for Polymeric Microparticle Example 12

An optical microscope photograph of the microparticles formed in Polymeric Microparticle Example 12 is shown in FIG. 6 hereinafter, in which the scale-bar shown is 50 micrometres.

Particle size data were measured by light scattering laser diffraction (either dynamic or static) using a Malvern Mastersizer™ 2000 (available from Malvern Instruments, UK) giving a result for the Polymeric Microparticle Example 12, SJH001/008/002, as follows:
D(4,3)=volume-weighted mean diameter (mean diameter by volume)=25.2 microns (=micrometres).

### Polymeric Microparticle Example 13

### Preparation of Dicamba Microparticle Sample #13 (Experiment SJH001/009/002)

### Prepared for Field Trials

### Introduction

This microparticle example (experiment SJH001/009/002), has a target of 5% of dicamba (measured as the free acid) by weight of the aqueous dispersion, and is at a large scale (of 250 grams target scale). The prepared microparticles contain a “moderate dicamba:polymer” ratio (=“0.2 dicamba acid/0.8 other ingredients” weight ratio within each microparticle), and contain an amino-silane-modified kaolin clay as a “Pickering” emulsion stabiliser (as opposed to the polyvinyl alcohol used in Polymeric Microparticle Examples 10 and 11), and also contain added plasticiser (methyl benzoate) in the organic phase. The date-of-Manufacture was 6 Feb. 2012, and the prepared microparticles were then sprayed in field trials in Europe during March 2012.

### Method

The organic phase (i.e. the “non-aqueous” phase) was prepared, firstly, by making a pre-mixture of Viapal™ VUP 4779/55 resin (42.42 grams) and methyl benzoate (6.50 grams) by stirring with a magnetic stirrer for 5 minutes (i.e. using an Heidolph™ magnetic hot-plate stirrer). Then, secondly, the resulting resinous blend was used to dissolve the dicamba acid of 87.9% purity (14.8 grams, providing=13.01 g=58.9 mmol of actual dicamba acid whose R.M.M.=221.0) by sonicating using Precision Ultrasonic Cleaning DP202-00 device for 5 minutes and then stirring at 50° C. with the Heidolph™ magnetic hot plate stirrer until all the dicamba acid had dissolved (several minutes), followed by cooling back to room temperature, after which initiator azo-bis-isobutyronitrile (AIBN, 1.30 grams, 7.9 mmol, where its R.M.M.=164.2) was added and dissolved in the mixture by magnetic flea stirrer method for 10 minutes at room temperature.

Furthermore, 6.26 grams of an amino-silane-modified kaolin clay known as Imerys™ RLO 7645 was dispersed into 143.39 grams of deionised (DI) water by using an ultrasonic probe (Ultrasonic Processor GEX 130; sonic probe head CV18)—60 seconds of pulsed sonication was employed (i.e. 1 second “on”, 1 second “off”, for 60 seconds duration). This gave a total aqueous phase of 149.65 grams with final homogenisation by hand-shaking within the chosen 300 ml volume sealed glass jar.

To prepare the required microparticles in this afore-said glass jar, the majority (62.07 grams) of the above-mentioned “organic phase” (which is [62.07 g/65.02 g]=95.46% by weight of the prepared organic phase, calculated as containing ca. 12.42 g of actual dicamba acid, ca. 1.24 g of AIBN, ca. 40.50 g of Viapal™ resin, and 6.21 g of methyl benzoate) was added in 0.5 ml aliquots to the entire above-mentioned “aqueous phase” while mixing for 10 minutes at 8000 rpm (the “yellow setting”) with a high shear mixer (IKA™ Ultra-Turrax™ T25) coupled with a “large head” attachment (known as “dispersing element S 25 N-18 G”). Mixing was continued for 4 minutes at 9500 rpm (the “green setting”) until the emulsion droplets were all smaller than 50 micrometres. In addition, 12.65 grams of a separately prepared Rhodopol™ 23 aqueous thickener solution (concentration 10 grams per litre of xanthan gum) was added to the polymeric microparticles emulsion preparation. The emulsion was then further stirred with a magnetic stirrer and heated to 80° C. for 2 hours, to cure (i.e. polymerise) the Viapal™ VUP 4779/55 resin and thereby to form an aqueous dispersion of the polymeric microparticles containing the herbicidal dicamba acid. The emulsion was efficiently stirred using an IKA™ Labortechnik “Lab-Egg”™ RW-11 basic mixer with sufficient “cling film” covering the glass vessel aperture to avoid any significant evaporative water losses. Finally, a further 25.33 grams of the separately prepared Rhodopol™ 23 aqueous thickener solution (concentration 10 grams per litre of xanthan gum) was added to the post-reaction polymeric microparticles preparation with stirring via a magnetic stirrer bar method. The final mixed organic+aqueous phase should weigh ca. 62.07+149.65+12.65+25.33 g=ca. 249.70 g in total; and should contain 0.3760 g of xanthan gum. The final sample was accordingly bottled and labelled ready for shipment to the field trials in Europe.

The ingredients and their loading percentages for sample #13 (Polymeric Microparticle Example 13) were as follows:

| | | % by weight of the |
|---|---|---|
| | | aqueous dispersion |
| Sample | Ingredient | (2 d.p.) |
| SJH001- | dicamba acid * | 4.97 * |
| 009-002 | AIBN | 0.50 |
| | VIAPAL ™ VUP 4779/55 | 16.22 |
| | resin methyl benzoate | 2.49 |
| | Imerys ™ RLO 7645 amino- | 2.51 |
| | silane-modified kaolin clay | |
| | Rhodopol ™ 23 | 0.151 (to 3 s.f.) |
| | (xanthan gum) | |
| | DI water | 72.48 |

* impurities of dicamba are not included in this calculation

For certain ingredients, for sample #13 (Polymeric Microparticle Example 13, experiment SJH001/009/002), the ratios by weight of (a) the stated ingredient to (b) the total non-aqueous phase (total polymeric microparticles), in the aqueous dispersion were as follows:

| | | Ratio by weight of (a) |
|---|---|---|
| | | the stated ingredient to |
| | | (b) the total non-aqueous |
| | | phase (total polymeric |
| | | microparticles), in the |
| Sample | Ingredient | aqueous dispersion |
| SJH001- | Imerys ™ RLO 7645 amino- | 0.1009:1 ** = |
| 009-002 | silane-modified kaolin clay | 1:9.92 (to 3 s.f.) |
| | Rhodopol ™ 23 | 0.00606:1 ** = |
| | (xanthan gum) | 1:165 (to 3 s.f.) |
| | dicamba acid | 0.2001:1 ** = |
| | (excluding impurities) | 1:5.00 (to 3 s.f.) |
| | methyl benzoate | 0.1000:1 ** = |
| | | 1:10.0 (to 3 s.f.) |

** The total weight of the polymeric microparticles is calculated as [total weight of: resin + dicamba + dicamba impurities + initiator].

### Particle Size Analysis for Polymeric Micro-Particle

### Example 13

An optical microscope photograph of the microparticles formed in Polymeric Microparticle Example 13 is shown in FIG. 7 hereinafter, I which the scale-bar shown is 50 micrometres.

Particle size data were measured by light scattering laser diffraction (either dynamic or static) using a Malvern Mastersizer™ 2000 (available from Malvern Instruments, UK) giving a result for the Polymeric Microparticle Example 13, SJH001/009/002, as follows:
D(4,3)=volume-weighted mean diameter (mean diameter by volume)=22.5 microns (=micrometres).

### Reference Polymeric Microparticle Example 14

### Preparation of Dicamba Microparticle Sample #14 (Experiment SJH001/035/002)

### Repeat of Sandoz EP 0 517 669 A1 Example 1

### Introduction

This preparation was intended as a close-to-exact repeat of the preparation of dicamba microparticles disclosed in Example 1 (page 5) of the patent application published as EP 0 517 669 A1 in the name of Sandoz Ltd. As trivial modifications of Example 1 of EP 0 517 669 A1, a different scale of the preparation was used, and the initiator used was tert-butyl peroxybenzoate, which is similar in functionality and is thought to be similar in effect to the USP-245 peroxyester initiator [which is 2,5-dimethyl-2,5-di(2-ethylhexanoylperoxy)hexane] used in Example 1 of EP 0 517 669 A1. This polymeric microparticle (“PMP”) example (experiment SJH001/035/002), has a target of 12.3% of dicamba (measured as the free acid) by weight of the aqueous dispersion—i.e. it has a high concentration of dicamba and of polymeric microparticles, by weight of the aqueous dispersion, compared to other Polymeric Microparticle Examples disclosed herein. This microparticle example contains a “moderate dicamba:polymer” ratio (=“0.246 dicamba acid/0.754 other ingredients” weight ratio within each microparticle).

### Method

The organic phase (i.e. the “non-aqueous” phase) was prepared by dissolving dicamba acid of 87.9% purity (2.8069 grams, providing 2.4673 g=11.16 mmol of actual dicamba acid, whose R.M.M.=221.0) in Viapal™ VUP 4779/55 resin (7.0666 grams) by sonicating using Precision Ultrasonic Cleaning DP202-00 device for 10 minutes and then stirring at 50° C. with a magnetic stirrer (i.e. an Heidolph™ magnetic hot-plate stirrer) until all the dicamba acid had dissolved (several minutes), followed by cooling back to room temperature, after which initiator tert-butyl peroxybenzoate of 98% purity (0.153 grams, providing 0.150 g=0.772 mmol of actual tert-butyl peroxybenzoate, whose R.M.M.=194.25) was added and mixed in by magnetic flea stirrer method for 5 minutes at room temperature.

For the “aqueous phase”, firstly a stock solution of Gohsenol™ GL05 (polyvinyl alcohol) of 15% by weight was prepared (i) by adding 15 grams of Gohsenol™ GL05 to 85 grams of deionised (DI) water at 60° C. while stirring with an IKA™ Labortechnik “Lab-Egg”™ RW-11 basic mixer and then (ii) stirring was continued for 20 minutes until all material had dissolved. Secondly, the aqueous phase was then prepared by adding 0.3516 grams of this 15% by weight Gohsenol™ GL05 stock solution (i.e. containing 0.05274 g of Gohsenol™ GL05 polyvinyl alcohol) to 4.5314 grams of DI water. Homogenisation of this aqueous phase was achieved by hand-shaking within a 20 millilitre volume sealed glass vial. Gantrez™ S-95S (methyl vinyl ether/maleic acid copolymer, an anionic surfactant, available from GAF, 0.0239 grams) was then added to this aqueous phase and dissolution was achieved via stirring at 80° C. for 30 minutes using the magnetic flea stirrer method. The aqueous phase was cooled to room temperature and 2 drops (say, approx. 0.05 grams) of SAG™ 1572 foam control agent were added. Homogenisation of the aqueous phase (which should weigh 4.9569 g) was achieved through hand shaking of the sealed glass vial.

To prepare the microparticles in this afore-said glass vial, 5.1666 grams of the above-mentioned “organic phase” (which is [5.1666 g/10.0265 g]=ca. 51.53% by weight of the prepared organic phase, calculated as containing ca. 1.2714 g of actual dicamba acid, ca. 0.0773 g of tert-butyl peroxybenzoate, and ca. 3.6414 g of Viapal™ resin) was added dropwise to the entire above-mentioned “aqueous phase” while mixing for 5 minutes at 20% of the maximum speed (the “yellow setting”) of a high shear mixer (IKA™ Ultra-Turrax™ T25, maximum speed=25000 rpm) coupled with a “small head” attachment (known as “dispersing element S 25 N-10 G”). Mixing was then continued for 8 minutes at 50% of the maximum speed (the “green setting”). Mixing was stopped and Reax™ 88B (lignosulfonate, an anionic surfactant, 0.0986 grams) was added. The glass vial was left on a Stuart™ Roller Mixer SRT6 for 1 hour to allow the mixture to homogenise. The emulsion was then stirred with a magnetic stirrer and heated to 70° C. for 4 hours, to cure (i.e. polymerise) the Viapal™ VUP 4779/55 resin and thereby to form an aqueous dispersion of the polymeric microparticles (PMPs) containing the herbicidal dicamba acid. The total mixed organic+aqueous phases should weigh ca. 5.1666+4.9569+0.0986 g=ca. 10.2221 g.

The loading percentages for each ingredient of sample SJH001/035/002 (Polymeric Microparticle Example 14) were as follows:

| | | % by weight of the |
|---|---|---|
| | | aqueous dispersion |
| | | (to 2 d.p. except |
| Sample | Ingredient | where shown) |
| SJH001/ | dicamba acid (excluding impurities) | 12.44 |
| 035/002 | Viapal ™ VUP 4779/55 resin | 35.62 |
| | tert-butyl peroxybenzoate initiator | 0.76 |
| | (=Total PMP, including impurities) | (=50.54) |
| | Gohsenol ™ GL05 (polyvinyl alcohol) | 0.516 (to 3 s.f.) |
| | Gantrez ™ S-95S (copolymer) | 0.234 (to 3 s.f.) |
| | Reax ™ 88B (lignosulfonate) | 0.965 (to 3 s.f.) |
| | SAG ™ 1527 (antifoam) | 0.49 |
| | DI Water- rest | 47.25 |

For certain ingredients, for sample #14 (Polymeric Microparticle Example 14, experiment SJH001/035/002), the ratios by weight of (a) the stated ingredient to (b) the total non-aqueous phase (total polymeric microparticles), in the aqueous dispersion were as follows:

| | | Ratio by weight of (a) the stated |
|---|---|---|
| | | ingredient to (b) the total |
| | | non-aqueous phase (total |
| | | polymeric microparticles), |
| Sample | Ingredient | in the aqueous dispersion |
| SJH001/035/ | Gohsenol ™ GL05 (polyvinyl alcohol) | 0.0102:1 ** = |
| 002 | | 1:98.0 (to 3 s.f.) |
| | Gantrez ™ S-95S (copolymer) | 0.00463:1 ** = |
| | (an anionic surfactant) | 1:216 (to 3 s.f.) |
| | Reax ™ 88B (lignosulfonate) | 0.01908:1 ** = |
| | (an anionic surfactant) | 1:52.4 (to 3 s.f.) |
| | total ionic surfactants [= total of Gantrez | 0.02371:1 ** = |
| | ™ S-95S (copolymer) + Reax ™ 88B | 1:42.2 (to 3 s.f.) |
| | (lignosulfonate)] | |
| | dicamba acid (excluding impurities) | 0.2461:1 ** = |
| | | 1:4.06 (to 3 s.f.) |

** The total weight of the polymeric microparticles (“PMPs”) is calculated as [total weight of: resin + dicamba + dicamba impurities + initiator].

### Microscopy Analysis of Polymeric Microparticle Example 14

### SJH001/035/002

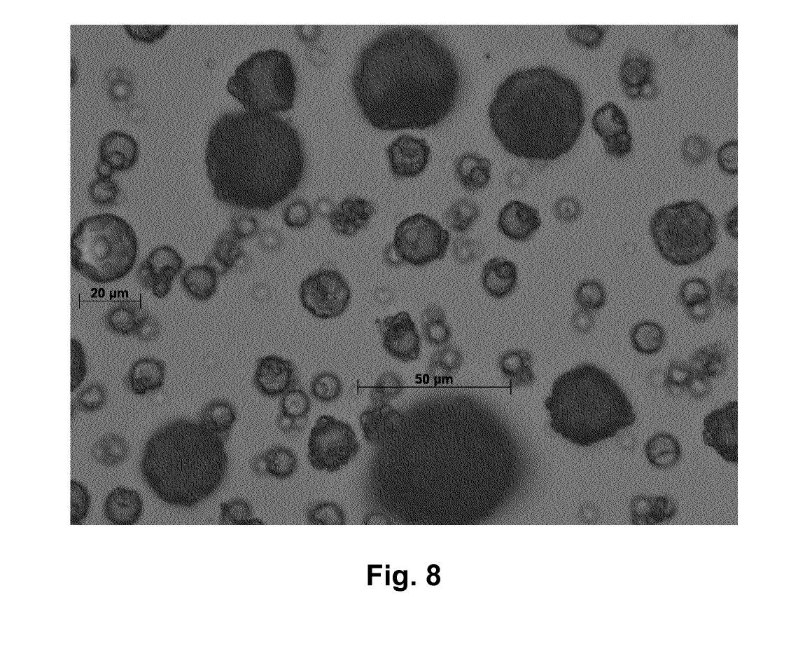

An optical microscope photograph of the microparticles formed in SJH001/035/002 (repeat of Sandoz Example 1) is shown in FIG. 8 hereinafter, in which the two scale-bars shown are 20 micrometres (at left side of photograph) and 50 micrometres (at bottom of photograph).

It can bee seen from FIG. 8 that the dispersion includes a large number of quite large polymeric microparticles whose diameters are in the 13 to 50 micrometre, or 15 to 50 micrometre, range. The texture and/or viscosity of the uncured mixture might have contributed to this slightly large particle size. Also, FIG. 8 seems to show that some of the larger particles seen are agglomerations of smaller particles.

### Assessment of Compatibility with Axial™ and Adigor™ Tank Mix Partners of Polymeric Microparticle Example 14

### SJH001/035/002

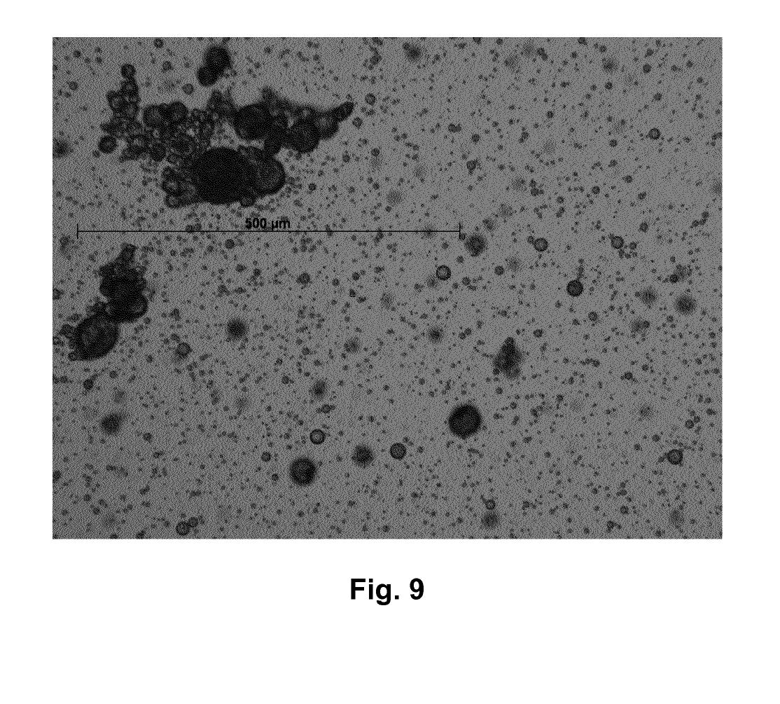

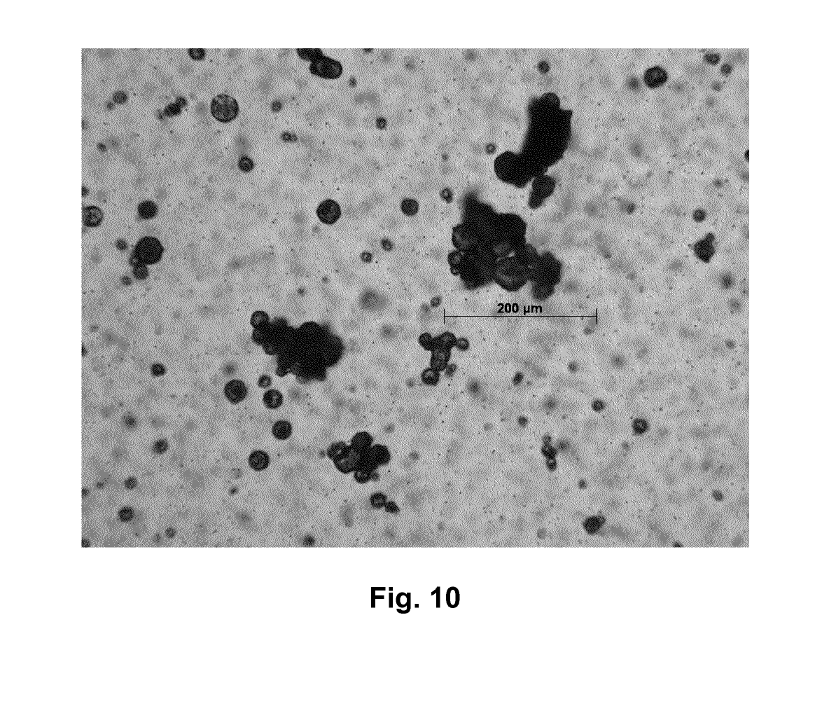

0.03 millilitres of Axial™ 100EC (which is an emulsifiable concentrate (“EC”) containing 100 g/L of the active ingredient pinoxaden, plus 25 g/L of cloquintocet-mexyl as a safener, plus tetrahydrofurfuryl alcohol and aromatic hydrocarbons as solvents, plus one, two or three surfactants, e.g. available from Syngenta; e.g. similar to the ECs of Example 1 (EC3) and/or Example 4 disclosed on pages 5-6 and 7 of WO 2007/073933 A2 which is incorporated herein by reference), 0.1 millilitres of the adjuvant Adigor™ (an emulsifiable concentrate containing 47% by weight of the formulation of methylated rapeseed oil as an adjuvant, e.g. available from Syngenta) and 0.2 millilitres of microparticle sample SJH001/035/002 (Reference Polymeric Microparticle Example 14) were combined in 20 millilitres of DI water. Homogenisation of this tank mix sample was achieved by hand-shaking of the 30 millilitre volume sealed glass jar. The mixture was left on a Stuart™ Roller Mixer SRT6 at room temperature, and optical microscope photographs were taken after 5 minutes of mixing (see FIG. 9 hereinafter, in which the scale-bar shown is 500 micrometres) and after 2.5 hours of mixing (see FIG. 10 hereinafter, in which the scale-bar shown is 200 micrometres). Observation of the glass jar containing this shaken and mixed “tank mixture”, 2.5 hours after its preparation, shows that the mixture is a cloudy slightly yellow-light brown dispersion with some lightly-visible smears (particles, or flocs) stuck to the glass jar wall above the waterline. The above-described “tank mixture” was left to stand at room temperature overnight before performing a wet sieve residue test. The entire tank mixture was poured through a 3.5 centimetre diameter Endecotts™ test sieve of aperture size 150 micrometres. The resulting residue on the sieve was photographed (the photograph, not shown herein, shows a solid residue collected on the sieve) and then dried in a 50° C. oven for 3 days. The remaining dry residue collected weighed 4.4 milligrams.

### Conclusions for Polymeric Microparticle Example 14

### SJH001/035/002, repeat of Sandoz EP 0 517 669 A1 Example 1

The preparation of these dicamba containing microparticles was successful, giving the discrete, fairly large-sized, solid polymer particles shown in FIG. 8.

However, upon mixing with Axial™ 100EC (an EC containing pinoxaden) and Adigor™ (an EC containing methylated rapeseed oil), flocculation occurred quickly with flocs of up to 300-400 micrometres and of up to 150-200 micrometres being seen via optical microscopy after just 5 minutes (FIG. 9) and after 2.5 hours (FIG. 10) respectively. On a macroscopic scale, this flocculation was evident in a wet sieve residue test in which 4.4 milligrams of flocculated material was unable to pass through a sieve of a 150 micrometre aperture size. This is a good demonstration of how a nozzle filter would become blocked if this tank mixture was sprayed.

It is therefore thought that Polymeric Microparticle Example 14 (a substantial repeat of Sandoz EP 0 517 669 A1 Example 1) is not very suitable for “tank mixing” in water with emulsifiable concentrates of the type used in Axial 100EC™ and/or Adigor™, because of this flocculation (or heteroflocculation) problem.

### Polymeric Microparticle Example 15

### Preparation of Dicamba Microparticle Sample #15 (Experiment SJH001/035/003)

### Modified Version of Example 1 of Sandoz EP 0 517 669 A1

### Introduction

Polymeric Microparticle Example 15 (experiment SJH001/035/003) was a modified version of Polymeric Microparticle Example 14 (experiment SJH001/035/002, which was an approximate repeat of Example 1 of Sandoz EP 0 517 669 A1).

The modifications included a reduction in the phase volume of the polymeric microparticles (“PMPs”) in the aqueous phase from ca. 50% to ca. 20% by weight.

A further alteration was the inclusion of a higher level of Gohsenol™ GL05 (polyvinyl alcohol, a non-ionic surfactant) compared to the level used in SJH001/035/002. This increase was from 0.516% by weight to ca. 2.79% by weight of the total aqueous dispersion formulation. The amounts of the other two (anionic) surfactants used, Gantrez™ S-95S and Reax™ 88B, were maintained at the same level as in Polymeric Microparticle Example 14.

Polymeric Microparticle Example 15 (experiment SJH001/035/003), has a target of 5% of dicamba (measured as the free acid) by weight of the aqueous dispersion, and contains a “moderate dicamba:polymer” ratio (=“0.246 dicamba acid/0.754 other ingredients” weight ratio within each microparticle).

### Method

The organic phase (i.e. the “non-aqueous” phase) was prepared by dissolving dicamba acid of 87.9% purity (2.8069 grams, providing 2.4673 g=11.16 mmol of actual dicamba acid whose R.M.M.=221.0) in Viapal™ VUP 4779/55 resin (7.0666 grams) by sonicating using Precision Ultrasonic Cleaning DP202-00 device for 10 minutes and then stirring at 50° C. with a magnetic stirrer (i.e. an Heidolph™ magnetic hot-plate stirrer) until all the dicamba acid had dissolved (several minutes), followed by cooling back to room temperature, after which initiator tert-butyl peroxybenzoate of 98% purity (0.153 grams technical material, providing 0.150 g=0.772 mmol of actual tert-butyl peroxybenzoate, whose R.M.M.=194.25) was added and mixed in by magnetic flea stirrer method for 5 minutes at room temperature.

For the “aqueous phase”, firstly a stock solution of Gohsenol™ GL05 (polyvinyl alcohol) of 15% by weight was prepared (i) by adding 15 grams of Gohsenol™ GL05 to 85 grams of DI water at 60° C. while stirring with an IKA™ Labortechnik “Lab-Egg”™ RW-11 basic mixer and then (ii) stirring was continued for 20 minutes until all material had dissolved.

Secondly, the aqueous phase was then prepared by adding 1.874 grams of this 15% by weight Gohsenol™ GL05 stock solution (i.e. containing 0.2811 g of Gohsenol™ GL05 polyvinyl alcohol) to 5.9612 grams of DI water. Homogenisation of this aqueous phase was achieved by hand-shaking within a 20 millilitre volume sealed glass vial. Gantrez™ S-95S (methyl vinyl ether/maleic acid copolymer, an anionic surfactant, available from GAF, 0.0240 grams) was then added to this aqueous phase and dissolution was achieved via stirring at 80° C. for 30 minutes using the magnetic flea stirrer method. The aqueous phase was cooled to room temperature and 2 drops (say, approx. 0.05 grams) of SAG™ 1572 foam control agent were added. Homogenisation of the aqueous phase (which should weigh ca. 7.9092 g) was achieved through hand shaking of the sealed glass vial.

To prepare the microparticles in this afore-said glass vial, 2.0575 grams of the above-mentioned “organic phase” (which is [2.0575 g/10.0265 g]=ca. 20.52% by weight of the prepared organic phase, calculated as containing ca. 0.5063 g of actual dicamba acid, ca. 0.0308 g of tert-butyl peroxybenzoate and ca. 1.4501 g of Viapal™ resin) was added dropwise to the entire above-mentioned “aqueous phase” while mixing for 5 minutes at 20% of the maximum speed (the “yellow setting”) of a high shear mixer (IKA™ Ultra-Turrax™ T25, maximum speed=25000 rpm) coupled with a “small head” attachment (known as “dispersing element S 25 N-10 G”). Mixing was then continued for 8 minutes at 50% of the maximum speed (the “green setting”). Mixing was stopped and Reax™ 88B (lignosulfonate, an anionic surfactant, 0.0985 grams) was added. The glass vial was then left on a Stuart™ Roller Mixer SRT6 for 1 hour to allow the mixture to homogenise. The emulsion was then stirred with a magnetic stirrer and heated to 70° C. for 4 hours, to cure (i.e. polymerise) the Viapal™ VUP 4779/55 resin and thereby to form an aqueous dispersion of the polymeric microparticles (PMPs) containing the herbicidal dicamba acid. The total mixed organic+aqueous phases should weigh ca. 2.0575+7.9092+0.0985 g=ca. 10.0652 g.

The loading percentages for each ingredient of sample SJH001/035/003 (Polymeric Microparticle Example 15) were as follows:

| | | % by weight of the |
|---|---|---|
| | | aqueous dispersion |
| | | (to 2 d.p. except |
| Sample | Ingredient | where shown) |
| SJH001/035/ | dicamba acid | 5.03 |
| 003 | Viapal ™ VUP 4779/55 resin | 14.41 |
| | tert-butyl peroxybenzoate initiator | 0.31 |
| | (= Total PMP, including impurities) | (= 20.44) |
| | Gohsenol ™ GL05 (polyvinyl alcohol) | 2.79 |
| | Gantrez ™ S-95S (copolymer) | 0.238 (to 3 s.f.) |
| | Reax ™ 88B (lignosulfonate) | 0.979 (to 3 s.f.) |
| | SAG ™ 1527 (antifoam) | 0.50 |
| | DI Water-rest | 75.05 |

For certain ingredients, for sample #15 (Polymeric Microparticle Example 15, experiment SJH001/035/003), the ratios by weight of (a) the stated ingredient to (b) the total non-aqueous phase (total polymeric microparticles), in the aqueous dispersion were as follows:

| | | Ratio by weight of (a) the stated |
|---|---|---|
| | | ingredient to (b) the total |
| | | non-aqueous phase (total |
| | | polymeric microparticles), |
| Sample | Ingredient | in the aqueous dispersion |
| SJH001/035/ | Gohsenol ™ GL05 (polyvinyl alcohol) | 0.1366:1 ** = |
| 003 | | 1:7.32 (to 3 s.f.) |
| | Gantrez ™ S-95S (copolymer) | 0.01166:1 ** = |
| | (an anionic surfactant) | 1:85.7 (to 3 s.f.) |
| | Reax ™ 88B (lignosulfonate) | 0.04787:1 ** = |
| | (an anionic surfactant) | 1:20.9 (to 3 s.f.) |
| | total ionic surfactants [= total of | |
| | Gantrez ™ S-95S (copolymer) + | 0.05954:1 ** = |
| | Reax ™ 88B (lignosulfonate)] | 1:16.8 (to 3 s.f.) |
| | dicamba acid (excluding impurities) | 0.2461:1 ** = |
| | | 1:4.06 (to 3 s.f.) |

** The total weight of the polymeric microparticles (“PMPs”) is calculated as [total weight of: resin + dicamba + dicamba impurities + initiator].

### Microscopy Analysis of Polymeric Microparticle Example 15

### SJH001/035/003

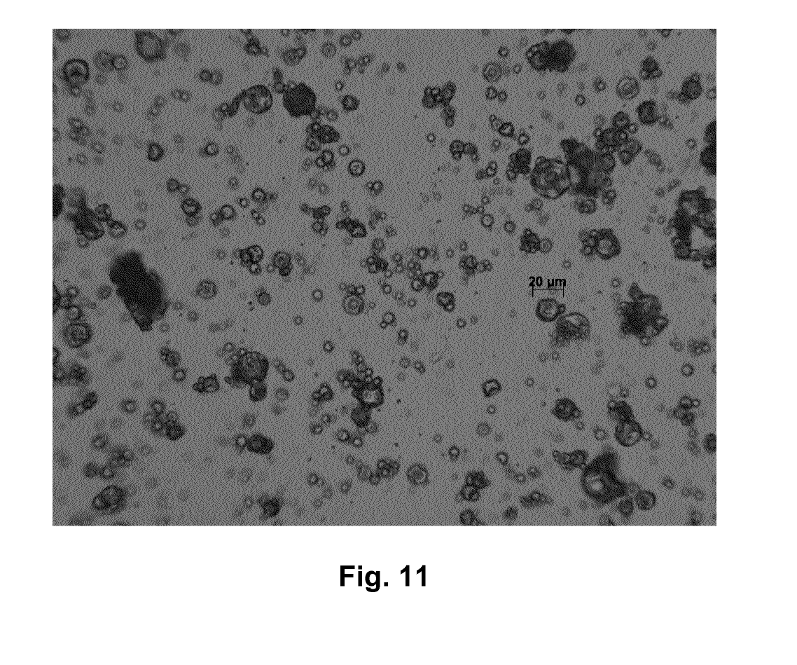

An optical microscope photograph of the microparticles formed in SJH001/035/003 (Polymeric Microparticle Example 15, the modified version of Sandoz Example 1) is shown in FIG. 11 hereinafter, in which the scale-bar shown is 20 micrometres.

### Assessment of Compatibility with Axial™ and Adigor™ tank mix partners of Polymeric Microparticle Example 15 (SJH001/035/003)

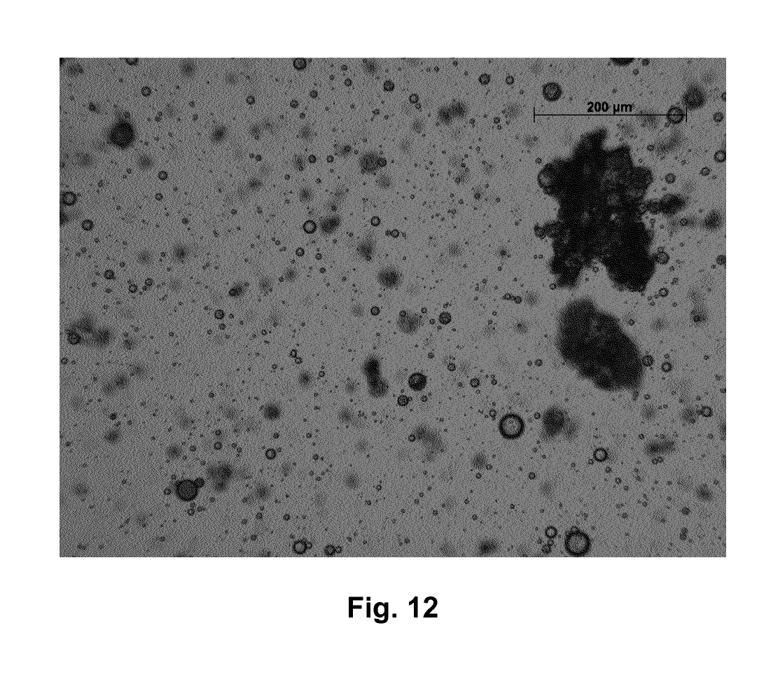

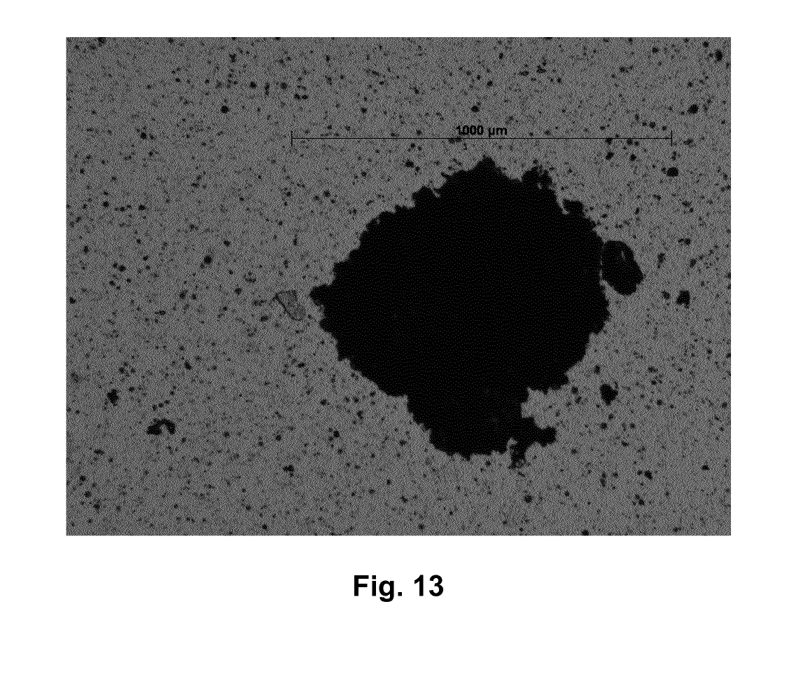

0.03 millilitres of Axial™ 100EC (which is an emulsifiable concentrate (“EC”) containing 100 g/L of the active ingredient pinoxaden, plus 25 g/L of cloquintocet-mexyl as a safener, plus tetrahydrofurfuryl alcohol and aromatic hydrocarbons as solvents, plus one, two or three surfactants, e.g. available from Syngenta; e.g. similar to the ECs of Example 1 (EC3) and/or Example 4 disclosed on pages 5-6 and 7 of WO 2007/073933 A2 which is incorporated herein by reference), 0.1 millilitres of the adjuvant Adigor™ (an emulsifiable concentrate containing 47% by weight of the formulation of methylated rapeseed oil as an adjuvant, e.g. available from Syngenta) and 0.48 millilitres of microparticle sample SJH001/035/003 (Polymeric Microparticle Example 15) were combined in 20 millilitres of DI water. Homogenisation of this tank mix sample was achieved by hand-shaking of the 30 millilitre volume sealed glass jar. The mixture was left on a Stuart™ Roller Mixer SRT6 at room temperature, and optical microscope photographs were taken after 5 minutes of mixing (see FIG. 12 hereinafter, in which the scale-bar shown is 200 micrometres) and after 2.5 hours of mixing (see FIG. 13 hereinafter, in which the scale-bar shown is 1000 micrometres). Observation of the glass jar containing this shaken and mixed “tank mixture”, 2.5 hours after preparation, shows that the mixture is a cloudy yellow-light brown dispersion with some clearly-visible large yellow-light brown smears (particles, or flocs) stuck to the glass jar wall above the waterline.

The above-described “tank mixture” was left to stand at room temperature overnight before performing a wet sieve residue test. The entire tank mixture was poured through a 3.5 centimetre diameter Endecotts™ test sieve of aperture size 150 micrometres. The resulting residue was photographed (the photograph, not shown herein, clearly shows a solid yellow-light brown residue collected on the sieve) and then dried in a 50° C. oven for 3 days. The remaining dry residue collected weighed 11.7 milligrams.

### Conclusions for Polymeric Microparticle Example 15

### SJH001/035/003

### Modified Version of Sandoz Example 1

The preparation of these modified dicamba containing microparticles was successful, giving solid dicamba polymer microparticles as shown in FIG. 11.

However, once again, upon mixing with Axial™ 100EC (an EC containing pinoxaden) and Adigor™ (an EC containing methylated rapeseed oil), flocculation occurred rapidly after just 5 minutes (see FIG. 12, which shows flocs of up to 200-250 micrometres). After 2.5 hours, flocs of up to 800-1000 micrometres were seen (see FIG. 13).

On a macroscopic scale, this flocculation was shown via a wet sieve residue test in which 11.7 milligrams of flocculated material was unable to pass through a sieve of a 150 micrometre aperture size. This is a good demonstration of how a nozzle filter would become blocked if this tank mixture was sprayed.

It is therefore thought that Polymeric Microparticle Example 15 (a modified version of Example 1 of Sandoz EP 0 517 669 A1, which contains more polyvinyl alcohol, but which still contains two anionic surfactants Gantrez™ S-95S and Reax™ 88B) is not very suitable for “tank mixing” in water with emulsifiable concentrates of the type used in Axial 100EC™ and/or Adigor™, because of this flocculation (or heteroflocculation) problem.

### Polymeric Microparticle Example 16

### Preparation of Dicamba Microparticle Sample #16 (Experiment SJH001/035/004)

### A Modification of Polymeric Microparticle Example 15 with Polyvinyl Alcohol as the Only Surfactant

### Introduction

In Polymeric Microparticle Example 16 (experiment/sample SJH001/035/004), the microparticle preparation uses the same lower phase volume of polymeric microparticles within the aqueous phase as in Polymeric Microparticle Example 15 (sample SJH001/035/003). The total surfactant level is also maintained at ca. 4% by weight of the aqueous dispersion, as in Polymeric Microparticle Example 15. However, unlike Polymeric Microparticle Examples 14+15, in this Polymeric Microparticle Example 16, the surfactant consists entirely of Gohsenol™ GL05 (polyvinyl alcohol, a nonionic surfactant), with no ionic surfactants being used [i.e. no Gantrez™ S-95S or Reax™ 88B is used].

The prepared polymeric microparticles (“PMPs”) (SJH001/035/004) contain a target of 5% of dicamba (measured as the free acid) by weight of the aqueous dispersion, and contain a “moderate dicamba:polymer” ratio (=“0.246 dicamba acid/0.754 other ingredients” weight ratio within each microparticle).

### Method

The organic phase (i.e. the “non-aqueous” phase) was prepared by dissolving dicamba acid of 87.9% purity (2.8069 grams, providing 2.4673 g=11.16 mmol of actual dicamba acid, whose R.M.M.=221.0) in Viapal™ VUP 4779/55 resin (7.0666 grams) by sonicating using Precision Ultrasonic Cleaning DP202-00 device for 10 minutes and then stirring at 50° C. with a magnetic stirrer (i.e. an Heidolph™ magnetic hot-plate stirrer) until all the dicamba acid had dissolved (several minutes), followed by cooling back to room temperature, after which initiator tert-butyl peroxybenzoate of 98% purity (0.153 grams, providing 0.150 g=0.772 mmol of actual tert-butyl peroxybenzoate, whose R.M.M.=194.25) was added and mixed in by magnetic flea stirrer method for 5 minutes at room temperature.

For the “aqueous phase”, firstly a stock solution of Gohsenol™ GL05 (polyvinyl alcohol) of 15% by weight was prepared (i) by adding 15 grams of Gohsenol™ GL05 to 85 grams of DI water at 60° C. while stirring with an IKA™ Labortechnik “Lab-Egg”™ RW-11 basic mixer and then (ii) stirring was continued for 20 minutes until all material had dissolved.

Secondly, the aqueous phase was then prepared by adding 2.7151 grams of this 15% by weight Gohsenol™ GL05 stock solution (i.e. containing 0.40727 g of Gohsenol™ GL05 polyvinyl alcohol) and 2 drops (say, approx. 0.05 grams) of SAG™ 1572 foam control agent to 5.2869 grams of DI water. Homogenisation of this aqueous phase (which should weigh ca. 8.0520 g) was achieved by hand-shaking within a 20 millilitre volume sealed glass vial.

To prepare the microparticles in this afore-said glass vial, 1.9723 grams of the above-mentioned “organic phase” (which is [1.9723 g/10.0265 g]=ca. 19.67% by weight of the prepared organic phase, calculated as containing ca. 0.4853 g of actual dicamba acid, ca. 0.0295 g of tert-butyl peroxybenzoate and ca. 1.3901 g of Viapal™ resin) was added dropwise to the entire above-mentioned “aqueous phase” while mixing for 5 minutes at 20% of the maximum speed (the “yellow setting”) of a high shear mixer (IKA™ Ultra-Turrax™ T25, maximum speed=25000 rpm) coupled with a “small head” attachment (known as “dispersing element S 25 N-10 G”). Mixing was then continued for 8 minutes at 50% of the maximum speed (the “green setting”). Mixing was stopped and the emulsion was then stirred with a magnetic stirrer and heated to 70° C. for 4 hours, to cure (i.e. polymerise) the Viapal™ VUP 4779/55 resin and thereby to form an aqueous dispersion of the polymeric microparticles containing the herbicidal dicamba acid. The total mixed organic+aqueous phases should weigh ca. 1.9723+8.0520 g=ca. 10.0243 g.

The loading percentages for each ingredient of sample SJH001/035/004 (Polymeric Microparticle Example 16) were as follows:

| | | % by weight of the |
|---|---|---|
| Sample | Ingredient | aqueous dispersion |
| SJH001/035/ | dicamba acid (excluding impurities) | 4.84 |
| 004 | Viapal ™ VUP 4779/55 resin | 13.87 |
| | tert-butyl peroxybenzoate initiator | 0.29 |
| | (= Total PMP, including impurities) | (= 19.68) |
| | Gohsenol ™ GL05 (polyvinyl alcohol) | 4.06 |
| | SAG ™ 1527 (antifoam) | 0.50 |
| | DI Water-rest | 75.76 |

For certain ingredients, for sample #16 (Polymeric Microparticle Example 16, experiment SJH001/035/004), the ratios by weight of (a) the stated ingredient to (b) the total non-aqueous phase (total polymeric microparticles), in the aqueous dispersion were as follows:

| | | Ratio by weight of (a) the |
|---|---|---|
| | | stated ingredient to (b) |
| | | the total non-aqueous |
| | | phase (total polymeric |
| | | microparticles), in the |
| Sample | Ingredient | aqueous dispersion |
| SJH001/035/ | Gohsenol ™ GL05 | 0.2065:1 ** = |
| 004 | (polyvinyl alcohol) | 1:4.84 (to 3 s.f.) |
| | dicamba acid | 0.2461:1 ** = |
| | (excluding impurities) | 1:4.06 (to 3 s.f.) |

** The total weight of the polymeric microparticles (“PMPs”) is calculated as [total weight of: resin + dicamba + dicamba impurities + initiator].

### Microscopy Analysis of Polymeric Microparticle Example 16

### SJH001/035/004

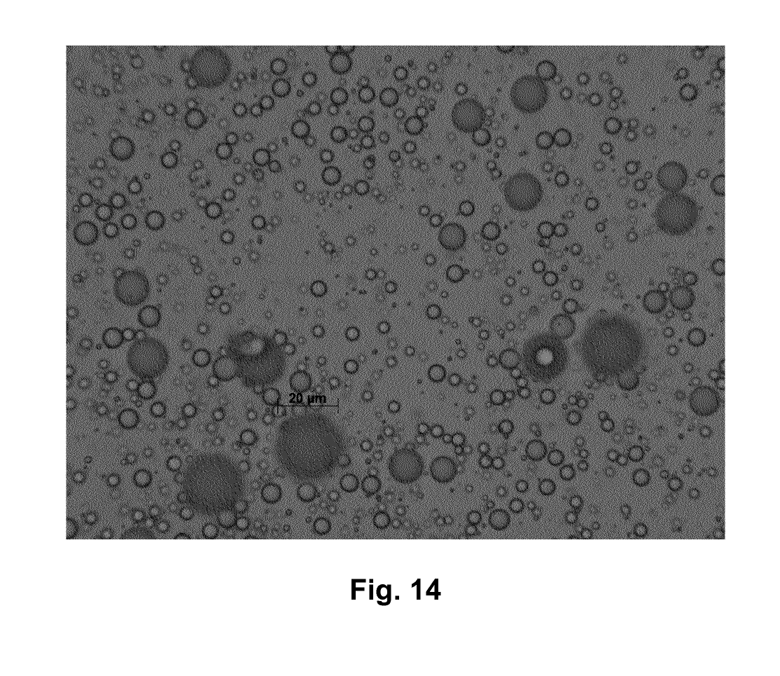

An optical microscope photograph of the microparticles formed in Polymeric Microparticle Example 16 (experiment SJH001/035/004, polyvinyl alcohol example) is shown in FIG. 14 hereinafter, in which the scale-bar shown is 20 micrometres.

### Assessment of Compatibility with Axial™ and Adigor™ Tank Mix Partners of Polymeric Microparticle Example 16 (SJH001/035/004)

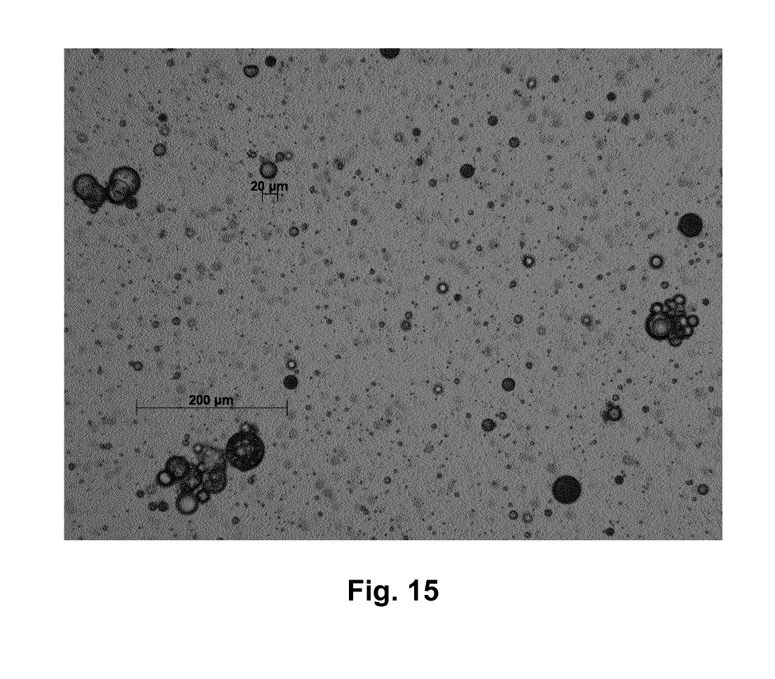

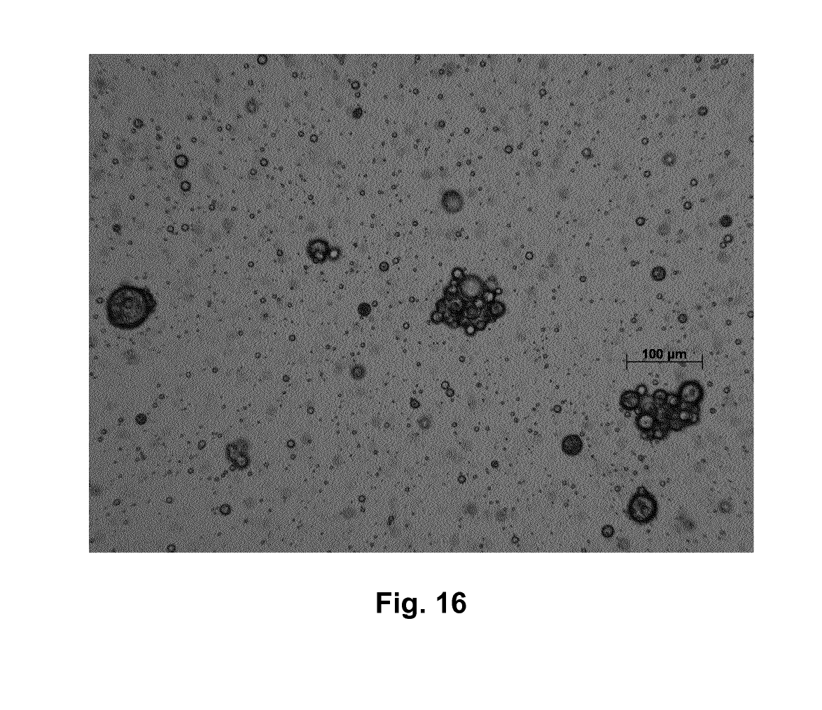

0.03 millilitres of Axial™ 100EC (which is an emulsifiable concentrate (“EC”) containing 100 g/L of the active ingredient pinoxaden, plus 25 g/L of cloquintocet-mexyl as a safener, plus tetrahydrofurfuryl alcohol and aromatic hydrocarbons as solvents, plus one, two or three surfactants, e.g. available from Syngenta; e.g. similar to the ECs of Example 1 (EC3) and/or Example 4 disclosed on pages 5-6 and 7 of WO 2007/073933 A2 which is incorporated herein by reference), 0.1 millilitres of the adjuvant Adigor™ (an emulsifiable concentrate containing 47% by weight of the formulation of methylated rapeseed oil as an adjuvant, e.g. available from Syngenta) and 0.48 millilitres of microparticle sample SJH001/035/004 (Polymeric Microparticle Example 16) were combined in 20 millilitres of DI water. Homogenisation of this tank mix sample was achieved by hand-shaking of the 30 millilitre volume sealed glass jar. The mixture was left on a Stuart™ Roller Mixer SRT6 at room temperature, and optical microscope photographs were taken after 5 minutes of mixing (see FIG. 15, in which the two scale-bars shown are 20 micrometres (top left of photograph) and 200 micrometres (bottom left of photograph)) and after 2.5 hours of mixing (see FIG. 16, in which the scale-bar shown is 100 micrometres). Observation of the glass jar containing the shaken and mixed “tank mixture”, 2.5 hours after preparation, shows that the mixture is a cloudy colourless dispersion with some lightly-visible smears (particles, or flocs) stuck to the glass jar wall above the waterline.

The above described “tank mixture” was left to stand at room temperature overnight before performing a wet sieve residue test. The entire tank mixture was poured through a 3.5 centimetre diameter Endecotts™ test sieve of aperture size 150 micrometres. No residue was collected on the sieve, and simple observation (photograph not shown) showed a clean sieve without residues on it.

### Conclusions for Polymeric Microparticle Example 16

### Experiment SJH001/035/004

### Polyvinyl Alcohol Example

The preparation of sample SJH001/035/004 (Polymeric Microparticle Example 16) was successful, giving a suspension of solid polymer microparticles as shown in FIG. 14.

Upon mixing with Axial™ 100EC (an EC containing pinoxaden) and Adigor™ (an EC containing methylated rapeseed oil), the sample was checked via optical microscopy after 5 minutes of mixing (FIG. 15) and after 2.5 hours of mixing (FIG. 16). Some flocs of up to 140-200 micrometres (FIG. 15) and of up to 100-120 micrometres (FIG. 16) were observed, but, from the optical microscope photographs, these flocs appeared looser and less dense than the flocs seen in the previous two examples (Polymeric Microparticle Examples 14 and 15). Upon passing this tank mixture containing Polymeric Microparticle Example 16 through a sieve of 150 micrometre aperture size, no residue was collected. This is a good indication that the loose flocs observed easily break apart to allow the mixture to pass through the sieve, for this “tank mixture” containing Polymeric Microparticle Example 16. This demonstrates that blocking of a nozzle filter, upon spraying this “tank mixture” (e.g. onto a field), is unlikely to happen.

It is therefore thought that Polymeric Microparticle Example 16 (which contains the nonionic surfactant polyvinyl alcohol, but none of the anionic surfactants Gantrez™ S-95S or Reax™ 88B) should be suitable for “tank mixing” in water with emulsifiable concentrates of a similar type to those used in Axial 100EC™ and/or Adigor™; and it appears that such “tank mixtures” should be suitable for spraying e.g. onto a field.

### Summary of Tank Mix Compatibility Tests for Polymeric Microparticle (PMP) Examples 14, 15 and 16

The extent of flocculation and, hence, the amount of resulting residue collected on a sieve, upon mixing of the polymeric microparticle (PMP) samples with Axial™ 100EC (which is an emulsifiable concentrate (“EC”) containing 100 g/L of the active ingredient pinoxaden, plus 25 g/L of cloquintocet-mexyl as a safener, plus tetrahydrofurfuryl alcohol and aromatic hydrocarbons as solvents, plus one, two or three surfactants, e.g. available from Syngenta; e.g. similar to the ECs of Example 1 (EC3) and/or Example 4 disclosed on pages 5-6 and 7 of WO 2007/073933 A2 which is incorporated herein by reference) and with Adigor™ (an emulsifiable concentrate containing 47% by weight of the formulation of methylated rapeseed oil as an adjuvant, e.g. available from Syngenta), is worse for samples SJH001/035/002 (PMP Example 14) and SJH001/035/003 (PMP Example 15) where the ionic (anionic) surfactants Gantrez™ S-95S and Reax™ 88B are present, compared to the polyvinyl-alcohol-only sample SJH001/035/004 (PMP Example 16). This is expected to cause significant problems when spraying the PMP Examples 14 and 15 in the above-mentioned (Axial™ and Adigor™) “tank mixtures” through agricultural equipment, since nozzle filter blockages are very likely to occur, whereas for PMP Example 16 (SJH001/035/004) the above-mentioned “tank mixture” (with Axial™ and Adigor™) should be acceptable for spraying through agricultural equipment based on the tests done.

This is shown in the Table below, which shows the amounts of dried residue collected (after tank-mixing with Axial™ and Adigor™, and the residue collected/measured by the wet sieve residue test) for each of the three experiments:

| | Dried residue |
|---|---|
| | collected on |
| Sample | sieve (milligrams) |
| SJH001/035/002 (PMP Example 14), substantial | 4.4 |
| repeat of Sandoz EP 0 517 669 A1 Example 1 | |
| SJH001/035/003 (PMP Example 15), modified | 11.7 |
| version of Sandoz EP 0 517 669 A1 Example 1 | |
| SJH001/035/004 (PMP Example 16), | 0.0 |
| Polyvinyl-alcohol-only example | |

### Polymeric Microparticle Example 17

### Establishing Threshold of Ionic (eg Anionic) Surfactant (e.g. “Reax™ 88B” and “Gantrez™ S-95S”) Regards Creation of Undesirable “Tank Mix Residue” Capable of Causing Sprayability Problems when Tank Mixing Polymeric Microparticles (PMPs) with Axial™ +Adigor™

Further work was done to establish at which level or threshold the ionic (specifically, anionic) dispersants/surfactants “Reax™ 88B” and “Gantrez™ S-95S” are capable of causing the creation of “tank mix residues”, when tank-mixing PMPs with Axial™ (an EC containing pinoxaden)+Adigor™ (an EC containing methylated rapeseed oil), which are potentially capable of causing sprayability problems.

The following systems were monitored:

### A Control as Above was Used:

Polymeric Microparticle Example 16 (experiment SJH001/035/004), in which no ionic surfactant (e.g. “Reax 88B” or “Gantrez S-95S”) was present.

The Experimental Comparisons were as Follows:

In the following systems, polyvinyl-alcohol-only PMP Example 16 (experiment SJH001/035/004) was combined with the appropriate levels of ionic surfactants (as described below) before tank mixing with the necessary Adigor™ and Axial™ 100EC mixture.

PMP Example 17(a): Polymeric Microparticle Example 14 (experiment SJH001/035/002, substantial repeat of Sandoz Example 1)—the full amount of the combined—Reax 88B″ and “Gantrez S-95S” being present, as described in Polymeric Microparticle Example 14 herein.

PMP Example 17(b): A first modification of Polymeric Microparticle Example 14 (experiment SJH001/035/002, substantial repeat of Sandoz Example 1) was prepared in which half the amount (% by weight of the dispersion) of the “Reax 88B” and half the amount (% by weight of the dispersion) of the “Gantrez S-95S” were present compared to Polymeric Microparticle Example 14.

PMP Example 17(c): A second modification of Polymeric Microparticle Example 14 (experiment SJH001/035/002, substantial repeat of Sandoz Example 1) was prepared in which one quarter of the amount (% by weight of the dispersion) of the “Reax 88B” and one quarter of the amount (% by weight of the dispersion) of the “Gantrez S-95S” were present compared to Polymeric Microparticle Example 14.

These formulations were tank-mixed with the necessary Adigor™ and Axial™ 100EC, as previously described herein, in order to prepare the relevant sprayable tank-mix compositions.

### Results and Conclusion:

A combination of visual observation, light microscopy and sieve residue analysis indicate that the threshold, above which flocullation on tank mixing with certain ECs starts to become significant enough to possibly start to cause blockage of spray nozzles (as measured by dry sieve residues), can be extrapolated back to very approximately ⅛ of the full amount (% by weight of the dispersion) of the ionic (here, anionic) surfactants “Reax™ 88B” and “Gantrez™ S-95S” present in Polymeric Microparticle Example 14 (experiment SJH001/035/002, a substantial repeat of Sandoz Example 1). Therefore, the conclusions are:
1/16 of the amount (% by weight of the dispersion) of the ionic (here, anionic) surfactants present in Polymeric Microparticle Example 14, or less, would be highly preferred, to avoid the filter blockage problem with PMP Example 14, since by extrapolation it is expected to give a similar behaviour to the control PMP Example 16, i.e. no residue at all on a suitable sieve. In this highly preferred embodiment, the ratio by weight of the polymeric microparticles to the total ionic (e.g. anionic) surfactants, in the aqueous dispersion, is 1:0.001482 or more, which is 675:1 or more (to 3 significant figures).
⅛ of the amount (% by weight of the dispersion) of the ionic (here, anionic) surfactants present in Polymeric Microparticle Example 14, or less, would be preferred to avoid the filter blockage problem with Sandoz Example 1, since by extrapolation, it is expected to give acceptable spraying behaviour, albeit some minor detectable residue on the filters or on a suitable sieve. In this preferred embodiment, the ratio by weight of the polymeric microparticles to the total ionic (e.g. anionic) surfactants, in the aqueous dispersion, is 1:0.002964 or more, which is 337:1 or more (to 3 significant figures).
One quarter (e.g. PMP Ex. 17(c)), one half (e.g. PMP Ex. 17(b)), or the full amount (e.g. PMP Ex. 17(a)) of the ionic (here, anionic) surfactants present in Polymeric Microparticle Example 14, are less preferred, to avoid the filter blockage problem with PMP Example 14, because significant sieve residues were detected in the experiments of PMP Example 17(a+b+c), compared to the control sample of PMP Example 16. In these three less preferred embodiments, the ratios by weight of the polymeric microparticles to the total ionic (e.g. anionic) surfactants, in the aqueous dispersion, are, respectively: 1:0.005928 (=169:1, to 3 s.f.) for PMP Ex. 17(c); 1:0.01186 (=84.4:1, to 3 s.f.) for PMP Ex. 17(b); and 1:0.02371 (=42.2:1, to 3 s.f.) for PMP Ex. 17(a).

### Polymeric Microparticle Example 18

### Preparation of Triasulfuron Microparticle Sample (Experiment J8694-100-1)

### Introduction

Sample/experiment J8694-100-1 (Polymeric Microparticle Example 18), had a target of ca. 5% triasulfuron by weight of the aqueous dispersion, and had a “moderate triasulfuron:polymer” ratio (=“about 0.2 triasulfuron/about 0.8 other ingredient” weight ratio within each microparticle).

### Method

“Air milled” triasulfuron was used, with particle size in the 1-3 micron range and having a 96.5% purity.

The organic phase was prepared by mixing this “air milled” impure triasulfuron (0.622 grams, providing 0.6002 g=1.494 mmol of actual triasulfuron, whose R.M.M.=401.8) in Viapal VUP 4779/55 resin (1.723 grams) by stirring with a magnetic stirrer, after which initiator azo-bis-isobutyronitrile (AIBN, 0.062 g, 0.378 mmol, where its R.M.M.=164.2) was added and dissolved in the mixture. Finally, 0.627 grams of methyl benzoate was added and stirred into the final organic phase mixture.

For the aqueous phase, first a stock solution of Gohsenol™ GL05 (polyvinyl alcohol) of 15% by weight was prepared (i) by adding 15 grams of Gohsenol™ GL05 to 85 grams of de-ionised water at 60° C. while stirring, and then secondly (ii) stirring was continued for 20 minutes until all the polymer material had dissolved.

The aqueous phase was then prepared by adding 2.707 grams of the 15% by weight Gohsenol™ GL05 stock solution (calculated as containing 0.40605 g of polyvinyl alcohol) and 2 drops of SAG™ 1572 foam control agent to 4.630 grams of deionised (“DI”) water, followed by homogenisation of the aqueous phase (ca. 7.337 g) by hand shaking.

To prepare the microparticles, 2.296 g of the organic phase (which is [2.296 g/3.034 g]=75.68% by weight of the prepared organic phase, calculated as containing ca. 0.4541 g of actual triasulfuron, ca. 0.0469 g of AIBN, 0.4745 g of methyl benzoate, and ca. 1.304 g of Viapal™ resin) was added dropwise to the entire aqueous phase while mixing with a high shear mixer (Ultra-Turrax™ T25) with a “small head” (known as “dispersing element S 25 N-10 G”). Mixing was continued for 5 minutes until the emulsion droplets were smaller than 20 micrometres. The emulsion was then stirred with a magnetic stirrer and heated to 80° C. for 2 hours, to cure (polymerize) the resin and thereby to form an aqueous dispersion of the polymeric microparticles containing the triasulfuron. The total mixed organic+aqueous phases should weigh ca. 2.296+7.337 g=ca. 9.633 g.

The loading percentages for the ingredients for this triasulfuron-PMP sample (Polymeric Microparticle Example 18) were as follows:

| | | % by weight of the |
|---|---|---|
| | | aqueous dispersion (to 2 |
| Sample | Ingredient | d.p.) |
| J8694-100-1 | triasulfuron * | 4.71 * |
| | AIBN | 0.49 |
| | VIAPAL ™ VUP 4779/55 resin | 13.54 |
| | methyl benzoate | 4.93 |
| | Gohsenol ™ GL05 (polyvinyl | 4.22 |
| | alcohol) | |
| | DI water | 71.95 |

* impurities of triasulfuron technical are not included in this calculation

For certain ingredients, for Polymeric Microparticle Example 18, experiment J8763-100-1), the ratios by weight of (a) the stated ingredient to (b) the total non-aqueous phase (total polymeric microparticles), in the aqueous dispersion, were as follows:

| | | Ratio by weight of (a) the |
|---|---|---|
| | | stated ingredient to (b) the |
| | | total non-aqueous phase |
| | | (total polymeric |
| | | microparticles), in the |
| Sample | Ingredient | aqueous dispersion |
| J8694-100-1 | Gohsenol ™ GL05 (polyvinyl | 0.1769:1 ** = |
| | alcohol) | 1:5.65 (to 3 s.f.) |
| | triasulfuron (excluding | 0.1978:1 ** = |
| | impurities) | 1:5.06 (to 3 s.f.) |
| | methyl benzoate | 0.2067:1 ** = |
| | | 1:4.84 ( to 3 s.f.) |

** The total weight of the polymeric microparticles (“PMPs”) is calculated as [total weight of: resin + triasulfuron + triasulfuron impurities + initiator].

### Particle Size Analysis for this Triasulfuron-Containing Polymeric Microparticle Example 18

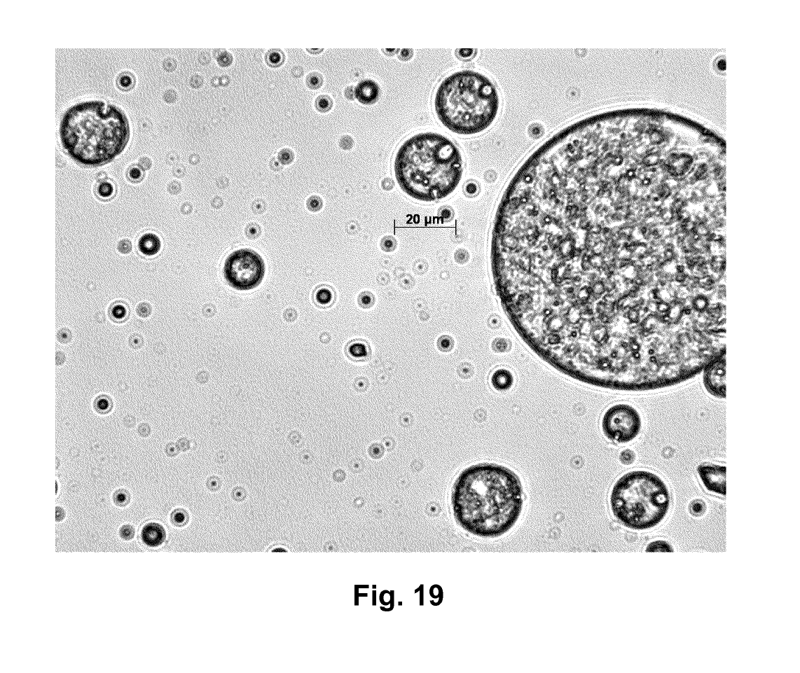

An optical microscope photograph of the triasulfuron-containing polymeric microparticles formed in this Polymeric Microparticle Example 18 is shown in FIG. 19 hereinafter, in which the scale-bar shown is 20 micrometres.

The optical microscope photograph of FIG. 19 shows that the particle size of this sample is mainly in the 5-20 microns range, although there is a single larger sphere up to 80 microns in dimension in the shown image. One can observe trisulfuron crystallites within each of the larger microparticles, which is expected.

### Composition Example 4

### Preparation of Dicamba Acid as a SC100 (Suspension Concentrate) Composition, for Use in Glasshouse Studies of Biological Examples 1 and 2

This preparation of dicamba acid suspension concentrate (100 g/L AE) was achieved by dispersing dicamba acid (87.9% purity technical material) into de-ionised water using Morwet® D425 as the stabilizing agent. Specifically, 0.114 grams of dicamba acid technical was added to 0.0136 grams of Morwet® D425 and 0.9085 grams of de-ionised water followed by bead milling using standard techniques at a small laboratory scale. The material as 100SC was well-behaved during preparation and subsequent storage at ambient temperature. It is further noted that upon dilution for spraying in the glasshouse experiment, the dicamba acid particles (from the 100SC) dissolve fully, which is commensurate with the water solubility of dicamba acid.

Morwet® D425 (available from Akzo Nobel; www.akzonobel.com) is a naphthalene-based dispersant suitable for preparing agrochemical suspension concentrate formulations.

### Reference Composition Example 5

### MCPA Potassium SL050 Composition

MCPA acid (10.5 g, 0.05 mole) was added to 30 ml water with 1.2 molar equivalents of KOH (85%) and stirred until all solid had dissolved, before diluting with water to the desired concentration.

### Reference Composition Example 6

### Sodium Dicamba (BANVEL SGF(E)™) Composition

Banvel® SGF(E) is a commercially available 240 g/L acid equivalent (AE) dicamba formulation presented as a sodium salt.

### Reference Composition Example 7

Banvel® 4S is a commercially available 480 g/L acid equivalent (AE) dicamba formulation presented as a dimethylammonium (DMA) salt.

### Reference Composition Example 9

### Other Compositions

Other chemical materials used or which can be used in glasshouse evaluations are as follows:

Logran® 20WG—supplied as standard commercial product—contains 20% w/w of triasulfuron.
Express® 75WG—supplied as standard commercial product—contains 75% w/w of tribenuron-methyl.
Axial® 100EC—supplied as standard commercial product—contains 100 g/L of pinoxaden.

### Controlled-Release Data for Polymeric Microparticle Examples 1, 2 and 3

Release and release rate data, for release of the first herbicide (here, the synthetic auxin which is dicamba acid) from the polymeric microparticles (“PMPs”) into water, for three of the polymeric microparticles (containing ca. 5.0 to 5.6% dicamba acid by weight of the aqueous dispersion) were generated for experiment/sample numbers J8694-165-1 (for Polymeric Microparticle Example 1), J8694-165-2 (for Polymeric Microparticle Example 2), and J8694-165-3 (for Polymeric Microparticle Example 3). The release and release rate test method/assay used was as follows.

Test Method/Assay Used to Measure the Release and Release Rate, into Water as Receiving Material, of the First Herbicide (e.g. a Synthetic Auxin Herbicide Such as Dicamba) from the Polymeric Microparticle (PMP)

Dilutions of the polymeric microparticle examples/samples (diluted in water to 50 millilitres volume) were prepared, whereby the first herbicide (e.g. a synthetic auxin herbicide such as dicamba) acid equivalent (AE) concentration was 0.5 grams per litre in de-ionised water.
0.5012 grams of sample J8694/165-1 (Polymeric Microparticle Example 1) was added to 49.982 grams of de-ionised water to make a dilution in experiment J8694/179-1
0.4814 grams of J8694/165-2 (Polymeric Microparticle Example 2) was added to 50.066 grams of de-ionised water to make a dilution in experiment J8694/179-2
0.4494 grams of J8694/165-3 (Polymeric Microparticle Example 3) was added to 50.017 grams of de-ionised water to make a dilution in experiment J8694/179-3

The dilutions were continually rolled at room temperature using a Stuart™ Roller Mixer SRT6.

Aliquots (approximately 1.0 ml) were then removed at the following times (in hours): 0.083, 0.5, 1, 3, 7, 24, 48, 72 and 144.

These aliquots were filtered through a 0.45 micron filter (that is, a Whatman nylon syringe filter, Whatman catalogue reference 6870-2504), and then were passed, e.g. to an analytical group, for analysis by high-pressure liquid chromatography (HPLC), for determination of the amount of the first herbicide (e.g. synthetic auxin herbicide such as dicamba) in each aliquot, e.g. as follows. Suitable HPLC instrument conditions include a 4.6 mm×75 mm reverse phase column packed with 3 micron C18 held at 40° C., eluting with a mobile phase initially comprising 70% of 0.1% aqueous formic acid and 30% acetonitrile, and programmed to 90% over 4.5 minutes, followed by an isocratic hold for 2 minutes at a flow rate of 1.0 ml per minute. Using an ultraviolet detector at 254 nanometers, dicamba is detected at 3.6 minutes, using these HPLC conditions.

### Results

The release and release rate data, into water, for Polymeric Microparticle Examples 1, 2 and 3 are given in the table below, and are also shown in graph form in FIG. 3 presented hereinafter, which is a graph of percentage dicamba released versus time (hours).

TABLE
Release and release rate test data, for water as receiving material, showing
percentage release of dicamba acid from the PMP over time (hours),
for Polymeric Microparticle Examples 1, 2 and 3

| | Time (hrs) | | | | | | | | |
|---|---|---|---|---|---|---|---|---|---|
| | 0.083 | 0.5 | 1 | 3 | 7 | 24 | 48 | 72 | 144 |
| PMP Example 1 | 14.7 | 17.6 | 19.5 | 22.7 | 25.3 | 28.7 | 30.9 | 32.2 | 33.9 |
| J8694/179-1 | | | | | | | | | |
| (=J8694/165-1) | | | | | | | | | |
| PMP Example 2 | 30.2 | 34.6 | 36.7 | 40.0 | 42.4 | 44.9 | 46.5 | 46.9 | 47.7 |
| J8694/179-2 | | | | | | | | | |
| (=J8694/165-2) | | | | | | | | | |
| PMP Example 3 | 40.8 | 43.8 | 45.1 | 46.5 | 49.2 | 49.8 | 48.1 | 48.3 | 48.4 |
| J8694/179-3 | | | | | | | | | |
| (=J8694/165-3) | | | | | | | | | |

Based on these release rate data curves shown in the above Table and in FIG. 3, two polymeric microparticles (containing ca. 5.0 to 5.3% dicamba acid by weight of the aqueous dispersion) were selected for the glasshouse antagonism screen with pinoxaden, J8694-165-1 (Polymeric Microparticle Example 1) and J8694-165-2 (Polymeric Microparticle Example 2).

The hypothesis was that the retarded release of dicamba from the microparticles would be beneficial to the objective of reduced antagonism of pinoxaden grass-herbicidal activity.

### Controlled-Release Data for Polymeric Microparticle Example 11

Release and release rate data, for release of the first herbicide (here, the synthetic auxin which is dicamba acid) from the polymeric microparticles (“PMPs”) into water, for Polymeric Microparticle Example 11 (microparticle experiment SJH001/011/002, containing ca. 5.0% dicamba acid by weight of the aqueous dispersion, and containing ca. 30% dicamba acid by weight of the polymeric microparticles, and containing polyvinyl alcohol as a nonionic surfactant/dispersant) were generated.

The release and release rate test method used was substantially the same test method as that disclosed hereinabove for Polymeric Microparticle Examples 1, 2 and 3, except that the sampling time intervals used in this test were: 5 minutes (=0.0833 hours), 30 minutes (0.5 hours), 1 hour, 4 hours, 6 hours, 24 hours, 48 hours, 72 hours, 96 hours, and 168 hours.

### Results

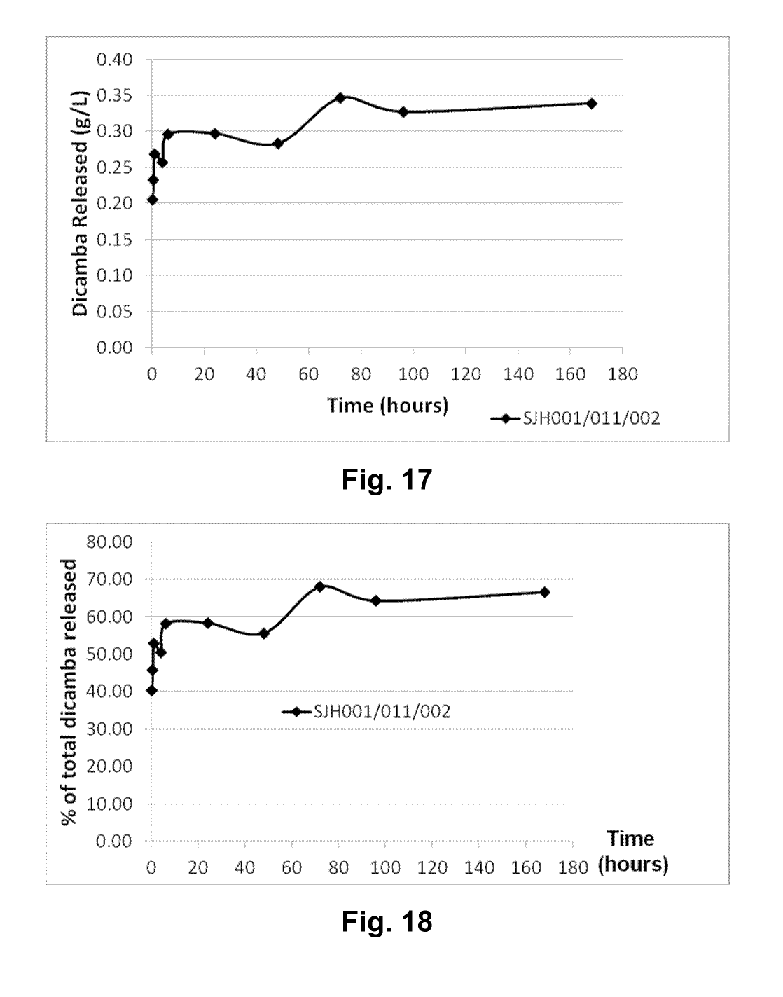

The release and release rate data for Polymeric Microparticle Example 11 are given in the tables below, and are also shown in graph form in FIGS. 17 and 18 presented hereinafter.

TABLE
Release and release rate test data, for water as receiving material,
showing concentration of dicamba acid (in g/L) released from
the PMP over time (hours), for Polymeric Microparticle
Example 11 - this data is also shown in FIG. 17

| Time | Concentration of dicamba released (g/L) - |
|---|---|
| (hours) | experiment SJH001/011/002 |
| 0.0833 | 0.2051 |
| 0.5 | 0.2332 |
| 1 | 0.2691 |
| 4 | 0.2574 |
| 6 | 0.2960 |
| 24 | 0.2970 |
| 48 | 0.2831 |
| 72 | 0.3467 |
| 96 | 0.3274 |
| 168 | 0.3390 |

TABLE
Release and release rate test data, for water as receiving material,
showing percentage of total dicamba acid released from
the PMP over time (hours), for Polymeric Microparticle
Example 11 - this data is also shown in FIG. 18

| | % of dicamba released |
|---|---|
| | (using theoretical 0.5095 g/L dicamba acid |
| Time | concentration for 100% dicamba release) - |
| (hours) | experiment SJH001/011/002 |
| 0.0833 | 40.26 |
| 0.5 | 45.78 |
| 1 | 52.82 |
| 4 | 50.52 |
| 6 | 58.10 |
| 24 | 58.30 |
| 48 | 55.57 |
| 72 | 68.04 |
| 96 | 64.26 |
| 168 | 66.54 |

The release rate data from the above two Tables and from FIGS. 17 and 18 shows an initial moderately-fast (but controlled) release, from the Polymeric Microparticle (PMP) Example 11 into the water, of about 50-53% of the dicamba in the first hour, followed by a slower release into the water of some more dicamba e.g. over 6 and 24 and 72 hours.

The release and release rate data for Polymeric Microparticle Example 11 is thought to make this PMP Example suitable for use in the field, as a controlled-release polymeric microparticle containing dicamba as the first herbicide. See Biological Example no. 3 hereinafter for some summary field trial results for Polymeric Microparticle Example 11.

### Biological Examples

### Method Used in the Glasshouse Studies for Biological Examples 1, 2, 4 and 5, and for Biological Examples 6 to 11

Viable seeds of the target species are sown in individual clumps (10-20 seeds, depending upon species) at a 2 cm depth, into 50 cm×15 cm biodegradable troughs containing a non-sterilised, standard clay loam soil.

In Biological Examples 1 to 11, the following species are used, with different species being used in different examples, but with the grassy monocotyledonous weed species AVEFA, LOLMU, ALOMY and SETVI being used in all of Biological Examples 1 to 11:
TRZAS—Winter Wheat ‘Hereward’—a standard European wheat variety included to verify that the wheat-selectivity of the pinoxaden has not been compromised.
AVEFA—Avena fatua; ‘wild-oat’ in British English
LOLMU—Lolium multiflorum; ‘Italian ryegrass’ in British English
ALOMY—Alopecurus myosuroides; ‘blackgrass’ in British English
SETVI—Setaria viridis; ‘giant foxtail’ in British English
GALAP—Galium aparine; ‘goosegrass’ in British English (a broad-leaved (dicotyledonous) weed species used in the sulfonyl urea assessments only for Examples 4 and 5)
(for Biological Examples 6 to 11): the dicotyledonous weed species SINAR (Sinapsis arvensis), AMARE (Amaranthus retroflexus), and CHEAL (Chenopodium album)

The troughs are watered appropriately and are not supplied with additional nutrients throughout the course of the test. Plants are grown on for approximately 16 days prior to application until they reach a growth stage of 2-3 leaves or early onset of tillering (Zadoks 13-21) to give a standard Post-emergence application timing. Applications are made using a conventional research cabinet sprayer, 8002E flat fan nozzles, 2 bar of pressure and an application volume of 200 l/ha (tap water); two replicates are used.

The graminicides used are standard commercial formulations applied with recommended tank-mix adjuvants. For example, pinoxaden is applied as AXIAL™ EC100, which is an emulsifiable concentrate (“EC”) formulation containing 100 g/L pinoxaden, 25 g/L cloquintocet-mexyl as a safener, tetrahydrofurfuryl alcohol and aromatic hydrocarbons as solvents, plus one, two or three surfactants; e.g. similar to the ECs of Example 1 (EC3) and/or Example 4 disclosed on pages 5-6 and 7 of WO 2007/073933 A2 which is incorporated herein by reference. The pinoxaden EC formulation is tank-mixed with the adjuvant ADIGOR™ (an emulsifiable concentrate containing 47% by weight of the formulation of methylated rapeseed oil as an adjuvant, available from Syngenta) at 0.5% by volume of the spray solution.

Formulations of the test “first herbicide” (synthetic auxin herbicide or ALS inhibitor herbicide) used are applied at fixed, ‘acid equivalent’ (AE) rates that would be appropriate for commercial levels of weed control, irrespective of formulation type. For example, dicamba is applied at 240 g AE/ha, and MCPA and 2,4-D are applied at 500 g AE/ha.

Crop injury is recorded at both 7 and 14-16 days after application; weed efficacy is only recorded at 14-16 days after application. A visual, 0-100% assessment scale is used, where 0%=no visible effects and 100%=complete plant destruction.

### Biological Examples 1+2

### Glasshouse Test

### Pinoxaden+Polymeric Microparticle Examples 1 and 2

A glasshouse evaluation was made to quantify any antagonistic effects on the grass species AVEFA, ALOMY, SETVI and LOLMU.

The following treatments were applied (see table below). In addition, an Adigor™ (adjuvant) spray was applied to each of the weed species.

### Glasshouse Protocol:

| | | | | |
|---|---|---|---|---|
| 1 | dicamba microparticle (1) | 5 wt % | J8694/165-1 | 0.5% v/v |
| | alone | dicamba | (Polymeric Micro- | Adigor |
| | | | particle Example 1) | |
| 2 | Axial ™ 100 EC (pinoxaden) + | 5 wt % | J8694/165-1 | Axial 100 EC |
| | 240 g dicamba/ha | dicamba | (Polymeric Micro- | + 0.5% v/v |
| | dicamba microparticle (1) as tank mix | | particle Example 1) | Adigor |
| 3 | dicamba microparticle (2) | 5 wt % | J8694/165-2 | 0.5% v/v |
| | alone | dicamba | (Polymeric Micro- | Adigor |
| | | | particle Example 2) | |
| 4 | Axial ™ 100 EC (pinoxaden) + | 5 wt % | J8694/165-2 | Axial 100 EC |
| | 240 g dicamba/ha dicamba | dicamba | (Polymeric Micro- | + 0.5% v/v |
| | microparticle (2) as tank mix | | particle Example 2) | Adigor |

### Glasshouse Results

### Biological Example No. 1

### Using Formulation Sample #1, J8694/165/1

### Polymeric Microparticle Example 1

The Table below contains a herbicidal evaluation of dicamba (within microparticles) in combination with pinoxaden to quantify any antagonistic effects e.g. on pinoxaden grass-herbicidal activity.

| | Herbicide a) | | | | | | | |
|---|---|---|---|---|---|---|---|---|
| | AXIAL | AXIAL | AXIAL | AXIAL | AXIAL | AXIAL | AXIAL | AXIAL |
| and | and | and | and | And | and | and | and | and |
| | Herbicide b) | | | | | | | |
| | | Dicamba | | Dicamba | | Dicamba | | Dicamba |
| | | acid | | acid | | acid | | acid |
| | | Micro- | | Micro- | | micro- | | micro- |
| | | particle | | particle | | particle | | particle |
| Rates a)/b) | Dicamba | sample | Dicamba | sample | Dicamba | Sample | Dicamba | Sample |
| g/ha | acid | #1 | acid | #1 | acid | #1 | acid | #1 |
| 5/240 | 0 | 25 | 15 | 43 | 60 | 80 | 30 | 65 |
| 15/240 | 40 | 83 | 70 | 80 | 93 | 99 | 75 | 88 |
| 30/240 | 75 | 93 | 85 | 93 | 100 | 100 | 95 | 97 |
| Weed species | AVEFA | AVEFA | ALOMY | ALOMY | SETVI | SETVI | LOLMU | LOLMU |

| | |
|---|---|
| | Herbicide (a) - |
| Rates of (a) | pinoxaden only |

| in g/ha | AXIAL | AXIAL | AXIAL | AXIAL |
|---|---|---|---|---|
| 5 | 10 | 28 | 78 | 55 |
| 15 | 83 | 73 | 100 | 93 |
| 30 | 93 | 83 | 100 | 98 |
| Weed species | AVEFA | ALOMY | SETVI | LOLMU |

### Regards Antagonism:

In this glasshouse test, there appear to be some reductions in pinoxaden herbicidal activity on the grassy weed species AVEFA and LOLMU, when dicamba acid is used with Axial™ (pinoxaden)+Adigor™ adjuvant, at some application rates. By switching to the dicamba polymer microparticle #1, Polymeric Microparticle Example 1, the antagonism is fully or partly removed in this test.

In terms of crop phytotoxicity, winter wheat “Hereward” was included in the protocol and none of the treatments gave more than 3% damage to this wheat variety, i.e. phytotoxicity on wheat appears not to be a problem regards combining this dicamba microparticle (sample #1) and Axial™.

Furthermore, in terms of controlling GALAP (Galium aparine) dicotyledonous weed species, this dicamba microparticle (sample #1) and Axial together gave ca. 94 to 97% control across the rates attempted, which is good.

This glasshouse data appears very encouraging for the 1st microparticle, Polymeric Microparticle Example 1, sample #1, J8694/165-1, which has the slowest release profile of dicamba as compared to the 2nd microparticle, sample #2, Polymeric Microparticle Example 2.

### Biological Example No. 2

### Using Formulation Sample #2, J8694/165/2

### Polymeric Microparticle Example 2

The Table below contains a herbicidal evaluation of dicamba (within microparticles) in combination with pinoxaden to quantify any antagonistic effects.

| | Herbicide a) | | | | | | | |
|---|---|---|---|---|---|---|---|---|
| | AXIAL | AXIAL | AXIAL | AXIAL | AXIAL | AXIAL | AXIAL | AXIAL |
| and | and | and | and | and | and | and | and | and |
| | Herbicide b) | | | | | | | |
| | | Dicamba | | Dicamba | | Dicamba | | Dicamba |
| | | acid | | acid | | acid | | acid |
| | | Micro- | | Micro- | | micro- | | micro- |
| | | particle | | particle | | particle | | particle |
| Rates a)/b) | Dicamba | sample | Dicamba | sample | Dicamba | Sample | Dicamba | Sample |
| g/ha | acid | #2 | acid | #2 | acid | #2 | acid | #2 |
| 5/240 | 0 | 3 | 15 | 15 | 60 | 73 | 30 | 15 |
| 15/240 | 40 | 73 | 70 | 50 | 93 | 95 | 75 | 83 |
| 30/240 | 75 | 80 | 85 | 83 | 100 | 100 | 95 | 93 |
| Weed species | AVEFA | AVEFA | ALOMY | ALOMY | SETVI | SETVI | LOLMU | LOLMU |

| | |
|---|---|
| Rates of (a) | Herbicide (a) - pinoxaden only |

| in g/ha | AXIAL | AXIAL | AXIAL | AXIAL |
|---|---|---|---|---|
| 5 | 10 | 28 | 78 | 55 |
| 15 | 83 | 73 | 100 | 93 |
| 30 | 93 | 83 | 100 | 98 |
| Weed species | AVEFA | ALOMY | SETVI | LOLMU |

### Regards Antagonism:

This glasshouse test appears to show only a slight benefit by switching from dicamba acid to the dicamba Polymeric Microparticle Example 2, since the antagonism appears not to be removed to a great extent in combination with Axial™/Adigor™. The exception was for the use of 15 g/ha pinoxaden and 240 g/ha dicamba on AVEFA, where antagonism of pionoxaden herbicidal activity vs AVEFA was clearly seen with dicamba acid, and where this antagonism was clearly reduced with the dicamba polymeric microparticle (PMP) of Polymeric Microparticle Example 2. A possible, less-marked, reduction of antagonism is arguably seen for the use of 15 g/ha pinoxaden and 240 g/ha dicamba on LOLMU, for the dicamba-PMP compared to dicamba acid.

In terms of crop phyto-toxicity, winter wheat “Hereward” was included in the protocol and gave between 8% and 13% damage to this wheat variety for these treatments, i.e. wheat phytotoxicity could be a potential problem regards combining this dicamba microparticle (sample #2) and Axial™, possibly related to the presence of plasticiser.

Furthermore, in terms of controlling GALAP dicot weed species, this dicamba microparticle (sample #2) and Axial together also gave ca. 94 to 97% control across the rates attempted, which is acceptable.

This glasshouse data appears not very encouraging for the Polymeric Microparticle Example 2, sample #2 J8694/165-2, which has a faster release profile than Polymeric Microparticle Example 1, sample #1, J8694/165-1. This micro-particle's glasshouse data (sample #2, J8694/165-2) was somewhat similar to “dicamba acid” alone, which might suggest that the plasticiser (methyl benzoate) added therein has increased the release rate of the dicamba pesticide by slightly more than ideal.

Overall, the first microparticle (Polymeric Microparticle Example 1, sample #1) is overall preferred regards the reduction of antagonism of pinoxaden (+Adigor™) grass-weed herbicidal activity.

### Biological Example No. 3

### Field Trials Using Polymeric Microparticle Example 11

### Microparticle Sample SJH001/011/002

Polymeric Microparticle (PMP) Example 11 (microparticle experiment/sample SJH001/011/002, containing 4.98% dicamba acid by weight of the aqueous dispersion, containing 30.01% dicamba acid by weight of the polymeric microparticles, containing 3.96% polyvinyl alcohol by weight of the aqueous dispersion as a nonionic surfactant/dispersant, and having a weight ratio of polymeric microparticles to polyvinyl alcohol of 4.19:1) was used in field trials.

In the field trials, held in Europe in March 2012 (i.e. spring application), Polymeric Microparticle Example 11 was tank mixed with Axial™ 100EC (an EC containing inter alia pinoxaden as herbicide and cloquintocet-mexyl as safener, described in detail elsewhere herein, e.g. available from Syngenta) and Adigor™ (an emulsifiable concentrate containing 47% by weight of the formulation of methylated rapeseed oil as an adjuvant, e.g. available from Syngenta).

As a short summary of these field trials, this tank mixture, containing the dicamba-PMPs of PMP Example 11, showed substantially the same herbicidal efficacy in the field, when applied post-emergence at application rates of 45 g/ha pinoxaden and 150 g/ha dicamba acid, against certain grassy monocotyledonous weeds at growth stages BBCH 21-29 (ca. 97.2% average herbicidal efficacy vs two Lolium and one Apera species), as the herbicidal efficacy achieved by the post-emergence application of Axial™ 100EC (application rate 45 g/ha pinoxaden) and Adigor™ alone (which achieved ca. 97.1% average herbicidal efficacy vs two Lolium and one Apera species). In contrast, the post-emergence application of Axial™ 100EC (45 g/ha pinoxaden) and Adigor™ tank mixed with sodium dicamba (Banvel™, application rate 150 g/ha acid equivalent, in which the sodium dicamba is not present in polymeric microparticles) achieved a numerically lower (ca. 95.0%) average herbicidal efficacy vs two Lolium and one Apera species.

Also, in these field trials, the herbicidal efficacy of PMP Example 11 tank-mixed with Adigor™ was compared to the herbicidal efficacy of sodium dicamba (Banvel™, not a PMP) tank-mixed with Adigor™, when these were applied at 150 g/ha dicamba (acid equivalent) application rates post-emergence to 5 dicotyledonous plant species at various growth stages. The herbicidal efficacy against Chenopodium album was ca. 100% for both PMP Example 11+Adigor™ and sodium dicamba+Adigor™. The herbicidal efficacy against Galeopsis tetrahit was ca. 91% for PMP Example 11+Adigor™ and ca. 82.5% for sodium dicamba+Adigor™. The herbicidal efficacy against Brassica nigra was ca. 66.5% for PMP Example 11+Adigor™ and ca. 62.5% for sodium dicamba+Adigor™. The herbicidal efficacy against Brassica napus subspecies napus was ca. 70% for PMP Example 11+Adigor™ and ca. 82.5% for sodium dicamba+Adigor™. The herbicidal efficacy against Matricaria chamomilla was ca. 79% for PMP Example 11+Adigor™ and ca. 95% for sodium dicamba+Adigor™.

### Biological Example 4

### Glasshouse Test of Pinoxaden+Triasulfuron

A further glasshouse evaluation was made to quantify any antagonistic effects on the grass species AVEFA, LOLMU, SETVI, and/or ALOMY, and/or on GALAP, of the pesticide triasulfuron.

An additional weed to previous examples is used to measure control of a representative broad-leaf: GALAP—Galium aparine; ‘goosegrass’ a broad-leaved (dicotyledonous) weed species

There were no treatments applied to TRZAS—Winter Wheat ‘Hereward’ in this glasshouse screen.

The following treatments were applied as stated in Table 4:

### Columns 1A, 2A, 3A, 4A, 5A, 6A, 7A, 8A, 9A and 10A: see Table 4a and 4b

Axial 100EC (pinoxaden) composition, mixed with triasulfuron as Logran 20WG composition. The latter is 200 g/kg of triasulfuron delivered as a water-dispersible granule.

### Columns 11, 12, 13, 14 and 15:

Axial 100EC (pinoxaden) composition alone (without any triasulfuron applied)—see Table 4c.

### Columns 16, 17, 18, 19 and 20:

Logran 20WG (triasulfuron) composition alone (without any pinoxaden applied)—see Table 4d

Tables 4a to 4d contain an evaluation of a formulation of triasulfuron in combination with Axial (pinoxaden) and ADIGOR™ (as adjuvant) to quantify any antagonistic effects.

Tables 4a and 4b show % WEED CONTROL of three grass species from mixing AXIAL with LOGRAN 20WG (averaged across 2 replicates for 5 weed species)

TABLE 4a

| Column | 1A | 2A | 3A | 4A | 5A |
|---|---|---|---|---|---|
| Herbicide | AXIAL | AXIAL | AXIAL | AXIAL | AXIAL |
| (i) | | | | | |
| pinoxaden | | | | | |
| and | and | and | and | and | and |
| Herbicide | Logran | Logran | Logran | Logran | Logran |
| (ii) | 20 WG | 20 WG | 20 WG | 20 WG | 20 WG |
| Rates (i)/ | | | | | |
| (ii) g/ha | | | | | |
| 15/5 | 20 | 50 | 83 | 78 | 87 |
| 30/5 | 68 | 55 | 94 | 87 | 95 |
| 45/5 | 90 | 60 | 100 | 96 | 97 |
| Weed | AVEFA | ALOMY | SETVI | LOLMU | GALAP |
| species | | | | | |

TABLE 4b

| Column | 6A | 7A | 8A | 9A | 10A |
|---|---|---|---|---|---|
| Herbicide | AXIAL | AXIAL | AXIAL | AXIAL | AXIAL |
| (i) | | | | | |
| pinoxaden | | | | | |
| and | and | and | and | and | And |
| Herbicide | Logran | Logran | Logran | Logran | Logran |
| (ii) | 20 WG | 20 WG | 20 WG | 20 WG | 20 WG |
| Rates (i)/ | | | | | |
| (ii) g/ha | | | | | |
| 15/15 | 15 | 50 | 93 | 73 | 99 |
| 30/15 | 80 | 65 | 95 | 93 | 90 |
| 45/15 | 93 | 73 | 99 | 97 | 92 |
| Weed | AVEFA | ALOMY | SETVI | LOLMU | GALAP |
| species | | | | | |

Key—NP means that “the assessment was not possible at this rate”—the weeds failed to emerge from the soil

TABLE 4c
% WEED CONTROL from AXIAL (pinoxaden) alone (five
weed species averaged across 2replicates)

| Column | 11 | 12 | 13 | 14 | 15 |
|---|---|---|---|---|---|
| Herbicide (i)— | AXIAL | AXIAL | AXIAL | AXIAL | AXIAL |
| pinoxaden | | | | | |
| only | | | | | |
| Rates of | | | | | |
| (i) in g/ha | | | | | |
| 15 | 50 | 23 | 93 | 75 | 0 |
| 30 | 85 | 78 | 100 | 93 | 0 |
| 45 | 93 | 80 | 100 | 99 | 0 |
| Weed | AVEFA | ALOMY | SETVI | LOLMU | GALAP |
| species | | | | | |

TABLE 4d
% WEED CONTROL from LOGRAN20 WG (triasulfuron) alone (five
weed species averaged across 2 replicates)

| Column | 16 | 17 | 18 | 19 | 20 |
|---|---|---|---|---|---|
| Herbicide (ii)— | LOGRAN | LOGRAN | LOGRAN | LOGRAN | LOGRAN |
| triasulfuron | 20 WG | 20 WG | 20 WG | 20 WG | 20 WG |
| only | | | | | |
| Rates of (ii) | | | | | |
| in g/ha | | | | | |
| 5 | 0 | 30 | 0 | 20 | 92 |
| 15 | 0 | 45 | 0 | 38 | 94 |
| Weed species | AVEFA | ALOMY | SETVI | LOLMU | GALAP |

In this Biological Example 4, some mild and occasional antagonism of pinoxaden herbicidal activity in grass species weed control appears to be seen when mixed with the LOGRAN 20WG triasulfuron commercial product, with respect to control of AVEFA at 15 g/ha (and maybe 30 g/ha) pinoxaden and control of ALOMY at 30 and 45 g/ha pinoxaden.

### Biological Example 5

### Glasshouse Test of Pinoxaden+Tribenuron-Methyl

A glasshouse evaluation was also made to quantify any antagonistic effects on the grass species AVEFA, LOLMU, SETVI, ALOMY and GALAP of the pesticide tribenuron-methyl (as Express 75WG) in combination with Axial™ (pinoxaden).

An additional weed to previous examples is used to measure control of a representative broad-leaf: GALAP—Galium aparine; ‘goosegrass’ a broad-leaved (dicotyledonous) weed species

There were no treatments applied to TRZAS—Winter Wheat ‘Hereward’ in this glasshouse screen.

The following treatments were applied as stated in Tables 5a, 5b and 5c:

### Columns 1A, 2A, 3A, 4A and 5A: see Tables 5a and 5b

Axial 100EC with tribenuron-methyl (as Express 75WG)

The latter is 750 g/kg of tribenuron-methyl delivered as a water-dispersible granule

### Columns 1B, 2B, 3B, 4B and 5B: see Tables 5a and 5b

Axial 100EC applied alone

The latter is 100 g/L equivalent of pinoxaden as an emulsifiable concentrate (EC)

### Columns 6, 7, 8, 9 and 10: see Table 5c

Express 75WG alone (without any pinoxaden applied)

### Tables 5a, 5b and 5c

Tables 5a and 5b contain an evaluation of AXIAL applied with EXPRESS 75WG in order to quantify any antagonistic effects.

Tables 5a and 5b show % WEED CONTROL of three grass species from mixing AXIAL with EXPRESS (tribenuron) 75WG formulation as compared to AXIAL alone (averaged across 2 replicates for 5 weed species)

TABLE 5a

| | Column | | | | | |
|---|---|---|---|---|---|---|
| | 1A | 1B | 2A | 2B | 3A | 3B |
| | Herbicide (i) | | | | | |
| | pinoxaden | | | | | |
| | AXIAL | AXIAL | AXIAL | AXIAL | AXIAL | AXIAL |
| | and | and | | and | | and |
| | Herbicide (ii) | | | | | |
| | tribenuron-methyl | | | | | |
| Rates (i)/ | Express | | Express | | Express | |
| (ii) g/ha | 75WG | | 75WG | | 75WG | |
| 15/15 | 33 | 50 | 28 | 23 | 68 | 93 |
| 30/15 | 78 | 85 | 40 | 78 | 83 | 100 |
| 45/15 | 90 | 93 | 33 | 80 | 89 | 100 |
| Weed | AVEFA | AVEFA | ALOMY | ALOMY | SETVI | SETVI |
| species | | | | | | |

TABLE 5b

| Column | 4A | 4B | 5A | 5B |
|---|---|---|---|---|
| Herbicide | AXIAL | AXIAL | AXIAL | AXIAL |
| (i) | | | | |
| pinoxaden | | | | |
| and | and | | and | |
| Herbicide | Express | | Express | |
| (ii) | 75 WG | | 75 WG | |
| tribenuron- | | | | |
| methyl | | | | |
| Rates (i)/ | | | | |
| (ii) g/ha | | | | |
| 15/15 | 88 | 75 | 97 | 0 |
| 30/15 | 89 | 93 | 93 | 0 |
| 45/15 | 90 | 99 | 95 | 0 |
| Weed | LOLMU | LOLMU | GALAP | GALAP |
| species | | | | |

TABLE 5c
% WEED CONTROL from EXPRESS 75 WG alone (data for five
weed species averaged across 2 replicates)

| Column | 6 | 7 | 8 | 9 | 10 |
|---|---|---|---|---|---|
| Herbicide (i)— | EXPRESS | EXPRESS | EXPRESS | EXPRESS | EXPRESS |
| tribenuron- | 75 WG | 75 WG | 75 WG | 75 WG | 75 WG |
| methyl only | | | | | |
| Rate of (i) in | 0 | 25 | 0 | 25 | 95 |
| g/ha | | | | | |
| 15 | | | | | |
| Weed species | AVEFA | ALOMY | SETVI | LOLMU | GALAP |

It can be observed in Table 5a that the percentage weed control for AVEFA and SETVI appears to be reduced at all measured application rates when EXPRESS 75WG (containing tribenuron-methyl as active ingredient) is sprayed together with AXIAL (pinoxaden) as compared to the weed control achieved for AXIAL alone, as shown and to the extent shown in the above tables.

In summary for this glasshouse Biological Example 5, antagonism of pinoxaden herbicidal activity in grass species weed control is demonstrated for AVEFA and SETVI when EXPRESS 75WG (containing tribenuron-methyl as active ingredient) is applied together with AXIAL (containing pinoxaden).

### Biological Example No. 6

### Using Formulation Sample #4, J8763-82-1

### Polymeric Microparticle Example 4)

The Table below contains a herbicidal evaluation of dicamba (within microparticles) in combination with pinoxaden to quantify any antagonistic effects e.g. on pinoxaden grass-herbicidal activity.

| | Herbicide a) | | | | | | | |
|---|---|---|---|---|---|---|---|---|
| | AXIAL | AXIAL | AXIAL | AXIAL | AXIAL | AXIAL | AXIAL | AXIAL |
| and | and | and | and | and | and | and | and | and |
| | Herbicide b) | | | | | | | |
| | | Dicamba | | Dicamba | | Dicamba | | Dicamba |
| | | acid | | acid | | acid | | acid |
| | | Micro- | | Micro- | | micro- | | micro- |
| | | particle | | particle | | particle | Dicamba | particle |
| Rates a)/b) | Dicamba | sample | Dicamba | sample | Dicamba | Sample | | Sample |
| g/ha | acid | #4 | acid | #4 | acid | #4 | acid | #4 |
| 5/240 | 13 | 45 | 13 | 55 | 73 | 75 | 15 | 43 |
| 15/240 | 53 | 70 | 58 | 65 | 93 | 90 | 75 | 80 |
| 30/240 | 73 | 75 | 68 | 75 | 97 | 97 | 80 | 83 |
| Weed species | AVEFA | AVEFA | ALOMY | ALOMY | SETVI | SETVI | LOLMU | LOLMU |

| | |
|---|---|
| | Herbicide (a) - |
| Rates of (a) | pinoxaden only |

| in g/ha | AXIAL | AXIAL | AXIAL | AXIAL |
|---|---|---|---|---|
| 5 | 28 | 33 | 83 | 48 |
| 15 | 88 | 73 | 97 | 85 |
| 30 | 93 | 78 | 98 | 93 |
| Weed species | AVEFA | ALOMY | SETVI | LOLMU |

### Regards Antagonism:

In this glasshouse test, there appear to be some reductions in pinoxaden herbicidal activity on the grassy weed species AVEFA, ALOMY and LOLMU, when dicamba acid is used with Axial™ (pinoxaden)+Adigor™ adjuvant, at some application rates. By switching to the dicamba polymer microparticle sample #4, Polymeric Microparticle Example 4, the antagonism is substantially removed or is reduced.

In terms of crop phyto-toxicity, spring wheat “Teal” was included in the protocol and none of the treatments gave more than 5% damage to this wheat variety, i.e. phytotoxicity on wheat does not appear to be a problem regards combining this dicamba microparticle (sample #4) and Axial™/Adigor™.

Furthermore, in terms of controlling the SINAR (Sinapsis arvensis) dicotyledonous weed species, this dicamba microparticle (sample #4) and Axial together gave ca. 88 to 90% control of SINAR across the application rates attempted, which is acceptable.

This glasshouse data appears very encouraging for this microparticle, Polymeric Microparticle Example 4, sample #4, J8763-82-1.

### Biological Example No. 7

### Using Formulation Sample #5, J8763-130-1

### Polymeric Microparticle Example 5

The Table below contains an herbicidal evaluation of dicamba (within microparticles) in combination with pinoxaden to quantify any antagonistic effects e.g. on pinoxaden grass-herbicidal activity.

| | Herbicide a) | | | | | | | |
|---|---|---|---|---|---|---|---|---|
| | AXIAL | AXIAL | AXIAL | AXIAL | AXIAL | AXIAL | AXIAL | AXIAL |
| and | and | and | and | and | and | and | and | and |
| | Herbicide b) | | | | | | | |
| | | Dicamba | | Dicamba | | Dicamba | | Dicamba |
| | | acid | | acid | | acid | | acid |
| | | Micro- | | Micro- | | micro- | | micro- |
| | | particle | | particle | | particle | | particle |
| Rates a)/b) | Dicamba | sample | Dicamba | sample | Dicamba | Sample | Dicamba | Sample |
| g/ha | acid | #5 | acid | #5 | acid | #5 | acid | #5 |
| 5/240 | 13 | 55 | 13 | 53 | 73 | 75 | 15 | 60 |
| 15/240 | 53 | 73 | 58 | 75 | 93 | 98 | 75 | 73 |
| 30/240 | 73 | 83 | 68 | 79 | 97 | 98 | 80 | 83 |
| Weed species | AVEFA | AVEFA | ALOMY | ALOMY | SETVI | SETVI | LOLMU | LOLMU |

| | |
|---|---|
| | Herbicide (a) - |
| Rates of (a) | pinoxaden only |

| in g/ha | AXIAL | AXIAL | AXIAL | AXIAL |
|---|---|---|---|---|
| 5 | 28 | 33 | 83 | 48 |
| 15 | 88 | 73 | 97 | 85 |
| 30 | 93 | 78 | 98 | 93 |
| Weed species | AVEFA | ALOMY | SETVI | LOLMU |

### Regards Antagonism:

In this glasshouse test, there appear to be some reductions in pinoxaden herbicidal activity on the grassy weed species AVEFA, ALOMY and LOLMU, when dicamba acid is used with Axial™ (pinoxaden)+Adigor™ adjuvant, at some application rates. By switching to the dicamba polymer microparticle sample #5, Polymeric Microparticle Example 5, the antagonism is substantially removed or is reduced.

In terms of crop phytotoxicity, spring wheat “Teal” was included in the protocol and none of the treatments gave more than 5% damage to this wheat variety, i.e. phytotoxicity on wheat does not appear to be a problem regards combining this dicamba microparticle (sample #5) and Axial™/Adigor™.

Furthermore, in terms of controlling the SINAR (Sinapsis arvensis) dicotyledonous weed species, this dicamba microparticle (sample #5) and Axial™ together gave ca. 88% control of SINAR across the application rates attempted, which is acceptable.

This glasshouse data appears very encouraging for this microparticle, Polymeric Microparticle Example 5, sample #5, J8763-130-1.

### Biological Example No. 8

### Using Formulation Sample #6, J8763-87-1

### Polymeric Microparticle Example 6

The Table below contains an herbicidal evaluation of dicamba (within microparticles) in combination with pinoxaden to quantify any antagonistic effects e.g. on pinoxaden grass-herbicidal activity.

| | Herbicide a) | | | | | | | |
|---|---|---|---|---|---|---|---|---|
| | AXIAL | AXIAL | AXIAL | AXIAL | AXIAL | AXIAL | AXIAL | AXIAL |
| and | and | and | and | and | and | and | and | and |
| | Herbicide b) | | | | | | | |
| | | Dicamba | | Dicamba | | Dicamba | | Dicamba |
| | | acid | | acid | | acid | | acid |
| | | Micro- | | Micro- | | micro- | | micro- |
| | | particle | | particle | | particle | | particle |
| Rates a)/b) | Dicamba | sample | Dicamba | sample | Dicamba | Sample | Dicamba | Sample |
| g/ha | acid | #6 | acid | #6 | acid | #6 | acid | #6 |
| 5/240 | 13 | 33 | 13 | 38 | 73 | 73 | 15 | 55 |
| 15/240 | 53 | 75 | 58 | 63 | 93 | 93 | 75 | 78 |
| 30/240 | 73 | 85 | 68 | 73 | 97 | 99 | 80 | 85 |
| Weed species | AVEFA | AVEFA | ALOMY | ALOMY | SETVI | SETVI | LOLMU | LOLMU |

| | |
|---|---|
| | Herbicide (a) - |
| Rates of (a) | pinoxaden only |

| in g/ha | AXIAL | AXIAL | AXIAL | AXIAL |
|---|---|---|---|---|
| 5 | 28 | 33 | 83 | 48 |
| 15 | 88 | 73 | 97 | 85 |
| 30 | 93 | 78 | 98 | 93 |
| Weed species | AVEFA | ALOMY | SETVI | LOLMU |

### Regards Antagonism:

In this glasshouse test, there appear to be some reductions in pinoxaden herbicidal activity on the grassy weed species AVEFA, ALOMY and LOLMU, when dicamba acid is used with Axial™ (pinoxaden)+Adigor™ adjuvant, at some application rates. By switching to the dicamba polymer microparticle sample #6, Polymeric Microparticle Example 6, the antagonism is substantially removed or is reduced.

In terms of crop phytotoxicity, spring wheat “Teal” was included in the protocol and none of the treatments gave more than 10% damage to this wheat variety, i.e. phytotoxicity on wheat does not appear to be a problem regards combining this dicamba microparticle (sample #6) and Axial™/Adigor™.

Furthermore, in terms of controlling the SINAR (Sinapsis arvensis) dicotyledonous weed species, this dicamba microparticle (sample #6) and Axial™ together gave ca. 88 to 90% control of SINAR across the application rates attempted, which is acceptable.

This glasshouse data appears very encouraging for this microparticle, Polymeric Microparticle Example 6, sample #6, J8763-87-1.

### Biological Example No. 9

### Using Formulation Sample #7, J8763-126-1

### Polymeric Micro-Particle Example 7)

The Table below contains an herbicidal evaluation of dicamba (within microparticles) in combination with pinoxaden to quantify any antagonistic effects e.g. on pinoxaden grass-herbicidal activity.

| | Herbicide a) | | | | | | | |
|---|---|---|---|---|---|---|---|---|
| | AXIAL | AXIAL | AXIAL | AXIAL | AXIAL | AXIAL | AXIAL | AXIAL |
| and | and | and | and | and | and | and | and | and |
| | Herbicide b) | | | | | | | |
| | | Dicamba | | Dicamba | | Dicamba | | Dicamba |
| | | acid | | acid | | acid | | acid |
| | | Micro- | | Micro- | | micro- | | micro- |
| | | particle | | particle | | particle | | particle |
| Rates a)/b) | Dicamba | sample | Dicamba | sample | Dicamba | Sample | Dicamba | Sample |
| g/ha | acid | #7 | acid | #7 | acid | #7 | acid | #7 |
| 5/240 | 13 | 43 | 13 | 23 | 73 | 73 | 15 | 43 |
| 15/240 | 53 | 78 | 58 | 70 | 93 | 90 | 75 | 75 |
| 30/240 | 73 | 93 | 68 | 75 | 97 | 97 | 80 | 85 |
| Weed species | AVEFA | AVEFA | ALOMY | ALOMY | SETVI | SETVI | LOLMU | LOLMU |

| | |
|---|---|
| | Herbicide (a) - |
| Rates of (a) | pinoxaden only |

| in g/ha | AXIAL | AXIAL | AXIAL | AXIAL |
|---|---|---|---|---|
| 5 | 28 | 33 | 83 | 48 |
| 15 | 88 | 73 | 97 | 85 |
| 30 | 93 | 78 | 98 | 93 |
| Weed species | AVEFA | ALOMY | SETVI | LOLMU |

### Regards Antagonism:

In this glasshouse test, there appear to be some reductions in pinoxaden herbicidal activity on the grassy weed species AVEFA, ALOMY and LOLMU, when dicamba acid is used with Axial™ (pinoxaden)+Adigor™ adjuvant, at some application rates. By switching to the dicamba polymer microparticle #7, Polymeric Microparticle Example 7, the antagonism is substantially removed or is reduced.

In terms of crop phytotoxicity, spring wheat “Teal” was included in the protocol and none of the treatments gave more than 8% damage to this wheat variety, i.e. phytotoxicity on wheat does not appear to be a problem regards combining this dicamba microparticle (sample #7) and Axial™/Adigor™.

Furthermore, in terms of controlling the SINAR (Sinapsis arvensis) dicotyledonous weed species, this dicamba microparticle (sample #7) and Axial™ together gave ca. 83% control of SINAR across the application rates attempted, which appears to be acceptable.

This glasshouse data appears very encouraging for this microparticle, Polymeric Microparticle Example 7, sample #7, J8763-126-1.

### Biological Example No. 10

### Using Formulation Sample #8, J8763-90-2

### Polymeric Microparticle Example 8

The Table below contains an herbicidal evaluation of MCPA (within the microparticles) in combination with pinoxaden to quantify any antagonistic effects e.g. on pinoxaden grass-herbicidal activity.

| | Herbicide a) | | | | | | | |
|---|---|---|---|---|---|---|---|---|
| | AXIAL | AXIAL | AXIAL | AXIAL | AXIAL | AXIAL | AXIAL | AXIAL |
| and | and | and | and | and | and | and | and | and |
| | Herbicide b) | | | | | | | |
| | | MCPA | | MCPA | | MCPA | | MCPA |
| | | acid | | acid | | acid | | acid |
| | | Micro- | | Micro- | | micro- | | micro- |
| | | particle | | particle | | particle | | particle |
| Rates a)/b) | MCPA | sample | MCPA | sample | MCPA | Sample | MCPA | Sample |
| g/ha | acid | #8 | acid | #8 | acid | #8 | acid | #8 |
| 5/500 | 33 | 70 | 48 | 53 | 78 | 78 | 45 | 70 |
| 15/500 | 78 | 85 | 63 | 73 | 98 | 95 | 78 | 85 |
| 30/500 | 85 | 90 | 73 | 73 | 98 | 99 | 88 | 88 |
| Weed species | AVEFA | AVEFA | ALOMY | ALOMY | SETVI | SETVI | LOLMU | LOLMU |

| | |
|---|---|
| | Herbicide (a) - |
| Rates of (a) | pinoxaden only |

| in g/ha | AXIAL | AXIAL | AXIAL | AXIAL |
|---|---|---|---|---|
| 5 | 28 | 33 | 83 | 48 |
| 15 | 88 | 73 | 97 | 85 |
| 30 | 93 | 78 | 98 | 93 |
| Weed species | AVEFA | ALOMY | SETVI | LOLMU |

### Regards Antagonism:

In this glasshouse test, there appear to be some reductions in pinoxaden herbicidal activity on the grassy weed species AVEFA, ALOMY and LOLMU, when MCPA acid is used with Axial™ (pinoxaden)+Adigor™ adjuvant, at some application rates. By switching to the MCPA-based polymer microparticle #8, Polymeric Microparticle

Example 8, the antagonism is substantially removed or is reduced (excluding the 5 g/ha pinoxaden application rate in this example where the pinoxaden herbicidal activity was not reduced when mixed with 500 g/ha of normal (non-microparticle) MCPA).

In terms of crop phytotoxicity, spring wheat “Teal” was included in the protocol and none of the treatments gave more than 3% damage to this wheat variety, i.e. phytotoxicity on wheat appears not to be a problem regards combining this dicamba microparticle (sample #8) and Axial™/Adigor™.

Furthermore, in terms of controlling the SINAR (Sinapsis arvensis) dicotyledonous weed species, this dicamba microparticle (sample #8) and Axial™ together gave ca. 80 to 83% control of SINAR across the application rates attempted, which appears to be acceptable.

This glasshouse data appears encouraging for this microparticle, Polymeric Microparticle Example 8, sample #8, J8763-90-2.

### Biological Example No. 11

### Using Formulation Sample #9, J8763-90-1

### Polymeric Microparticle Example 9

The Table below contains an herbicidal evaluation of 2,4-D (within the microparticles) in combination with pinoxaden to quantify any antagonistic effects e.g. on pinoxaden grass-herbicidal activity.

| | Herbicide a) | | | | | | | |
|---|---|---|---|---|---|---|---|---|
| | AXIAL | AXIAL | AXIAL | AXIAL | AXIAL | AXIAL | AXIAL | AXIAL |
| and | and | and | and | and | and | and | and | and |
| | Herbicide b) | | | | | | | |
| | | 2,4-D | | 2,4-D | | 2,4-D | | 2,4-D |
| | | acid | | acid | | acid | | acid |
| | | Micro- | | Micro- | | micro- | | micro- |
| | | particle | | particle | | particle | | particle |
| Rates a)/b) | 2,4-D | sample | 2,4-D | sample | 2,4-D | Sample | 2,4-D | Sample |
| g/ha | acid | #9 | acid | #9 | acid | #9 | acid | #9 |
| 5/500 | 28 | 55 | 35 | 50 | 70 | 78 | 18 | 60 |
| 15/500 | 70 | 78 | 63 | 73 | 80 | 90 | 73 | 80 |
| 30/500 | 80 | 90 | 68 | 78 | 97 | 95 | 83 | 85 |
| Weed species | AVEFA | AVEFA | ALOMY | ALOMY | SETVI | SETVI | LOLMU | LOLMU |

| | |
|---|---|
| | Herbicide (a) - |
| Rates of (a) | pinoxaden only |

| in g/ha | AXIAL | AXIAL | AXIAL | AXIAL |
|---|---|---|---|---|
| 5 | 28 | 33 | 83 | 48 |
| 15 | 88 | 73 | 97 | 85 |
| 30 | 93 | 78 | 98 | 93 |
| Weed species | AVEFA | ALOMY | SETVI | LOLMU |

### Regards Antagonism:

In this glasshouse test, there appear to be some reductions in pinoxaden herbicidal activity on the grassy weed species AVEFA, ALOMY, SETVI and LOLMU, when 2,4-D acid is used with Axial™ (pinoxaden)+Adigor™ adjuvant, at some application rates. By switching to the 2,4-D-based polymer microparticle #9, Polymeric Microparticle Example 9, the antagonism is substantially removed or is reduced.

In terms of crop phytotoxicity, spring wheat “Teal” was included in the protocol and none of the treatments gave more than 8% damage to this wheat variety, i.e. phytotoxicity on wheat appears not to be a problem regards combining this dicamba microparticle (sample #9) and Axial™/Adigor™.

Furthermore, in terms of controlling the SINAR (Sinapsis arvensis) dicotyledonous weed species, this dicamba microparticle (sample #9) and Axial™ together gave ca. 83 to 85% control of SINAR across the application rates attempted, which appears to be acceptable.

This glasshouse data appears encouraging for this microparticle, Polymeric Micro-particle Example 9, sample #9, J8763-90-1.

### Assays

### Assay 1—Synthetic Auxin Herbicide Assay

In a preferred embodiment of the invention, the definition of and/or an assay or test for a synthetic auxin herbicide is as follows.

A synthetic auxin herbicide can be defined as a compound that is a herbicide and that, either itself or after the removal of any procide groups present thereon, stimulates the expression of B-glucuronidase (GUS) in transgenic Arabidopsis plantlets line AtEM101 (as disclosed in Lindsey and Topping, The Plant Cell, 1997, vol. 9, pp. 1713-1725). For the test, seeds of AtEM101 are germinated aseptically on half-strength Murashige and Skoog medium containing a test compound at a range of doses between 0 and 200 uM and assayed for GUS activity at 6 days post-germination. For quantitative GUS assays, protein crude extracts of the plantlets are prepared and a fluorometric assay is used as described by Jefferson et al. EMBO J., 1987, vol. 6, pp. 3901-3907. Alternatively, whole plantlets are transferred to 100 mM sodium phosphate buffer at pH 7.0 containing 10 mM EDTA, 0.1% Triton X-100, 1 mM potassium ferricyanide, 1 mM potassium ferrocyanide and 1 mM 5-bromo-4-chloro-3-indolyl β-D-glucuronic acid (X-gluc) and incubated for 12 h at 37° C. Stained plantlets are then removed and cleared of chlorophyll by soaking in 70% (v/v) ethanol. The amount of overall blue staining is then assessed and compared visually. A synthetic auxin is defined in this assay/test as a test compound which exhibits a dose response of blue staining or GUS activity dependent on the concentration of test compound present during the germination and growth of the AtEM101 Arabidopsis plantlet, and can for example be as depicted in FIG. 4A of Lindsey and Topping, The Plant Cell, 1997, vol. 9, pp. 1713-1725 and in respect of napthylacetic acid. A synthetic auxin is further defined in this assay/test as a compound that, when assayed/tested under the above conditions, and at a concentration of 50 μM (50 micromolar) results in at least about a doubling of GUS activity or of the amount of blue staining relative to the amount of GUS activity or blue staining obtained with like AtEM101 plantlets like-grown in the absence of the test compound.

### Assay 2—Acetolactate Synthase (ALS) Inhibition Assay

In a preferred embodiment of the invention, the definition of and/or an assay or test for an ALS inhibitor herbicide is as follows.

An ALS inhibitor herbicide can be defined as a compound that is a herbicide and that, either itself or after the removal of any procide groups present thereon, inhibits acetolactate synthase according to the following method. ALS enzyme is prepared as described in the Legend to table 1. on page 119 of T. Hawkes et al., in ‘Herbicides and Plant Metabolism’: ed. A. D. Dodge, Society for Experimental Biology Seminar Series 38, Cambridge University Press, United Kingdom, 1989, pp. 113-136. ALS inhibitor herbicides is defined, in this assay/test, as a compound that, when assayed/tested at a range of doses between 0 and 200 μM, and according to the method described in the legend of FIG. 3 on page 124 of T. Hawkes et al. (from ‘Herbicides and Plant Metabolism’: ed. A. D. Dodge, Society for Experimental Biology Seminar Series 38, Cambridge University Press, United Kingdom, 1989, pp. 113-136), inhibits, at a concentration less than 100 μM, the specific activity of ALS by more than 90% relative to like controls run absent of the test compound, and where the comparative rate measurements are made at or after a reaction time of at least 200 minutes.

### Assay 3—Glasshouse Assay for Pinoxaden Antagonism

A suitable glasshouse assay/test, to determine whether or not the “first herbicide”, when in a salt-free form and when not contained within polymeric microparticles, antagonises the herbicidal activity of pinoxaden, is as follows.

Viable seeds of the target species are sown in individual clumps (10-20 seeds, depending upon species) at a 2 cm depth, into 50 cm×15 cm biodegradable troughs containing a non-sterilised, standard clay loam soil.

The following species are used:
AVEFA—Avena fatua; ‘wild-oat’ in British English
LOLMU—Lolium multiflorum; ‘Italian ryegrass’ in British English
ALOMY—Alopecurus myosuroides; ‘blackgrass’ in British English
SETVI—Setaria viridis; ‘giant foxtail’ in British English
(Optional): TRZAS—Winter Wheat ‘Hereward’—a standard European wheat variety, optionally included to verify that the wheat-selectivity of the pinoxaden has not been compromised.

The troughs are watered appropriately and are not supplied with additional nutrients throughout the course of the test. Plants are grown on for approximately 16 days prior to application until they reach a growth stage of 2-3 leaves or early onset of tillering (Zadoks 13-21) to give the standard post-emergence application timing. Applications are made using a (e.g. conventional) research cabinet sprayer (e.g.: 8002E flat fan nozzles, 2 bar of pressure) and an application volume of 200 L/ha (tap water); usually, two replicates are used. The pinoxaden is typically used in a commercial formulation applied with recommended tank-mix adjuvants. Preferably, pinoxaden is applied as AXIAL™ EC100, a formulation containing 100 g/L pinoxaden and 25 g/L cloquintocet-mexyl safener; it is tank mixed with the adjuvant ADIGOR™ (containing methylated rapeseed oil, available from Syngenta) at 0.5% by volume of the spray solution.

Crop injury (e.g. to wheat) is recorded at both 7 and 14-16 days after application; weed efficacy is only recorded at 14-16 days after application. A visual, 0-100% assessment scale is used, where 0%=no visible effects and 100%=complete plant destruction.

### Application Rates to be Used in the Glasshouse Pinoxaden Antagonism Assay

Formulations used for the other herbicide (the “first herbicide”), which is being tested for whether or not it antagonises the herbicidal activity of pinoxaden, are applied at fixed, ‘acid equivalent’ (AE) application rates suitable for commercial in-field levels of weed control, irrespective of formulation type; most preferably using application rates suitable for use on cereal crops (preferably non-oat cereal crops, e.g. wheat and/or barley). For example, dicamba can be applied at ca. 240 g/ha (or alternatively at from 100 to 140, e.g. ca. 120, g/ha), measured as the free acid; MCPA and/or 2,4-D can be applied at ca. 500 g/ha, measured as the free acid.

For a “first herbicide” active ingredient being assayed/tested, application rates should be X or 2X where X=recommended field application rate as disclosed for that herbicide in “The Pesticide Manual”, 15^{th} Edition, 2009, British Crop Production Council, UK, or future editions thereof. Alternatively, application rates may be identified from journal, book and/or patent publications for the specific active ingredient under test. Where no such published information is available, a dose response designed to cover the full range of activities predicted for that herbicide class should be applied; typically for ALS inhibitor (e.g. sulfonyl urea) class herbicides: 5, 25, 150 g active ingredient/ha; e.g. for other classes (e.g. synthetic auxins): 10, 50, 250, 1250 g active ingredient/ha, all measured as the free compound (acid equivalent).

All application rates for the “first herbicide” should be applied in all combinations with each of the tested pinoxaden application rates, which are typically: 5, 10, 20 and 40 g pinoxaden/ha (which e.g. were the rates used with dicamba and MCPA in Biological Examples 1 and 2); or 15, 30 and 45 g pinoxaden/ha (which e.g. were the rates used with triasulfuron in Biological Example 3).

Where the potentially-antagonizing “first herbicide” also exhibits graminicide (grass-weed-herbicidal) activity (e.g. iodosulfuron-methyl or mesosulfuron-methyl), a dose response of the potentially-antagonizing “first herbicide” should be applied as a solo application, as well as all application rate combinations of pinoxaden plus the potentially-antagonizing “first herbicide”.

Antagonism of pinoxaden may then be determined by the application of Colby's formula:

(Observed 1+Observed 2)−((Observed 1×Observed 2)/100),

to calculate the expected weed control values for mixtures; where Observed 1 is the weed efficacy value recorded for the pinoxaden alone and Observed 2 is the weed efficacy value recorded for the potentially-antagonizing “first herbicide” alone at a given application rate. Where observed values are smaller than the calculated expected value, antagonism is deemed to have occurred.
Assay 4—Glasshouse Assay for Measuring the Selectivity on, i.e. Suitability for Use on, Non-Oat Cereals (e.g. Wheat and/or Barley) of the First Herbicide

A suitable glasshouse assay/test, to determine/measure whether or not the “first herbicide”, contained within the polymeric microparticles, is selective on (i.e. suitable for use on) non-oat cereals such as wheat, barley, rye and/or triticale, is as follows.

Viable seeds of the target species are sown in individual clumps (10-20 seeds, depending upon species) at a 2 cm depth, into 50 cm×15 cm biodegradable troughs (or pots of equivalent depth) containing a non-sterilised, standard clay loam soil.

One of the following species are used, to test the selectivity on (suitability for) one crop:
TRZAS (Wheat)—Winter Wheat ‘Hereward’—a standard European wheat variety;
(Optional): A typical European or North American variety of winter or spring barley;
(Optional): A typical European or North American variety of rye;
(Optional): A typical European or North American variety of triticale.

The troughs (or pots) are watered appropriately and are not supplied with additional nutrients throughout the course of the test. Plants are grown on for approximately 16 days prior to application until they reach a growth stage of 2-3 leaves or early onset of tillering (Zadoks 13-21) to give the standard post-emergence application timing. Applications of the first herbicide (contained within the polymeric microparticles) are made using a (e.g. conventional) research cabinet sprayer (e.g.: 8002E flat fan nozzles, 2 bar of pressure) and an application volume of 200 L/ha (tap water); usually, two replicates are used.

Non-oat cereal crop injury (e.g. to wheat) is recorded at both 7 days and 14-16 days after application. A visual, 0-100% assessment scale is used, where 0%=no visible effects and 100%=complete plant destruction.

Formulations used for the “first herbicide” are applied at fixed, ‘acid equivalent’ (AE) application rates (i.e. rates measured as the free compound) which are suitable for commercial in-field levels of weed control, irrespective of formulation type; most preferably using application rates suitable for use on non-oat cereal crops such as wheat, barley, rye and/or triticale. For example, dicamba can be applied at ca. 240 g/ha measured as the free acid (or alternatively at from 100 to 140 g/ha, e.g. ca. 120 g/ha, measured as the free acid); MCPA and/or 2,4-D can be applied at ca. 500 g/ha measured as the free acid; triasulfuron can be applied at from 5 to 15 g/ha measured as the free acid, and pyroxsulam can be applied at from 9 to 18.75 g/ha measured as the free acid.

For a “first herbicide” active ingredient being assayed/tested, application rates should be X or 2X where X=recommended field application rate as disclosed for that herbicide in “The Pesticide Manual”, 15^{th} Edition, 2009, British Crop Production Council, UK, or future editions thereof. Alternatively, application rates may be identified from journal, book and/or patent publications for the specific active ingredient under test. Where no such published information is available, a dose response designed to cover a reasonable range of activities predicted for that herbicide class should be applied (but, in this Assay 4, without using very high application rates); therefore, for ALS inhibitor (e.g. sulfonyl urea) class herbicides: 5, 15, 40 g active ingredient/ha, measured as the free compound/free acid; e.g. for other classes (e.g. for synthetic auxin herbicides): 20, 100, 300 g active ingredient/ha, all measured as the free compound/free acid (acid equivalent).

The glasshouse tests are preferably also done in the absence, and in the presence, of a safener suitable for use with non-oat cereals such as wheat, preferably using a weight ratio of the first herbicide (measured as the free acid) to the safener of 20:1 to 1:1, e.g. 10:1 to 2:1. If used, the suitable safener to be used in the test is cloquintocet-mexyl or mefenpyr-diethyl.

The first herbicide, contained within the polymeric microparticles, is determined in this Assay 4 to be selective for (i.e. suitable for use on) the non-oat cereal tested (e.g. wheat) if either or both of criteria (a) or (b) are fulfilled:

Criterion (a): The above-mentioned glasshouse assay(s)/test(s) show a level of damage (phytotoxicity) to the crop tested (e.g. wheat) of 30% or less (preferably 20% or less) as measured by visual assessment at 14-16 days after application of the first herbicide, in the absence of a safener suitable for use with non-oat cereals, and at all application rates of the first herbicide which have been tested in the present assay (see above criteria for which application rates to be tested).
Criterion (b): The above-mentioned glasshouse assay(s)/test(s) show a level of damage (phytotoxicity) to the crop tested (e.g. wheat) of 30% or less (preferably 20% or less) as measured by visual assessment at 14-16 days after application of the first herbicide, in the presence of a safener being cloquintocet-mexyl or mefenpyr-diethyl, and using a weight ratio of the first herbicide (measured as the free acid) to the safener of 20:1 to 1:1 or preferably 10:1 to 2:1, and at all application rates of the first herbicide which have been tested in the present assay (see above criteria for which application rates to be tested).

1. A herbicidal composition, comprising a mixture of:
(a) polymeric microparticles containing a first herbicide, wherein the first herbicide is a synthetic auxin herbicide or an acetolactate synthase (ALS) inhibitor herbicide;
wherein the first herbicide, when in a salt-free form and when not contained within polymeric microparticles, antagonises the herbicidal activity of pinoxaden;
and (x) a nonionic surfactant;
wherein the herbicidal composition is a dispersion composition in which the polymeric microparticles are dispersed in a continuous liquid phase or medium,
and wherein the nonionic surfactant is present in the continuous liquid phase or medium, such that the nonionic surfactant stabilizes the dispersion of the polymeric microparticles in the continuous liquid phase or medium,
and wherein the weight ratio of the polymeric microparticles to the nonionic surfactant in the herbicidal composition is from 40:1 to 1:2;
and wherein either the composition comprises no ionic surfactant, or the composition comprises an ionic surfactant and the weight ratio of the polymeric microparticles to the ionic surfactant in the herbicidal composition is 200:1 or more;
and wherein the polymeric microparticles are controlled-release matrices, within which is the first herbicide, and which function in such a way as to control and/or slow down the release of the first herbicide from the polymeric microparticles into a liquid medium when the polymeric microparticles are placed in and in contact with the liquid medium.

2. A herbicidal composition as claimed in claim 1, wherein the nonionic surfactant is present in from 0.2 to 30% by weight of the dispersion composition.

3. (canceled)

4. (canceled)

5. A herbicidal composition as claimed in claim 1, wherein the nonionic surfactant comprises at least one of
polyvinyl alcohol;
a polyglycol ether derivative of an aliphatic or cycloaliphatic alcohol or of a saturated or unsaturated fatty acid or of an alkyl phenol which contains 3 to 30 glycol ether groups and 8 to 20 carbon atoms in a (cyclo)aliphatic hydrocarbon radical or 6 to 18 carbon atoms in an alkyl moiety of an alkyl phenol;
a water-soluble polyethylene oxide adduct with polypropylene glycol, ethylenediaminopolypropylene glycol or alkyl polypropylene glycol, having 1 to 10 carbon atoms in any alkyl chain, and having 20 to 250 ethylene glycol ether groups and 10 to 100 propylene glycol ether groups;
polyethylene glycol; and
a fatty acid ester of polyoxyethylene sorbitan.

6. A herbicidal composition as claimed in claim 1, wherein the weight ratio of the polymeric microparticles to the nonionic surfactant in the herbicidal composition is from 20:1 to 1:1.

7. (canceled)

8. (canceled)

9. (canceled)

10. A herbicidal composition as claimed in claim 1, wherein either the composition comprises no ionic surfactant, or the composition comprises an ionic surfactant in which the weight ratio of the polymeric microparticles to the ionic surfactant in the herbicidal composition is 670:1 or more.

11. A herbicidal composition as claimed in claim 1, wherein the herbicidal composition is an aqueous dispersion composition in which the polymeric microparticles are dispersed in a continuous aqueous liquid phase or medium.

12. (canceled)

13. A herbicidal composition as claimed in claim 1, wherein the polymeric microparticles containing the first herbicide are controlled-release matrices within which is the first herbicide, characterized by:
an amount of the first herbicide released, over a specified time period which is the first 1 hour of contact or the first 3 hours of contact, from the polymeric microparticles into a liquid medium after the polymeric microparticles are placed in and in contact with the liquid medium,
which is reduced by at least 40%, measured by numbers of moles of the first herbicide or measured by weight of the first herbicide calculated in a salt-free form,
compared to an amount of the same first herbicide released or dissolved over the same specified time period, from a sample of the same first herbicide which is in substantially pure form and in which the first herbicide is not contained within polymeric microparticles, into the same liquid medium used for the polymeric microparticle release analysis, after the substantially pure sample of the first herbicide is placed in and in contact with the liquid medium.

14. A herbicidal composition as claimed in claim 1, wherein the mean diameter by volume of the polymeric microparticles containing the first herbicide is from 0.5 to 15 micrometres, as measured by light scattering laser diffraction.

15. A herbicidal composition as claimed in claim 1, wherein the polymer microparticles comprise a polymeric matrix or matrices comprising:
a crosslinked polyester polymer or co-polymer;
an epoxy polymer or co-polymer;
a phenolic, urea or melamine polymer or co-polymer;
a silicone or rubber polymer or co-polymer;
a polyisocyanate, polyamine or polyurethane polymer or co-polymer;
an acrylic polymer or co-polymer;
a polymer or co-polymer of styrene, vinyltoluene, alpha-methylstyrene, divinylbenzene, or diallylphthalate;
a polyacrylonitrile polymer or co-polymer;
a polyalkylacetate polymer or co-polymer;
a C₁-C₃alkyl and/or hydroxypropyl derivative of cellulose, or carboxymethylcellulose, sodium carboxymethylcellulose, or calcium carboxymethylcellulose;
polyvinylpyrrolidone (PVP) (crosslinked or non-crosslinked); and/or
a polyoxyethylene-polyoxypropylene copolymer (poloxamer).

16. (canceled)

17. A herbicidal composition as claimed in claim 15, wherein the polymer microparticles comprise a polymeric matrix or matrices comprising a crosslinked polyester polymer formed from the polymerization of an unsaturated (alkene-containing) polyester resin mixed with a vinyl-group-containing monomer.

18. A herbicidal composition as claimed in claim 1, wherein the polymeric microparticles are present in from 1 to 60% by weight of the dispersion composition.

19. A herbicidal composition as claimed in claim 1, wherein the polymer microparticles either contain no non-volatile solvent, oil or plasticizer, or contain up to 5% of a non-volatile solvent, oil and/or plasticizer, by weight of the polymer microparticles containing the first herbicide.

20. A herbicidal composition as claimed in claim 1, wherein the amount of the first herbicide contained within the polymer microparticles is from 5 to 40%, by weight of the polymer microparticles containing the first herbicide.

21. (canceled)

22. A herbicidal composition as claimed in claim 1, wherein:
the synthetic auxin herbicide is defined as a compound that is a herbicide and that, either itself or after the removal of any procide groups present thereon, stimulates the expression of B-glucuronidase (GUS) in transgenic Arabidopsis plantlets line AtEM101 in an assay in which:
seeds of AtEM101 are germinated aseptically on half-strength Murashige and Skoog medium containing a test compound at a range of doses between 0 and 200 uM and assayed for GUS activity at 6 days post-germination; and
either, for a quantitative GUS assay, protein crude extracts of the plantlets are prepared and a fluorometric assay is used;
or, whole plantlets are transferred to 100 mM sodium phosphate buffer at pH 7.0 containing 10 mM EDTA, 0.1% Triton X-100, 1 mM potassium ferricyanide, 1 mM potassium ferrocyanide and 1 mM 5-bromo-4-chloro-3-indolyl β-D-glucuronic acid (X-gluc) and incubated for 12 hours at 37° C.; stained plantlets are then removed and cleared of chlorophyll by soaking in 70% (v/v) ethanol; the amount of overall blue staining is then assessed and compared visually; and
a synthetic auxin is defined in this assay as a test compound which exhibits a dose response of GUS activity or blue staining dependent on the concentration of test compound present during the germination and growth of the AtEM101 Arabidopsis plantlet; and
a synthetic auxin is further defined in this assay as a compound that, when assayed under the above conditions, and at a concentration of 50 μM (50 micromolar), results in at least about a doubling of GUS activity or of the amount of blue staining, relative to the amount of GUS activity or blue staining obtained with like AtEM101 plantlets like-grown in the absence of the test compound;
and wherein an acetolactate synthase (ALS) inhibitor herbicide is defined as a compound that is a herbicide and that, either itself or after the removal of any procide groups present thereon, inhibits, at a concentration less than 100 μM, the specific activity of acetolactate synthase by more than 90% relative to similar controls run in the absence of the compound, wherein the comparative rate measurements are made at or after a reaction time of at least 200 minutes;
and wherein the acetolactate synthase has been prepared as described in T. Hawkes et al., in ‘Herbicides and Plant Metabolism’: ed. A. D. Dodge, Society for Experimental Biology Seminar Series 38, Cambridge University Press, United Kingdom, 1989, pp. 113-136.

23. A herbicidal composition as claimed in claim 1, wherein the first herbicide is: dicamba, 2,4-D, MCPA, triasulfuron, tribenuron-methyl, iodosulfuron-methyl, mesosulfuron-methyl, sulfosulfuron, flupyrsulfuron-methyl, or pyroxsulam; or an agrochemically acceptable salt thereof.

24. A herbicidal composition as claimed in claim 23, wherein the first herbicide is dicamba or an agrochemically acceptable salt thereof.

25. A herbicidal composition, comprising a mixture of:
(a) polymeric microparticles containing a first herbicide, wherein the first herbicide is a synthetic auxin herbicide or an acetolactate synthase (ALS) inhibitor herbicide;
wherein the first herbicide, when in a salt-free form and when not contained within polymeric microparticles, antagonises the herbicidal activity of pinoxaden;
and (y) a surface-modified clay;
wherein the herbicidal composition is a dispersion composition in which the polymeric microparticles are dispersed in a continuous liquid phase or medium,
and wherein the surface-modified clay is present in the continuous liquid phase or medium and/or is present at the interface between the continuous liquid phase or medium and the polymeric microparticles, such that the surface-modified clay stabilizes the dispersion of the polymeric microparticles in the continuous liquid phase or medium;
and wherein the polymeric microparticles are controlled-release matrices, within which is the first herbicide, and which function in such a way as to control and/or slow down the release of the first herbicide from the polymeric microparticles into a liquid medium when the polymeric microparticles are placed in and in contact with the liquid medium.

26. A herbicidal composition as claimed in claim 25 wherein the surface-modified clay is a clay which has been surface-modified such that the surface-modified clay (i) is capable of being at least partially wetted by an aqueous liquid phase, (ii) is capable of being at least partially wetted by a non-aqueous oil liquid phase, and (iii) is capable of stabilizing an oil-and-water-containing emulsion through adsorption at a or the oil/water interface.

27. A herbicidal composition as claimed in claim 25, wherein the surface-modified clay comprises an amino-silane-modified clay.

28. (canceled)

29. A herbicidal composition as claimed in any of claim 25, wherein the surface-modified clay is present in from 0.2 to 20% by weight of the dispersion composition.

30. (canceled)

31. A herbicidal composition as claimed in claim 25, wherein the weight ratio of the polymeric microparticles to the surface-modified clay in the herbicidal composition is from 100:1 to 3:1.

32. (canceled)

33. A herbicidal composition as claimed in claim 25, wherein the herbicidal composition is an aqueous dispersion composition in which the polymeric microparticles are dispersed in a continuous aqueous liquid phase or medium.

34. (canceled)

35. A herbicidal composition as claimed in claim 25, wherein the polymeric microparticles containing the first herbicide are controlled-release matrices within which is the first herbicide, characterized by:
an amount of the first herbicide released, over a specified time period which is the first 1 hour of contact or the first 3 hours of contact, from the polymeric microparticles into a liquid medium after the polymeric microparticles are placed in and in contact with the liquid medium,
which is reduced by at least 40%, measured by numbers of moles of the first herbicide or measured by weight of the first herbicide calculated in a salt-free form,
compared to an amount of the same first herbicide released or dissolved over the same specified time period, from a sample of the same first herbicide which is in substantially pure form and in which the first herbicide is not contained within polymeric microparticles, into the same liquid medium used for the polymeric microparticle release analysis, after the substantially pure sample of the first herbicide is placed in and in contact with the liquid medium.

36. A herbicidal composition as claimed in claim 25, wherein the mean diameter by volume of the polymeric microparticles containing the first herbicide is from 1.0 to 50 micrometres, as measured by light scattering laser diffraction.

37. A herbicidal composition as claimed in claim 25, wherein
the polymeric microparticles comprise a polymeric matrix or matrices comprising at least one of
a crosslinked polyester polymer or co-polymer;
an epoxy polymer or co-polymer;
a phenolic, urea or melamine polymer or co-polymer;
a silicone or rubber polymer or co-polymer;
a polyisocyanate, polyamine or polyurethane polymer or co-polymer;
an acrylic polymer or co-polymer;
a polymer or co-polymer of styrene, vinyltoluene, alpha-methylstyrene, divinylbenzene, or diallylphthalate;
a polyacrylonitrile polymer or co-polymer;
a polyalkylacetate polymer or co-polymer;
a C₁-C₃alkyl and/or hydroxypropyl derivative of cellulose, or carboxymethylcellulose, sodium carboxymethylcellulose, or calcium carboxymethylcellulose;
polyvinylpyrrolidone (PVP) (crosslinked or non-crosslinked); and/or
a polyoxyethylene-polyoxypropylene copolymer (poloxamer); and/or
the first herbicide is dicamba, 2,4-D, MCPA, triasulfuron, tribenuron-methyl, iodosulfuron-methyl, mesosulfuron-methyl, sulfosulfuron, flupyrsulfuron-methyl, or pyroxsulam; or an
agrochemically acceptable salt thereof.

38. A herbicidal composition comprising a mixture of:
(a) polymeric microparticles containing a first herbicide, wherein the first herbicide is a synthetic auxin herbicide or an acetolactate synthase (ALS) inhibitor herbicide;
wherein the first herbicide, when in a salt-free form and when not contained within polymeric microparticles, antagonises the herbicidal activity of pinoxaden;
and (b) pinoxaden;
wherein the polymeric microparticles are controlled-release matrices, within which is the first herbicide, and which function in such a way as to control and/or slow down the release of the first herbicide from the polymeric microparticles into a liquid medium when the polymeric microparticles are placed in and in contact with the liquid medium.

39. A herbicidal composition as claimed in claim 38, wherein the polymeric microparticles containing the first herbicide are controlled-release matrices within which is the first herbicide, characterized by:
an amount of the first herbicide released, over a specified time period which is the first 1 hour of contact or the first 3 hours of contact, from the polymeric microparticles into a liquid medium after the polymeric microparticles are placed in and in contact with the liquid medium,
which is reduced by at least 40%, measured by numbers of moles of the first herbicide or measured by weight of the first herbicide calculated in a salt-free form,
compared to an amount of the same first herbicide released or dissolved over the same specified time period, from a sample of the same first herbicide which is in substantially pure form and in which the first herbicide is not contained within polymeric microparticles, into the same liquid medium used for the polymeric microparticle release analysis, after the substantially pure sample of the first herbicide is placed in and in contact with the liquid medium.

40. (canceled)

41. (canceled)

42. (canceled)

43. (canceled)

44. (canceled)

45. A herbicidal composition as claimed in claim 38, wherein the mean diameter of the polymeric microparticles containing the first herbicide is from 0.7 to 15 micrometres.

46. A herbicidal composition as claimed in claim 38, wherein the polymer microparticles comprise a polymeric matrix or matrices comprising:
a crosslinked polyester polymer or co-polymer;
an epoxy polymer or co-polymer;
a phenolic, urea or melamine polymer or co-polymer;
a silicone or rubber polymer or co-polymer;
a polyisocyanate, polyamine or polyurethane polymer or co-polymer;
an acrylic polymer or co-polymer;
a polymer or co-polymer of styrene, vinyltoluene, alpha-methylstyrene, divinylbenzene, or diallylphthalate;
a polyacrylonitrile polymer or co-polymer;
a polyalkylacetate polymer or co-polymer;
a C₁-C₃alkyl and/or hydroxypropyl derivative of cellulose, carboxymethylcellulose, sodium carboxymethylcellulose, or calcium carboxymethylcellulose;
polyvinylpyrrolidone (PVP) (crosslinked or non-crosslinked); and/or
a polyoxyethylene-polyoxypropylene copolymer (poloxamer).

47. (canceled)

48. A herbicidal composition as claimed in claim 46, wherein the polymer microparticles comprise a polymeric matrix or matrices comprising a crosslinked polyester polymer formed from the polymerization of an unsaturated (alkene-containing) polyester resin mixed with a vinyl-group-containing monomer.

49. (canceled)

50. (canceled)

51. A herbicidal composition as claimed in any of claim 38, wherein the first herbicide is: dicamba, 2,4-D, MCPA, triasulfuron, tribenuron-methyl, iodosulfuron-methyl, mesosulfuron-methyl, sulfosulfuron, flupyrsulfuron-methyl, or pyroxsulam; or an agrochemically acceptable salt thereof.

52. A herbicidal composition as claimed in claim 51, wherein:
the weight ratio of dicamba or an agrochemically acceptable salt thereof (measured as the free acid) to pinoxaden is 16:1 to 4:3;
the weight ratio of MCPA or an agrochemically acceptable salt thereof (measured as the free acid) to pinoxaden is from 110:1 to 35:6;
the weight ratio of 2,4-D or an agrochemically acceptable salt thereof (measured as the free acid) to pinoxaden is from 110:1 to 35:6;
the weight ratio of triasulfuron or an agrochemically acceptable salt thereof (measured as the free acid) to pinoxaden is from 1:1 to 1:12;
the weight ratio of tribenuron-methyl or an agrochemically acceptable salt thereof (measured as the free acid) to pinoxaden is from 2:1 to 5:24;
the weight ratio of iodosulfuron-methyl or an agrochemically acceptable salt thereof (measured as the free acid) to pinoxaden is from 1:1 to 1:12;
the weight ratio of mesosulfuron-methyl or an agrochemically acceptable salt thereof (measured as the free acid) to pinoxaden is from 4:3 to 1:6; and
the weight ratio of sulfosulfuron or an agrochemically acceptable salt thereof (measured as the free acid) to pinoxaden is from 7:3 to 1:6;
the weight ratio of flupyrsulfuron-methyl or an agrochemically acceptable salt thereof (measured as the free acid) to pinoxaden is from 1:1 to 1:12; and
the weight ratio of pyroxsulam or an agrochemically acceptable salt thereof (measured as the free acid) to pinoxaden is from 15:12 to 3:20.

53. (canceled)

54. A herbicidal composition as claimed in claim 38, comprising a mixture of:
(a) polymeric microparticles containing dicamba, or an agrochemically acceptable salt thereof; and
(b) pinoxaden.

55. (canceled)

56. A herbicidal composition as claimed in claim 38, wherein the amount of the first herbicide contained within the polymeric microparticles is from 1 to 50%, by weight of the polymeric microparticles containing the first herbicide.

57. (canceled)

58. (canceled)

59. A herbicidal composition as claimed in claim 38, which is an aqueous dispersion composition in which the polymeric microparticles are dispersed in a continuous aqueous liquid phase or medium; and wherein the dispersion of the polymeric microparticles in the continuous liquid phase or medium is stabilised by a stabilizer and/or a dispersant.

60. A herbicidal composition as claimed in claim 38, comprising:
(e) an oil additive selected from an oil of vegetable or animal origin, a mineral oil, alkyl esters of such oils, mixtures of such oils and oil derivatives, tris-esters of phosphoric acid with aliphatic or aromatic alcohols, and bis-esters of alkyl phosphonic acids with aliphatic or aromatic alcohols,
optionally (c) a safener and,
optionally, (d) an additional herbicide.

61. (canceled)

62. (canceled)

63. A method of reducing the antagonistic effect on the control of monocotyledonous weeds in non-oat cereals which is shown by a herbicidal mixture of either a synthetic auxin herbicide with pinoxaden or an ALS inhibitor herbicide with pinoxaden, which comprises applying a herbicidal composition as defined in claim 38 to the plants or to the locus thereof.

64. A method of controlling weeds in non-oat cereal crops comprising applying a herbicidal composition as defined in any one of claim 1 to the plants or to the locus thereof.

65. (canceled)

66. A method as claimed in claim 63, wherein the first herbicide is dicamba, 2,4-D, MCPA, triasulfuron, tribenuron-methyl, iodosulfuron-methyl, mesosulfuron-methyl, sulfosulfuron, flupyrsulfuron-methyl, or pyroxsulam; or an agrochemically acceptable salt thereof.

67. A method as claimed in claim 63, wherein pinoxaden is applied at an application rate of from 15 to 60 g pinoxaden/ha, and wherein the polymeric microparticles contain dicamba or an agrochemically acceptable salt thereof, and the dicamba or the agrochemically acceptable salt thereof is applied at an application rate of from 80 to 240 g of dicamba/ha, measured as the free acid.

68. (canceled)

69. (canceled)

70. (canceled)

71. A herbicidal composition, comprising a mixture of:
(a) polymeric microparticles containing a first herbicide, wherein the first herbicide is a synthetic auxin herbicide or an acetolactate synthase (ALS) inhibitor herbicide;
wherein the first herbicide, when in a salt-free form and when not contained within polymeric microparticles, antagonises the herbicidal activity of pinoxaden;
and (x) a nonionic surfactant;
wherein the herbicidal composition is a dispersion composition in which the polymeric microparticles are dispersed in a continuous liquid phase or medium,
wherein the polymeric microparticles are controlled-release matrices, within which is the first herbicide, and which function in such a way as to control and/or slow down the release of the first herbicide from the polymeric microparticles into a liquid medium when the polymeric microparticles are placed in and in contact with the liquid medium,
and wherein the nonionic surfactant is present in the continuous liquid phase or medium, such that the nonionic surfactant stabilizes the dispersion of the polymeric microparticles in the continuous liquid phase or medium,
wherein the polymer microparticles comprise a polymeric matrix or matrices comprising a crosslinked polyester polymer or co-polymer;
and wherein the mean diameter by volume of the polymeric microparticles containing the first herbicide is from 0.5 to 15 micrometres, in particular from 2.0 to 13 micrometres, as measured by light scattering laser diffraction.

72. A herbicidal composition as claimed in claim 71, wherein the nonionic surfactant comprises polyvinyl alcohol.

73. A herbicidal composition as claimed in claim 71:
the polymeric microparticles are controlled-release matrices, within which is the first herbicide, and which function in such a way as to control and/or slow down the release of the first herbicide from the polymeric microparticles into a liquid medium when the polymeric microparticles are placed in and in contact with the liquid medium; and
the crosslinked polyester polymer or co-polymer is a crosslinked polyester polymer formed from the polymerization of an unsaturated (alkene-containing) polyester resin mixed with an alkenyl-group-containing monomer.
